(19) United States
(12) Patent Application Publication
(10) Pub. No.: US 2022/0006962 A1
(43) Pub. Date: Jan. 6, 2022

(54) Coordinated Multi-viewpoint Image Capture With A Robotic Vehicle

(71) Applicant: QUALCOMM Incorporated, San Diego, CA (US)

(72) Inventors: Jayesh BATHIJA, San Diego, CA (US); Taoufik TANI, San Diego, CA (US); Ning BI, San Diego, CA (US)

(21) Appl. No.: 16/920,299

(22) Filed: Jul. 2, 2020

(51) Int. Cl. H04N 5/232; G05D 1/00; G05D 1/10

(52) U.S. Cl. CPC H04N 5/232933; H04N 5/23299; G05D 1/0297; G05D 1/0094; G05D 1/104; H04N 5/23206

(57) ABSTRACT

Various embodiments may include methods and systems for performing synchronous multi-viewpoint photography using robotic vehicle devices. Various embodiments may include transmitting a first maneuver instruction directing a responding robotic vehicle to a position for capturing an image suitable for multi-viewpoint photography, determining whether the responding robotic vehicle is suitably positioned and oriented for capturing such an image, transmitting a second maneuver instruction to adjust the responding robotic vehicle's location and/or orientation in response to determining that the responding robotic vehicle is not suitably positioned and oriented, transmitting an image capture instruction causing the responding robotic vehicle to capture an image in response to determining that the responding robotic vehicle is suitably positioned and oriented for synchronous multi-viewpoint photography, capturing an image by the initiating robotic vehicle, receiving the image from the responding robotic vehicle, and generating an image file based on the captured and received images.

### BACKGROUND

Standard wireless device photos are taken from a single perspective and are two-dimensional. A user may capture multiple images of a subject from different points of view, but each additional image captured will have been at a time after a first image capture. This is problematic when attempting to take a three-dimensional (3D) portrait of a subject if the subject has moved between images.

Methods of capturing 3D images using two or more cameras that are fixed and configured to take images of a same subject simultaneously, providing images that can be stitched together to create the 3D image. However, this requires fixing the cameras in pre-set positions (e.g., around a football field). Thus, it is not possible today to take synchronous 3D images using multiple handheld cameras or unmanned aerial vehicles or drones equipped with cameras.

### SUMMARY

Various aspects include methods and circuits for performing synchronous multi-viewpoint photography using camera-equipped robotic vehicle device, such as an unmanned aerial vehicles (UAV) devices and computing devices including cameras, such as smailphones.

Some aspects include methods that may be performed by a processor associated with an initiating robotic vehicle or a robotic vehicle controller communicating with the initiating robotic vehicle for performing synchronous multi-viewpoint photography with a plurality of robotic vehicles. Such aspects may include transmitting to a responding robotic vehicle a first maneuver instruction configured to cause the responding robotic vehicle to maneuver to a location (including altitude for maneuvering a UAV) with an orientation suitable for capturing an image suitable for use with an image of the initiating robotic vehicle for performing synchronous multi-viewpoint photography, determining from information received from the responding robotic vehicle whether the responding robotic vehicle is suitably positioned and oriented for capturing an image for synchronous multi-viewpoint photography, transmitting to the responding robotic vehicle a second maneuver instruction configured to cause the responding robotic vehicle to maneuver so as to adjust its location (including altitude for maneuvering a UAV) or its orientation to correct its position or orientation for capturing an image for synchronous multi-viewpoint photography in response to determining that the responding robotic vehicle is not suitably positioned and oriented for capturing an image for synchronous multi-viewpoint photography, and transmitting, to the responding robotic vehicle, an image capture instruction configured to enable the responding robotic vehicle to capture a second image at approximately the same time as the initiating robotic vehicle captures a first image in response to determining that the responding robotic vehicle is suitably positioned and oriented for capturing an image for synchronous multi-viewpoint photography, capturing, via a camera of the initiating robotic vehicle, the first image, receiving the second image from the responding robotic vehicle, and generating an image file based on the first image and the second image.

In some aspects, the processor may be within an initiating robotic vehicle controller controlling the initiating robotic vehicle, the first and second maneuver instructions transmitted to the responding robotic vehicle may be transmitted from the initiating robotic vehicle controller to a robotic vehicle controller of the responding robotic vehicle and configured to enable the responding robotic vehicle controller to display information to enable an operator to maneuver the responding robotic vehicle to the location and orientation suitable for capturing an image for synchronous multi-viewpoint photography, and the image capture instruction transmitted to the responding robotic vehicle is transmitted from the initiating robotic vehicle controller to the robotic vehicle controller of the responding robotic vehicle and configured to cause the responding robotic vehicle controller to send commands to the responding robotic vehicle to capture the second image at approximately the same time as the initiating robotic vehicle captures the first image. Such aspects may further include displaying, via a user interface on the initiating robotic vehicle controller, preview images captured by the camera of the initiating robotic vehicle, and receiving an operator input on the user interface identifying a region or feature appearing in the preview images, in which transmitting to the responding robotic vehicle the first maneuver instruction configured to cause the responding robotic vehicle to maneuver to a location (including altitude for maneuvering a UAV) with an orientation suitable for capturing an image suitable for use with an image captured by the initiating robotic vehicle for performing synchronous multi-viewpoint photography may include transmitting preview images captured by the camera of the initiating robotic vehicle to the robotic vehicle controller of the responding robotic vehicle in a format that enables the robotic vehicle controller of the responding robotic vehicle to display the preview images for reference by an operator of the responding robotic vehicle.

In some aspects, the processor may be within the initiating robotic vehicle, the first and second maneuver instructions transmitted to the responding robotic vehicle may be transmitted from the initiating robotic vehicle to the responding robotic vehicle and configured to enable the responding robotic vehicle to maneuver to the location and orientation for capturing an image for synchronous multi-viewpoint photography, and the image capture instruction transmitted to the responding robotic vehicle may be transmitted from the initiating robotic vehicle to the responding robotic vehicle and configured to cause the responding robotic vehicle to capture the second image at approximately the same time as the initiating robotic vehicle captures the first image.

In some aspects, determining from information received from the responding robotic vehicle whether the responding robotic vehicle is suitably positioned and oriented for capturing an image for synchronous multi-viewpoint photography may include receiving location and orientation information from the responding device, and determining whether the responding robotic vehicle is suitably positioned and oriented for capturing an image for synchronous multi-viewpoint photography based on the location and orientation information of the responding robotic vehicle and location and orientation information of the initiating robotic vehicle.

Some aspects may further include displaying, via a user interface on the initiating robotic vehicle controller, a first preview image captured by the camera of the initiating robotic vehicle, and receiving an operator input on the user interface identifying a region or feature appearing in the first preview image, in which transmitting to the responding robotic vehicle the first maneuver instruction configured to cause the responding robotic vehicle to maneuver to the location (including altitude for maneuvering a UAV) with an orientation suitable for capturing an image suitable for use with images captured by the initiating robotic vehicle for performing synchronous multi-viewpoint photography may include determining, based on the identified region or feature of interest and a location and orientation of the initiating robotic vehicle, the location (including altitude for maneuvering a UAV) and the orientation for the responding robotic vehicle for capturing images suitable for use with images captured by the initiating robotic vehicle for synchronous multi-viewpoint photography, and transmitting the determined location and orientation to the responding robotic vehicle. In such aspects, determining from information received from the responding robotic vehicle whether the responding robotic vehicle is suitably positioned and oriented for capturing an image for synchronous multi-viewpoint photography may include receiving preview images from the responding robotic vehicle, and performing image processing to determine whether the preview images received from the responding robotic vehicle and preview images captured by the initiating robotic vehicle are aligned suitably for synchronous multi-viewpoint photography, determining an adjustment to the location or orientation of the responding robotic vehicle to position the responding robotic vehicle for capturing an image for synchronous multi-viewpoint photography in response to determining that the preview images received from the responding robotic vehicle and preview images captured by the initiating robotic vehicle are not aligned suitably for synchronous multi-viewpoint photography, and determining that the responding robotic vehicle is suitably positioned and oriented for capturing an image for synchronous multi-viewpoint photography in response to determining that the preview images received from the responding robotic vehicle and preview images captured by the initiating robotic vehicle are aligned suitably for synchronous multi-viewpoint photography.

In some aspects, performing image processing to determine whether the preview images received from the responding robotic vehicle and preview images captured by the initiating robotic vehicle are aligned suitably for synchronous multi-viewpoint photography may include determining a first perceived size of an identified point of interest in the preview images captured by the initiating robotic vehicle, determining a second perceived size of the identified point of interest in the preview images received from the responding robotic vehicle, and determining whether a difference between the first perceived size of the identified point of interest and the second perceived size of the identified point of interest is within a size difference threshold for synchronous multi-viewpoint photography, determining an adjustment to the location or orientation of the responding robotic vehicle to position the responding robotic vehicle for capturing an image for synchronous multi-viewpoint photography in response to determining that the preview images received from the responding robotic vehicle and preview images captured by the initiating robotic vehicle are not aligned suitably for synchronous multi-viewpoint photography may include determining a change in location for the responding robotic vehicle based on the difference between the first perceived size of the identified point of interest and the second perceived size of the identified point of interest in response to determining that the difference between the first perceived size of the identified point of interest and the second perceived size of the identified point of interest is not within the size difference threshold for synchronous multi-viewpoint photography, and determining that the responding robotic vehicle is suitably positioned and oriented for capturing an image for synchronous multi-viewpoint photography in response to determining that the preview images received from the responding robotic vehicle and preview images captured by the initiating robotic vehicle are aligned suitably for synchronous multi-viewpoint photography may include determining that the responding robotic vehicle is suitably positioned and oriented for capturing an image for synchronous multi-viewpoint photography in response to determining that the difference between the first perceived size of the identified point of interest and the second perceived size of the identified point of interest is within the size difference threshold for synchronous multi-viewpoint photography.

In some aspects, performing image processing to determine whether the preview images received from the responding robotic vehicle and preview images captured by the initiating robotic vehicle are aligned suitably for synchronous multi-viewpoint photography may include performing image processing to determine a location where the point of interest appears within preview images captured by the initiating robotic vehicle, performing image processing to determine a location where the point of interest appears within preview images received from the responding robotic vehicle, and determining whether a difference in the location of the point of interest within preview images captured by the initiating robotic vehicle and preview images received from the responding robotic vehicle is within a location difference threshold for synchronous multi-viewpoint photography, determining an adjustment to the location or orientation of the responding robotic vehicle to position the responding robotic vehicle for capturing an image for synchronous multi-viewpoint photography in response to determining that the preview images received from the responding robotic vehicle and preview images captured by the initiating robotic vehicle are not aligned suitably for synchronous multi-viewpoint photography may include determining a change in orientation of the responding robotic vehicle based on the difference in the location of the point of interest within preview images captured by the initiating robotic vehicle and preview images received from the responding robotic vehicle in response to determining that the difference in the location of the point of interest within preview images captured by the initiating robotic vehicle and preview images received from the responding robotic vehicle is not within the location difference threshold for synchronous multi-viewpoint photography, and determining that the responding robotic vehicle is suitably positioned and oriented for capturing an image for synchronous multi-viewpoint photography in response to determining that the preview images received from the responding robotic vehicle and preview images captured by the initiating robotic vehicle are aligned suitably for synchronous multi-viewpoint photography may include determining that the responding robotic vehicle is suitably oriented for capturing an image for synchronous multi-viewpoint photography in response to determining that the difference in the location of the point of interest within preview images captured by the initiating robotic vehicle and preview images received from the responding robotic vehicle is within the location difference threshold for synchronous multi-viewpoint photography.

Some aspects may further include transmitting a timing signal that enables synchronizing a clock in the responding robotic vehicle with a clock in the initiating robotic vehicle, in which transmitting an image capture instruction configured to enable the responding robotic vehicle to capture a second image at approximately the same time as the initiating robotic vehicle captures a first image may include transmitting a time-based image capture instruction using the synchronized clocks. In such aspects, transmitting a time-based image capture instruction using the synchronized clocks may include transmitting an instruction configured to cause the responding robotic vehicle to capture a plurality of images and record a time when each image is captured by the initiating robotic vehicle, capturing the first image may include capturing the first image and recording a reference time when the first image is captured, and receiving the second image from the responding robotic vehicle may include transmitting, to the responding robotic vehicle, the reference time when the first image was captured, and receiving from the responding robotic vehicle a second image that was captured by the responding robotic vehicle at approximately the reference time.

Some aspects may further include receiving a time signal from a global navigation satellite system (GNSS), in which transmitting the image capture instruction configured to enable the responding robotic vehicle to capture the second image at approximately the same time as the initiating robotic vehicle captures the first image may include transmitting to the responding robotic vehicle a time based on GNSS time signals at which the responding robotic vehicle should capture the second image.

Some aspects may include methods performed by a processor associated with a responding robotic vehicle for performing synchronous multi-viewpoint photography. Such aspects may include maneuvering the responding robotic vehicle to a position and orientation identified in a first maneuver instruction received from an initiating robotic vehicle, transmitting information to the initiating robotic vehicle relevant to the position and orientation of the responding robotic vehicle, maneuvering to adjust the position or orientation the responding robotic vehicle based on a second maneuver instruction received from the initiating robotic vehicle, capturing at least one image in response to an image capture instruction received from the responding robotic vehicle, and transmitting the at least one image to the initiating robotic vehicle.

In some aspects, the processor may be within a responding robotic vehicle controller controlling the responding robotic vehicle, maneuvering the responding robotic vehicle to a position and orientation identified in the first maneuver instruction received from the initiating robotic vehicle may include displaying the first maneuver instructions on a display of the responding robotic vehicle controller and transmitting maneuver commands to the responding robotic vehicle based on user inputs, maneuvering to adjust the position or orientation the responding robotic vehicle based on the second maneuver instruction received from the initiating robotic vehicle may include displaying the second maneuver instructions on the display of the responding robotic vehicle controller and transmitting maneuver commands to the responding robotic vehicle based on user inputs, capturing at least one image in response to an image capture instruction received from the responding robotic vehicle may include the responding robotic vehicle controller causing a camera of the responding robotic vehicle to capture the at least one image, and transmitting the at least one image to the initiating robotic vehicle may include the responding robotic vehicle controller receiving the at least one image from the responding robotic vehicle and transmitting the at least one image to a robotic vehicle controller of the initiating robotic vehicle. Such aspects may further include receiving, from the initiating robotic vehicle, preview images captured by the initiating robotic vehicle including an indication of a point of interest within the preview images, and displaying the preview images and the indication of the point of interest on the display of the responding robotic vehicle controller.

In some aspects, transmitting information to the initiating robotic vehicle relevant to the position and orientation of the responding robotic vehicle may include transmitting preview images capture by a camera of the responding robotic vehicle to the initiating robotic vehicle.

In some aspects, transmitting information to the initiating robotic vehicle relevant to the position and orientation of the responding robotic vehicle may include transmitting information regarding a location and orientation of the responding robotic vehicle to the initiating robotic vehicle.

Some aspects may further include receiving a timing signal from the initiating device that enables synchronizing a clock in the responding robotic vehicle with a clock of the initiating robotic vehicle, in which capturing at least one image in response to the image capture instruction received from the responding robotic vehicle may include capturing at least one image in response to a time-based image capture instruction using the synchronized clock.

In some aspects, capturing at least one image in response to a time-based image capture instruction using the synchronized clocks may include receiving an image capture instruction identifying a time based on the synchronized clock to begin capturing a plurality of images, capturing a plurality of images and recording a time when each image is captured beginning at the identified time, receiving a reference time from the initiating robotic vehicle, and identifying one of the captured plurality of images with a recorded time closely matching the reference time received from the initiating robotic vehicle, and transmitting the at least one image to the initiating robotic vehicle may include transmitting the identified one of the captured plurality of images to the initiating robotic vehicle.

Some aspects may further include receiving time signals from a global positioning system (GPS) receiver, in which capturing at least one image in response to the image capture instruction received from the initiating robotic vehicle may include capturing the at least one image at a time based on GPS time signals indicated in the image capture instruction received from the initiating robotic vehicle.

In some aspects, one or both of the initiating robotic vehicle and the responding robotic vehicle may be a UAV. Further aspects include a robotic vehicle having a processor configure to perform operations of any of the methods summarized above. Further aspects include a robotic vehicle controller having a processor configure to perform operations of any of the methods summarized above. Further aspects include processing device suitable for us in a robotic vehicle or robotic vehicle controller and including a processor configure to perform operations of any of the methods summarized above. Further aspects include a robotic vehicle having means for performing functions of any of the methods summarized above. Further aspects include a robotic vehicle controller having means for performing functions of any of the methods summarized above. Further aspects include a non-transitory processor-readable medium having stored thereon processor-executable instructions configured to cause a processor of a robotic vehicle and/or a robotic vehicle controller to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. lA is a system block diagram illustrating an example communications system 100a according to various embodiments.

FIG. 1B is a system block diagram illustrating an example communications system 100b including camera-equipped UAV robotic vehicles according to some embodiments.

FIG. 2 is a component block diagram illustrating an example computing system suitable for implementing various embodiments.

FIG. 3 is a component block diagram illustrating an example system 300 configured for performing synchronous multi-viewpoint photography according to various embodiments.

FIG. 4 is a message flow diagram 400 illustrating operations and device-to-device communications for implementing various embodiments.

FIGS. 5A-5D illustrate four examples of wireless devices and UAV robotic vehicles performing synchronous 3D multi-viewpoint photography of a point of interest according to some embodiments.

FIG. 6 illustrates an initiating device 600 for performing synchronous multi-viewpoint photography according to some embodiments.

FIG. 7 illustrates an example of two devices performing synchronous multi-viewpoint photography prior to a position adjustment by a responding device.

FIG. 8 illustrates a user-interface display 800 on a responding device for the example multi-viewpoint photography illustrated in FIG. 7.

FIG. 9 illustrates an example of two devices performing synchronous multi-viewpoint photography after a position adjustment of the responding device.

FIG. 10 illustrates a user-interface display 8100 on a responding device for the example illustrated in FIG. 9multi-viewpoint.

FIGS. 11-14 illustrate examples of user-interface displays of an initiating device and responding devices performing synchronous multi-viewpoint photography according to some embodiments.

FIG. 15 illustrates an example of positioning four devices for performing 360-degree 3D synchronous multi-viewpoint photography according to some embodiments.

FIGS. 16-20 illustrate examples of user interface displays for initiating devices useful for planning synchronous multi-viewpoint photography according to some embodiments.

FIG. 21 illustrates an example of three devices positioned for performing synchronous panoramic multi-viewpoint photography according to some embodiments.

FIG. 22-28 illustrate examples of user-interface displays of an initiating device and responding devices for performing synchronous panoramic multi-viewpoint photography according to some embodiments.

FIG. 29 illustrates an example of device positioning for performing 360-degree synchronous panoramic multi-viewpoint photography according to some embodiments.

FIG. 30 illustrates an example of device positioning for performing synchronous multi-viewpoint photography having a blur effect according to some embodiments.

FIG. 31 illustrates an example of device positioning for performing synchronous multi-viewpoint photography according to some embodiments.

FIGS. 32-34 illustrate example user interface displays of an initiating device for performing synchronous multi-viewpoint photography according to some embodiments.

FIG. 35 is a process flow diagram illustrating a method 3500 for an initiating device to perform synchronous multi-viewpoint photography according to some embodiments.

FIGS. 36-38 are process flow diagrams illustrating alternative operations that may be performed by a processor of an initiating device as part of the method 3500 for performing synchronous multi-viewpoint photography according to some embodiments.

FIG. 39 is a process flow diagram illustrating a method 3900 for an initiating device to perform synchronous multi-viewpoint photography according to some embodiments.

FIGS. 40-44 are process flow diagrams illustrating alternative operations that may be performed by a processor of a wireless device as part of the method 3900 for performing synchronous multi-viewpoint photography according to some embodiments.

FIG. 45 is a process flow diagram illustrating a method 4500 implementing a responding device to perform synchronous multi-viewpoint photography according to various embodiments.

FIGS. 46-49 are process flow diagrams illustrating alternative operations that may be performed by a processor of a wireless device as part of the method 4500 for performing synchronous multi-viewpoint photography according to some embodiments.

FIG. 50 is a component block diagram illustrating components of a wireless device suitable for use with various embodiments.

FIG. 51A is a component block diagram illustrating components of a UAV robotic vehicle suitable for use with various embodiments.

FIG. 51B is a component block diagram illustrating components of a UAV robotic vehicle controller suitable for use with various embodiments.

FIG. 52 is a process flow diagram illustrating a method 5200 that may be performed by an initializing robotic vehicle or initializing robotic vehicle controller for performing synchronous multi-viewpoint photography according to various embodiments.

FIG. 53-60 are process flow diagrams illustrating alternative and additional operations that may be performed by an initializing robotic vehicle or initializing robotic vehicle controller for performing synchronous multi-viewpoint photography according to some embodiments.

FIG. 61 is a process flow diagram illustrating a method 5200 that may be performed by a responding robotic vehicle or responding robotic vehicle controller for performing synchronous multi-viewpoint photography according to various embodiments.

FIG. 62-65 are process flow diagrams illustrating alternative and additional operations that may be performed by an initializing robotic vehicle or initializing robotic vehicle controller for performing synchronous multi-viewpoint photography according to some embodiments.

### DETAILED DESCRIPTION

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

Various embodiments include methods, and devices configured to implement the methods, for performing synchronous multi-viewpoint photography using camera-equipped wireless devices, such as smartphones, and robotic vehicles, such as UAVs. Various embodiments may be configured to perform synchronous multi-viewpoint photography by synchronously capturing one or more images using an initiating device or initiating robotic vehicle device communicating with one or more responding devices or responding robotic vehicles. The captured images may be associated with timestamps for purposes of correlating the images to generate multi-viewpoint images and videos. The resulting multi-viewpoint images may include three-dimensional (3D), panoramic, blur or time lapse, multi-viewpoint, 360-degree 3D, and 360-degree panoramic images and image files. In some embodiments, one or both of the initiating robotic vehicle and the responding robotic vehicle may be a UAV.

The term “wireless device” is used herein to refer to any one or all of cellular telephones, smartphones, portable computing devices, personal or mobile multi-media players, laptop computers, tablet computers, smartbooks, ultrabooks, wireless electronic mail receivers, multimedia Internet-enabled cellular telephones, smart glasses, and similar electronic devices that include a memory, a camera, wireless communication components, a user display, and a programmable processor. The term “initiating device” is used herein to refer to a wireless device that is used to initiate and coordinate the operations of one or more other wireless devices to capture images for simultaneous multi-viewpoint photography by performing operations over various embodiments described herein. The term “responding device” is used herein to refer to a wireless device that receives information and commands from the initiating device and performs operations of various embodiments to participate in capturing images for simultaneous multi-viewpoint photography in coordination with the initiating device.

Various embodiments may use one or more camera-equipped robotic vehicles to capture at least some of the images used in simultaneous multi-viewpoint photography. The term “robotic vehicle” refers to any of a variety of autonomous and semiautonomous vehicles and devices. Non-limiting examples of robotic vehicles include UAVs, unmanned ground vehicles, and unmanned boats and other water-borne vehicles. Various embodiments may be particularly useful with camera-equipped UAVs due to their popularity, small size, versatility, and the unique viewing perspectives achievable with aerial vehicles. For this reason, various embodiments are illustrated and described using UAVs as an example robotic vehicle. However, the use of UAVs in the figures and embodiment descriptions is not intended to limit the claims to UAVs unless specifically recited in a claim.

As described herein, operations of some embodiments may be performed within a robotic vehicle controller sending commands to and receiving data and images from a robotic vehicle as well as communicating with another robotic vehicle controller, and operations of other embodiments may be performed within a robotic vehicle communicating with another robotic vehicle as well as with a robotic vehicle controller. For ease of reference describing various embodiments, the following terms are defined and used in the following descriptions of various embodiments.

The term “robotic vehicle device” is used herein to refer generally to either a robotic vehicle controller or a robotic vehicle when described operations that may be performed in either device. Similarly, the term “UAV device” is used herein to refer generally to either a UAV controller or a UAV when described operations that may be performed in either device.

The term “initiating robotic vehicle device” is used herein to refer generally to either a robotic vehicle controller or a robotic vehicle when described operations that may be performed in either for initiating and coordinating other wireless devices or robotic vehicle devices to capture images for simultaneous multi-viewpoint photography. Similarly, the term “initiating UAV device” is used herein to refer generally to either a UAV controller or a UAV when described operations that may be performed in either device for initiating and coordinating other wireless devices or robotic vehicle devices to capture images for simultaneous multi-viewpoint photography.

The term “responding robotic vehicle device” is used herein to refer generally to either a robotic vehicle controller or a robotic vehicle when described operations that may be performed in either for receiving information and commands from an initiating device or initiating robotic vehicle device for capturing images for simultaneous multi-viewpoint photography in coordination with an initiating device or initiating robotic vehicle device. Similarly, the term “responding UAV device” is used herein to refer generally to either a UAV controller or a UAV when described operations that may be performed in either for receiving information and commands from an initiating device or initiating UAV device for capturing images for simultaneous multi-viewpoint photography in coordination with an initiating device or initiating UAV device.

The term “initiating robotic vehicle controller” is used herein to refer to a robotic vehicle controller performing operations to initiate and coordinate the operations of one or more other robotic vehicle controllers to capture images for simultaneous multi-viewpoint photography. Similarly, the term “initiating UAV controller” is used herein to refer to a UAV controller performing operations to initiate and coordinate the operations of one or more other UAV controllers to capture images for simultaneous multi-viewpoint photography.

The term “initiating robotic vehicle” is used herein to refer to a robotic vehicle performing operations to initiate and coordinate the operations of one or more other robotic vehicles to capture images for simultaneous multi-viewpoint photography. Similarly, the term “initiating UAV” is used herein to refer to a UAV performing operations to initiate and coordinate the operations of one or more other UAVs to capture images for simultaneous multi-viewpoint photography.

The term “responding robotic vehicle controller” is used herein to refer to a robotic vehicle controller that receives information and commands from an initiating device or an initiating robotic vehicle controller to participate in capturing images for simultaneous multi-viewpoint photography. Similarly, the term “responding UAV controller” is used herein to refer to a UAV controller that receives information and commands from an initiating device or an initiating UAV controller to participate in capturing images for simultaneous multi-viewpoint photography.

The term “responding robotic vehicle” is used herein to refer to a robotic vehicle that receives information and commands from an initiating device or an initiating robotic vehicle device to participate in capturing images for simultaneous multi-viewpoint photography. Similarly, the term “responding UAV” is used herein to refer to a UAV that receives information and commands from an initiating device or an initiating UAV device to participate in capturing images for simultaneous multi-viewpoint photography.

The term “system-on-a-chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system-in-a-package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

Various embodiments include methods for coordinating multi-viewpoint imaging of a subject (referred to herein as a “point of interest”) or scene from a number of perspectives in a single moment by multiple wireless devices equipped with cameras, such as smartphones and robotic vehicle (e.g., UAV) devices. Various embodiments may enable generating 3D-like photography using multiple images of a subject or scene, which is sometimes referred to herein as a point of interest, captured by a number of camera-equipped wireless devices at approximately the same time. The wireless devices and robotic vehicles may be configured to enable users of responding wireless devices to coordinate or reorient the location, orientation, and/or camera settings of camera-equipped wireless devices to achieve a desired multi-camera multi-viewpoint image or images. For example, in some embodiments a responding wireless device may receive adjustment instructions from an initiating wireless device, and display prompts to enable a user to adjust the elevation, tilt angle, camera lens focal depth, camera zoom magnification, and distance from a point of interest of the wireless device to set up a desired multi-camera image or images.

In some embodiments, an initiating device may send adjustment instructions to responding devices that enables a user of the initiating device to select and focus on a subject or a point of interest, instruct users of the responding device(s) (including operators of responding robotic vehicle devices) on how to frame and focus on the same subject or point of interest from different perspectives, and then trigger all wireless devices to capture an image or images approximately simultaneously from the different perspectives. The multi-camera images captured in this manner may be combined and processed to create a variety of image products including, for example, a 3D-like image (e.g., 3D, “Freeview,” gif animation, live photo, etc.), a time-sensitive panoramic image, a simultaneous multi-view image or video, or other multi-perspective image medium.

In some embodiments, the initiating device may collect preview images from the one or more responding devices. The initiating device may use the collected images to determine how the responding devices should be repositioned or reoriented so as to capture images for simultaneous multi-viewpoint photography desired by the user of the initiating device (e.g., 3D photography, panoramic photography, multi-viewpoint photography, etc.). The initiating device may then send adjustment information messages to the one or more responding devices instructing the users/pilots on how to adjust the location, orientation, or camera features or settings of the responding devices to be prepared to capture the multi-viewpoint images.

Various embodiments may be understood by way of example process for obtaining images for simultaneous multi-viewpoint photography using a number of wireless devices (e.g., smartphones or camera-equipped robotic vehicles). Initially, users of each wireless device may open an application that implements operations of the various embodiments. The device users may select or configure one of the devices to be the initiating device while the remaining devices are configured to be responding devices. The initiating device and one or more responding devices may communicate in real time over a wireless connection (e.g., LTE-D, WiFi, Bluetooth, etc.).

To orient and focus the wireless devices on a particular subject or point of interest for simultaneous multi-viewpoint photography, the user of the initiating device may choose the photographic subject, such as by tapping on the screen or user display interface to focus the camera on the subject. The initiating device may then collect information (e.g., device location, camera settings, device/camera orientation, current focal point, distance from subject, accelerometer information, etc.) and preview images from the responding devices. Using the received information and preview images, initiating device may determine how each responding device should be repositioned and reoriented to focus on the same subject sufficient to enable capturing images for simultaneous multi-viewpoint photography. The initiating device may transmit adjustment information messages automatically to the responding devices showing or otherwise directing the users on how to reposition/reorient their devices or robotic vehicles. In some embodiments, the adjustment information to users may be displayed as an augmented reality overlay on the responding device screens. The adjustment information messages can include instructions to recommend the responding device users to adjust a distance, height, tilt angle, and or camera setting so each device establishes (i) a same distance from the subject in horizontal and vertical planes and (ii) the desired diversity in perspective (i.e. at varying degrees around the subject). In some embodiments, the specific adjustment information can be automatic based on depth-sensing, object recognition machine-learning, eye tracking, etc. When the wireless devices are camera-equipped robotic vehicles, the adjustment information messages from the initiating robotic vehicle device (i.e., the initiating robotic vehicle or initiating robotic vehicle controller) may direct responding robotic vehicle devices (i.e., responding robotic vehicles or robotic vehicle controllers), or their operators, on how to reposition the robotic vehicles in three-dimensional space.

While the responding devices are being manually or automatically repositioning/reorienting per the adjustment information messages, the initiating device may analyze received preview images from each of the responding devices to determine when the responding devices are in the proper orientations/locations/settings, and may alert the user when that is the case. For example, once orientation and position of the responding devices are in an acceptable range to acquire the desired images for simultaneous multi-viewpoint photography, a button or interface display may inform the user of the initiating device of a “ready” status of the responding device(s) (e.g., interface button appears as green/ready, displays notification message, etc.) indicating that the image or a series of images can be taken at any time. In response, the user of the initiating device may initiate the image capture process by hitting or selecting the button. In some embodiments, instead of waiting for the user of the initiating device to press a button or otherwise take the images for simultaneous multi-viewpoint photography, the initiating device may automatically initiate image capture by all of the wireless devices as soon as all devices are in the proper orientations/locations/settings to capture the an image (i.e. the ready status is achieved). If a position/orientation of one or more of the responding devices is altered before image capture may be initiated, then the ready status may change to a “not ready” status (e.g., button appears as red, image capture is no longer selectable) to inform the initiating devices and responding device(s) to readjust again.

In some embodiments, when the user of the initiating device pushes a button or selects a corresponding user display interface icon, or in response to achieving the “ready” state, the initiating device may transmit commands to the responding device(s) to cause the responding device(s) to capture images in a manner that enables an image from every wireless device to be captured at approximately the same time. This process may include operations to synchronize image capture among the participating wireless devices. In some embodiments, the initiating device may issue a command to processors of the responding device(s) to automatically capture images at a designated time. In some embodiments, the initiating device may issue a command to processors of the responding devices to begin capturing a burst of images and storing multiple images in a buffer associated with a time when each image was captured. Each of the wireless devices by store the images in memory. In embodiments in which responding devices capture births of images, the images may be stored in a cyclic buffer/local storage with corresponding timestamps. The initiating device may also store one or a set of images having timestamps or associated time tags/values. The timestamps may be based on precise timing information derived from an on-board local clock (e.g., crystal oscillator), which may be synchronized using time information from a global navigation satellite system (GNSS) receiver (e.g., a global positioning system (GPS) receiver), from wireless communication network timing, or from a remote server.

The responding devices may then transmit captured images to the initiating device. In embodiments in which the responding devices capture a burst of images, the initiating device may transmit to each of the responding devices a time at which the initiating device captured an image, and the responding devices may one or more images with a timestamp closest to the time received from the initiating device. For example, an initiating device may capture one image with a specific timestamp, each responding device may receive the timestamp of the master device image, and then each responding device may retrieve an image from the series of burst images within the cyclic buffer that has a timestamp closest to the initiating device image timestamp.

The responding devices may transmit the captured images to the initiating device, which may process the images to obtain the desired images for simultaneous multi-viewpoint photography using known image combination processing techniques. Alternatively, the initiating device may transmit captured and received images to a remote server for image processing. Alternatively, each of the initiating device in the responding devices may transmit the collected captured images directly to a remote server for image processing to create the multi-viewpoint rendering.

In addition to wireless devices, various embodiments may also be implemented on robotic vehicles capable of autonomous or semiautonomous locomotion, such as unmanned aerial vehicles (UAVs, unmanned ground vehicles, robots, and similar devices capable of wireless communications and capturing images. Using UAVs as an example, one or more UAVs may be operated according to various embodiments to capture simultaneous or near simultaneous images from different perspectives based upon the location and viewing angle of each of the devices. In some embodiments, one or more robotic vehicles may be used in combination with handheld wireless devices similar to the methods described above. In some embodiments, all of the wireless devices participating in a multi-view imaging session may be robotic vehicles (e.g., UAVs), including one of the robotic vehicles functioning as the initiating device. For example, in addition to providing unique viewing perspectives, modern UAVs have a number of functional capabilities that can be leveraged for capturing multi-perspective images.

UAVs typically have the capability of determining their position in three-dimensional (3D) space coordinates by receiving such information from GPS or GNSS receivers onboard the UAV. This capability may enable redirection messaging from the initiating device to identify a particular location in 3D space at which each UAV should be positioned to capture appropriate images for simultaneous multi-viewpoint photography. Further, each UAV can be configured to maintain a designated coordinate position in 3D space through station keeping or closed loop navigation processes. Unmanned ground and unmanned waterborne vehicles may have similar capabilities, although typically limited to 2D space coordinates (e.g., latitude and longitude).

Many robotic vehicles, including UAVs, have the ability to maintain station through an autopilot that enables the robotic vehicle to remain in the same location (including altitude for maneuvering a UAV) while maintaining a constant orientation or camera viewing angle. Such station keeping autopilot capability may be relied upon in various embodiments to minimize the amount of positional correction messaging required to maintain all robotic vehicles in a proper location and orientation to capture images for simultaneous multi-viewpoint photography.

Another capability of robotic vehicles that may be leveraged in various embodiments is the fact that many robotic vehicles are remotely controlled by robotic vehicle controllers, and therefore motion or positional commands are sent by the wireless control communication links. Thus, the repositioning messages of various embodiments may be configured for robotic vehicle implementation by leveraging the control command protocol and instructions that are already part of robotic vehicle control systems. In some embodiments, an initiating device or initiating robotic vehicle device may use this capability to bypass the individual controllers of each robotic vehicle by providing repositioning messages communicating repositioning messages directly between the initiating device or initiating robotic vehicle device and each responding robotic vehicle.

UAVs (versus ground or waterborne robotic devices) have the additional advantage of providing elevated views that may contribute to images for simultaneous multi-viewpoint photography. Thus, instead of just 360° views of an object, images for simultaneous multi-viewpoint photography may be obtained from several angles above an object in addition to the ground level views.

The capability of abilities of determining ordinate locations in 3D space plus orientation information in each UAV as well as the ability to maintain station at designated coordinates in 3D space enable some embodiments to simplify the set up for multi-viewpoint imaging by the initiating UAV instructing each of the other UAVs to fly to and maintain position (i.e., hover) at designated 3D coordinates that have been determined (e.g., by a user or the initiating device) to provide a suitable images for simultaneous multi-viewpoint photography. Responding UAVs may then maintain their position and viewing angle autonomously by through close loop flight control and navigation that function to minimize the error between actual position in 3D space and the designated location.

Various embodiments provide new functionality by enabling handheld wireless devices and robotic vehicle devices to capture near simultaneous multi-viewpoint images for use in generating 3D images, panoramic images and multi-viewpoint action images. While various embodiments are particularly useful for handheld wireless devices capturing images for simultaneous multi-viewpoint photography, the embodiments may also be useful for setting up and capturing images for simultaneous multi-viewpoint photography in which some wireless devices are positioned on stands or tripods as the embodiments provide tools for positioning and focusing each of the wireless devices engaged in capturing the images for simultaneous multi-viewpoint photography.

FIG. lA is a system block diagram illustrating an example communications system 100a according to various embodiments. The communications system 100a may be an 5G NR network, or any other suitable network such as a Long Term Evolution (LTE) network.

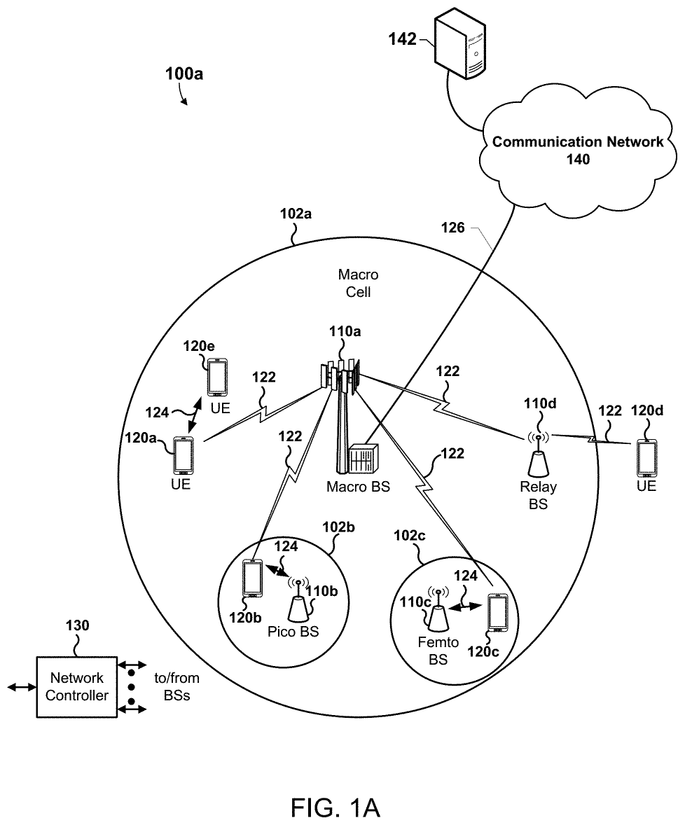

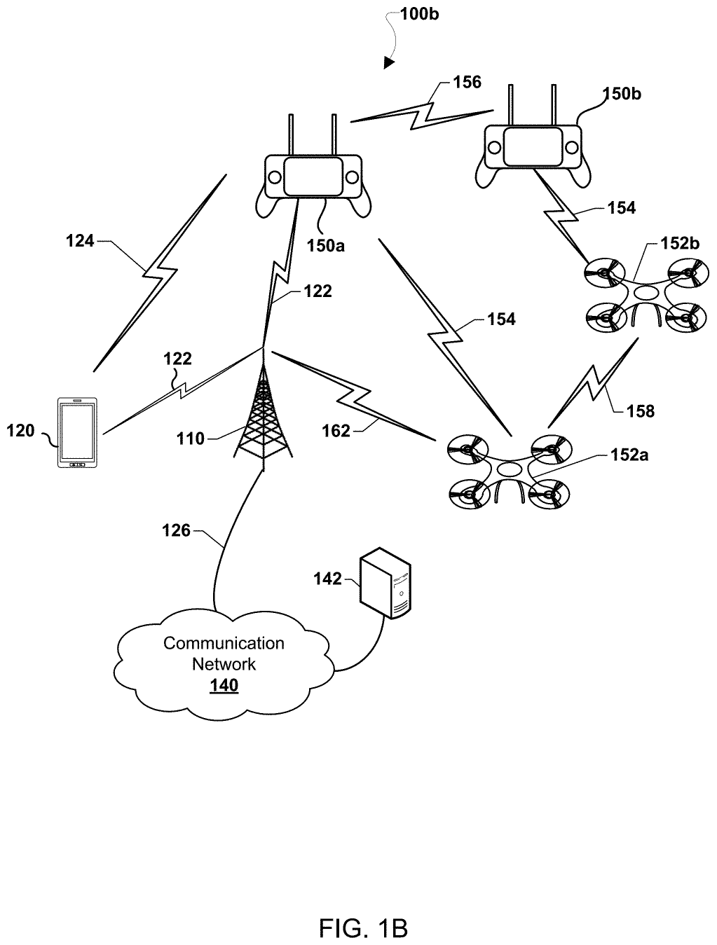

The communications system 100a may include a heterogeneous network architecture that includes a communication network 140 and a variety of wireless devices (illustrated as wireless device 120a-120e in FIG. 1). The communications system 100a also may include a number of base stations (illustrated as the BS 110a, the BS 110b, the BS 110c, and the BS 110d) and other network entities. A base station is an entity that communicates with wireless devices, and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3 GPP, the term “cell” can refer to a coverage area of a base station, a base station subsystem serving this coverage area, or a combination thereof, depending on the context in which the term is used.

In some embodiments, timing information provided by a network server (e.g., communication network 140) may be used by the wireless devices to synchronization timers or clocks for purposes of synchronized image capture. A synchronization timer derived from the network server may be used for purposes of determining which images captured by the wireless devices should be correlated to form a multi-viewpoint image as described with respect to some embodiments.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1A, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In various embodiments examples, a cell may not be stationary, and the geographic area of the cell may move according to the location of a mobile base station. In various embodiments, the base stations 110a-110d may be interconnected to one another as well as to one or more other base stations or network nodes (not illustrated) in the communications system 100a through various types of backhaul interfaces, such as a direct physical connection, a virtual network, or a combination thereof using any suitable transport network

The base station 110a-110d may communicate with the communication network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100a also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay base station 110d may communicate with the macro base station 110a and the wireless device 120d in order to facilitate communication between the base station 110a and the wireless device 120d. A relay station also may be referred to as a relay base station, a relay base station, a relay, etc.

The communications system 100a may be a heterogeneous network that includes base stations of different types, for example, macro base stations, pico base stations, femto base stations, relay base stations, etc. These different types of base stations may have different transmit power levels, different coverage areas, and different impacts on interference in communications system 100a. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100a, and each wireless device may be stationary or mobile. A wireless device also may be referred to as an access terminal, a terminal, a mobile station, a subscriber unit, a station, etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122, 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communications system 100a include medium range protocols such as Wi-Fi, LTE-U, LTE-Direct, LAA, MuLTEfire, and relatively short-range RATs such as ZigBee, Bluetooth, and Bluetooth Low Energy (LE).

Certain wireless networks (such as LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e. 6 resource blocks), and there may be 1, 2, 4, 8 or 16 subbands for system bandwidth of 1.25, 2.5, 5, 10 or 20 MHz, respectively.

In some implementations, two or more wireless devices 120a-e (for example, illustrated as the wireless device 120a and the wireless device 120e) may communicate directly using one or more sidelink channels 124 (for example, without using a base station 110 as an intermediary to communicate with one another).

Various embodiments may be implemented using robotic vehicles operating within similar communication systems with the added elements of wireless communication links two and between robotic vehicles, an example of which using UAVs as the robotic vehicles is illustrated in FIG. 1B. With reference to FIG. 1B, the communication system 100b may include one or more UAVs 152a, 152b under the control of the UAV controllers 150a, 150b, one or more wireless devices 120, a base station 110 operating as part of a communication network 140, which may be coupled to a remote server 142, such as a server configured to generate multi-image photography files based on images received from two or more wireless devices or UAVs. As described with reference to FIG. 1B, wireless devices 120 may be configured to communicate via a cellular wireless communication links 122 with the base station 110 or receiving communication services of the communication network 140.

Each UAV 152a, 152b may communicate with a respective UAV controller 150a, 150b over a wireless communication links 154. In some embodiments, UAVs may be capable of communicating directly with each other via wireless communication links 158. In some embodiments, UAVs 152a, 152b may be configured to communicate with a communication system base station 110 via wireless communication links 162. Further, UAV controllers 150a, 150b may be configured to communicate with one another via wireless communication links 156, as well as with base stations 110 of a communication network 140 via wireless communication links 122 similar to wireless devices 120, such as smart phones. In some embodiments, UAV controllers 150a, 150b may be configured to communicate with wireless devices 120 via side link communication channels 124. In some embodiments, the smart phone wireless devices 120 may be configured to function as UAV controllers, communicating directly with UAVs 152a, 152b similar to conventional UAV controllers (i.e., via communication links 154) or communicating with UAVs 152a, 152b via the communication network 140 over a wireless communication link 162 established between the base station 110 and a UAV 152a, 152b. The various wireless communication links 122, 124, 154, 156, 158, 162 a variety of RATs, including relatively short range RATs such as ZigBee, Bluetooth, and Bluetooth Low Energy (BLE), medium range protocols such as Wi-Fi, LTE-U, LTE-Direct, LAA, MuLTEfire, and, wireless wide area network (WWAN) protocols including LTE, 3G, 4G, 5G, GSM), CDMA, WCDMA, WiMAX, TDMA, and other mobile telephony communication technologies cellular RATs.

Ground and waterborne robotic vehicles may communicate via wireless communications in a manner very similar to UAVs as described with reference to FIG. 1B.

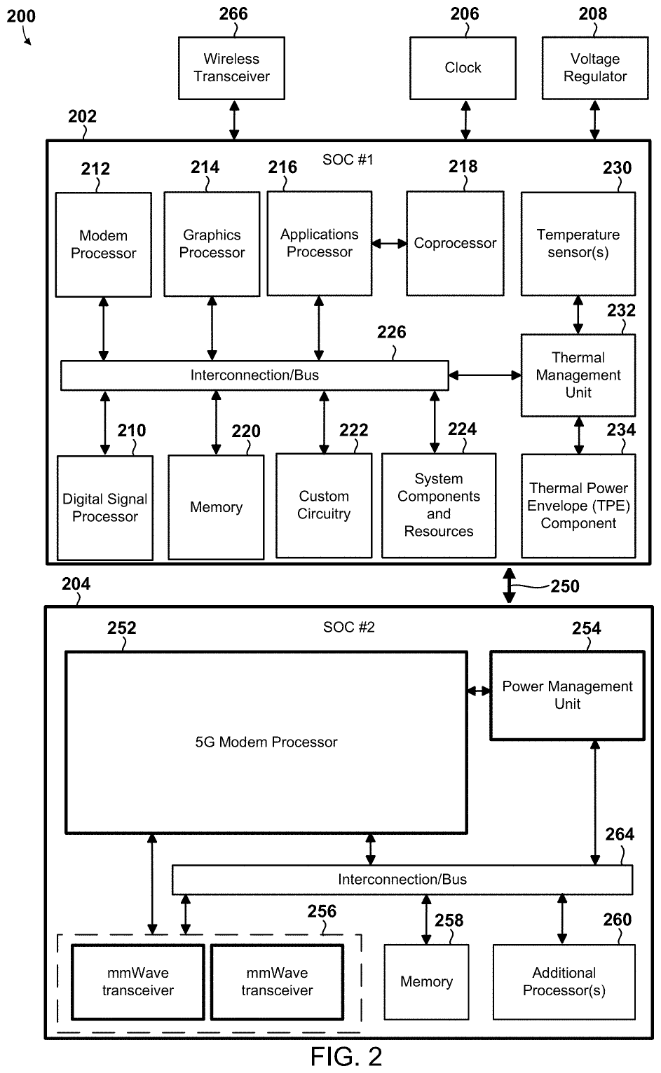

FIG. 2 is a component block diagram illustrating an example computing system in the form of a system in package (SIP) 200 for use in robotic vehicles, robotic vehicle controllers and wireless devices and configure to perform operations of various embodiments.

With reference to FIGS. 1A- 2, the illustrated example SIP 200 includes a two SOCs 202, 204, a clock 206, a voltage regulator 208, and a wireless transceiver 266. In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.). In some implementations, any or all of the processors 210, 212, 214, 216, 218, 252, 260 may be a component of a processing system. A processing system may generally refer to a system or series of machines or components that receives inputs and processes the inputs to produce a set of outputs (which may be passed to other systems or components of, for example, the first SOC 202 or the second SOC 250). For example, a processing system of the first SOC 202 or the second SOC 250 may refer to a system including the various other components or subcomponents of the first SOC 202 or the second SOC 250.

The processing system of the first SOC 202 or the second SOC 250 may interface with other components of the first SOC 202 or the second SOC 250, and may process information received from other components (such as inputs or signals), output information to other components, etc. For example, a chip or modem of the first SOC 202 or the second SOC 250 may include a processing system, a first interface to output information, and a second interface to receive information. In some cases, the first interface may refer to an interface between the processing system of the chip or modem and a transmitter, such that the first SOC 202 or the second SOC 250 may transmit information output from the chip or modem. In some cases, the second interface may refer to an interface between the processing system of the chip or modem and a receiver, such that the first SOC 202 or the second SOC 250 may receive information or signal inputs, and the information may be passed to the processing system. A person having ordinary skill in the art will readily recognize that the first interface also may receive information or signal inputs, and the second interface also may transmit information.

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, various implementations may be implemented in a wide variety of computing systems, which may include a single processor, multiple processors, multicore processors, or any combination thereof.

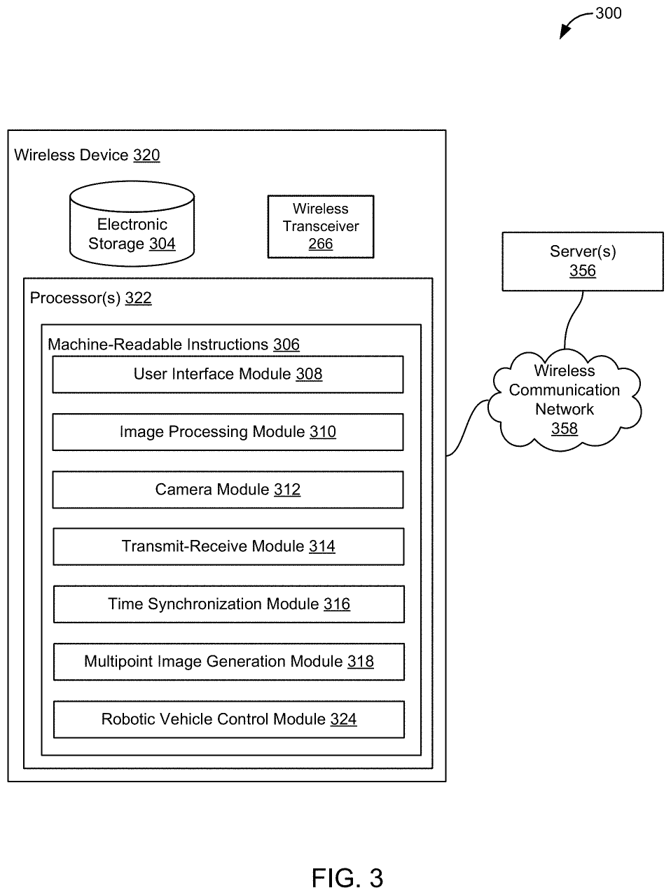

FIG. 3 is a component block diagram illustrating an example system 300 for performing synchronous multi-viewpoint photography according to various embodiments. With reference to FIGS. 1-3, the system 300 may include one or more wireless device(s) 120 (e.g., the wireless device(s) 120a-120e) and one or more server(s) 142, which may communicate via a wireless communication network 358.

The wireless device(s) 120, 150, 152 may be configured by machine-readable instructions 306. Machine-readable instructions 306 may include one or more instruction modules. The instruction modules may include computer program modules. The instruction modules may include one or more of a user interface module 308, an image processing module 310, a camera module 312, a transmit-receive module 314, a time synchronization module 316, a multi-viewpoint image generation module 318, a robotic vehicle control module 324, and other instruction modules (not illustrated). The wireless device 120, 150, 152 may include electronic storage 304 that may be configured to store information related to functions implemented by the user interface module 308, the image processing module 310, the camera module 312, the transmit-receive module 314, the time synchronization module 316, the multi-viewpoint image generation module 318, the robotic vehicle control module 324, and any other instruction modules. The wireless device 120, 150, 152 may include processor(s) 322 configured to implement the machine-readable instructions 306 and corresponding modules. In some embodiments, the electronic storage 304 may include a cyclic buffer to store one or more images having timestamps at which the images were captured.

The user interface module 308 may be used to display and provide a user interface capable of being viewed and interacted with by a user of the wireless device 120, 150, 152. The user interface module 308 may receive selections, such as on a display screen, from a user. For example, the user interface module 308 may receive selections made by a user to identify a subject or point of interest within an image or image feed as rendered in the user interface by the camera module 312. In some embodiments, the user interface module 308 may display image feed information from other wireless devices, such as a real-time image feed received by the wireless device 120, 150, 152 from another wireless device.

The image processing module 310 may be used to process images rendered or captured by the camera module 312. The image processing module 310 may process images, such as preview images used for configuring a setup to perform synchronous multi-viewpoint image capture, or captured images to be used for generating multi-viewpoint image files. In some embodiments, the image processing module 310 may perform image processing on images, image feeds, or video files. In some embodiments, the image processing module 310 may process images to determine a subject or point of interest, or to determine location and/or orientation parameters of a subject or point of interest, such parameters including a size, height, width, elevation, shape, distance from camera or depth, and camera and/or device tilt angle in three dimensions.

The camera module 312 may be used to capture images for performing synchronous multi-viewpoint image generation. In some embodiments, the camera module 312 may relay or output a real-time image feed to a user interface for displaying the observed contents of the camera view angle to a user of the wireless device 120, 150, 152.

The transmit-receive module 314 may perform wireless communication protocol functions for communicating with various devices, including other wireless devices (e.g., an initiating device, responding device). The transmit-receive module 314 may transmit or receive instructions according to various embodiments. In some embodiments, the transmit-receive module 314 may transmit or receive time synchronization signals, clocks, instructions, or other information for purposes of synchronizing the wireless device 120, 150, 152 with one or more wireless devices.

The time synchronization module 316 may store a time synchronization signal for purposes of synchronizing the wireless device 120, 150, 152 with one or more wireless devices. The time synchronization module 316 may use the stored timer or clock signal to allocate a time value or timestamp to an image when an image is captured by the camera module 312. In some embodiments, the time synchronization module 316 may receive a time value or timestamp associated with one or more images captured by another wireless device to identify one or more images having time values or timestamps approximate to the received time value.

The multi-viewpoint image generation module 318 may generate one or more synchronous multi-viewpoint image files based on at least two images having different perspectives of a subject or a point of interest or multiple subjects or points of interest. The multi-viewpoint image generation module 318 may generate synchronous multi-viewpoint images using at least one image captured by the camera module 312 and at least one image received from at least one other wireless device. Depending on the image capture mode implemented by a user of the wireless device 120, 150, 152 or another wireless device, the image file generated by the multi-viewpoint image generation module 318 may have varying stylistic and/or perspective effects (e.g., 3D, panoramic, blur or time lapse, multi-viewpoint, 360-degree 3D, and 360-degree panoramic mode).

The robotic vehicle control module 324 may perform operations to allow the wireless device 120, 150, 152 (e.g., a robotic vehicle controller device) to control the attitude and altitude of a robotic vehicle (e.g., a UAV) paired with the wireless device 120, 150, 152.

The wireless device 120, 150, 152 may be implemented as an initiating device and a responding device as described by embodiments. For example, the wireless device 120, 150, 152 may be utilized as an initiating device in one configuration or image capture event, and may also be utilized as a responding device in another configuration or image capture event occurring at a different time.

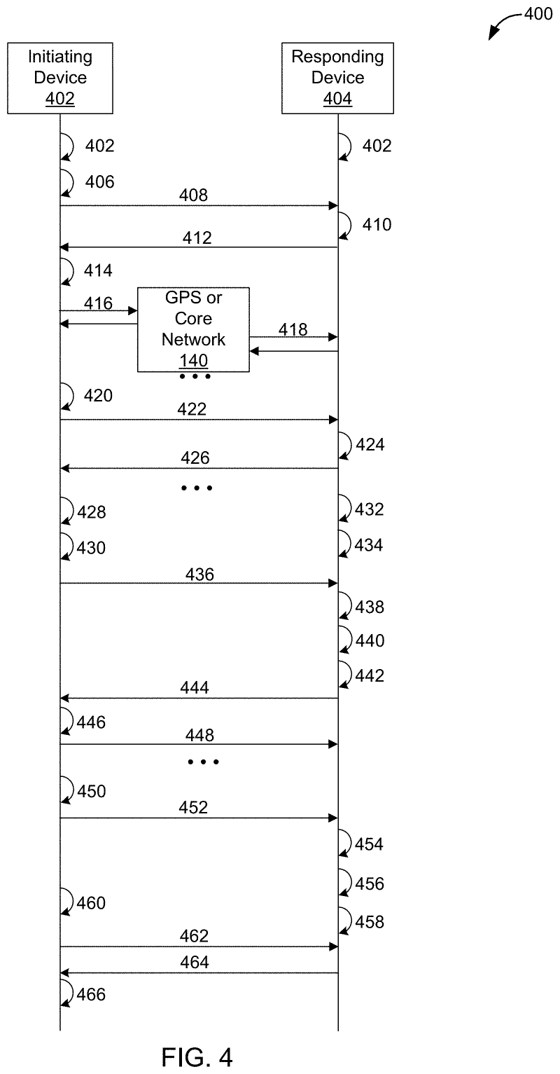

FIG. 4 is a message flow diagram 400 illustrating operations and device-to-device communications for performing synchronous multi-viewpoint photography according to some embodiments. The operations and communications for performing synchronous multi-viewpoint photography illustrated in FIG. 4 may be implemented using at least two wireless devices. For example, the communications illustrated in FIG. 4 may be performed between two (or more) user equipment devices (e.g., smailphone), between two robotic vehicle controllers controlling two camera-equipped robotic vehicles, between two camera-equipped robotic vehicles, and between a user equipment device (e.g., a smailphone) and a camera-equipped robotic vehicle or a robotic vehicle controller controlling a camera-equipped robotic vehicle. As the operations and communications illustrated in FIG. 4 may be performed implementations using wireless devices (e.g., smailphones) in conjunction with robotic vehicle devices as well as in solely using robotic vehicle devices (i.e., robotic vehicles and robotic vehicle controllers), both hand held wireless devices and robotic vehicles, as well as controllers of robotic vehicles, are referred to in the description of FIG. 4 as wireless devices or simply devices. Some of the operations or communications illustrated in FIG. 4 may not be performed in all embodiments, and operations and communications may be performed in a different order than the example shown in FIG. 4.

Referring to FIG. 4, in operation 402, an initiating device 402 may launch a multi-viewpoint image capture application. A user of the initiating device 402 may select a multi-viewpoint image capture application stored on the device or otherwise configure the initiating device 402 for performing synchronous multi-viewpoint photography.

In operation 404, a responding device 404 may launch a multi-viewpoint image capture application. A user of the responding device 404 may initiate a multi-viewpoint image capture application or otherwise configure the responding device 404 for performing synchronous multi-viewpoint photography.

In operation 406, the initiating device 402 may detect other devices within wireless communication range that have launched the multi-viewpoint image capture application or are otherwise configured for performing synchronous multi-viewpoint photography. For example, the initiating device 402 may include an interface displaying all wireless devices available for performing synchronous multi-viewpoint photography, and a user may select one or more available devices to establish device-to-device communications with.

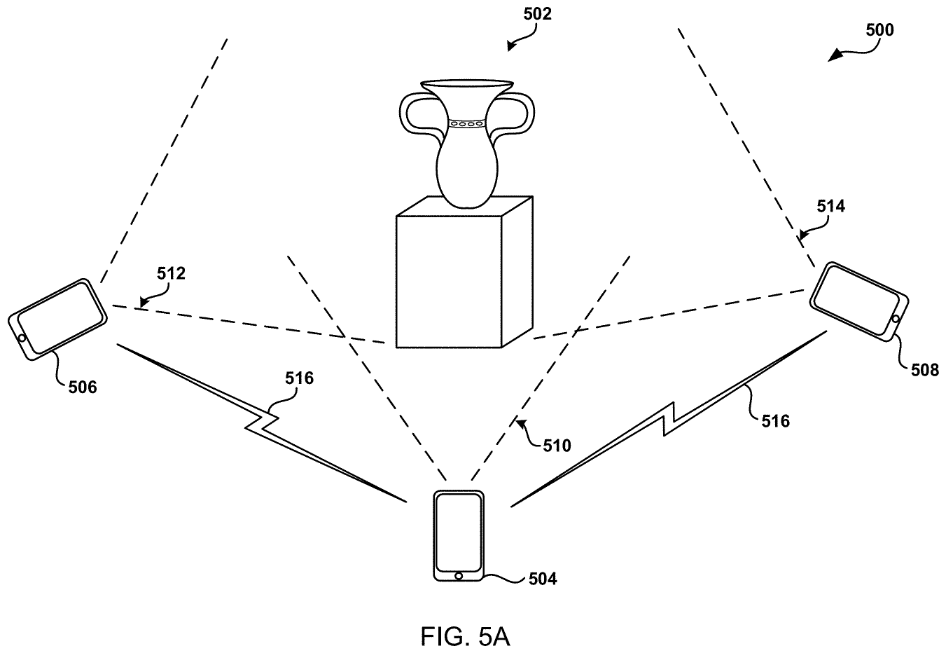

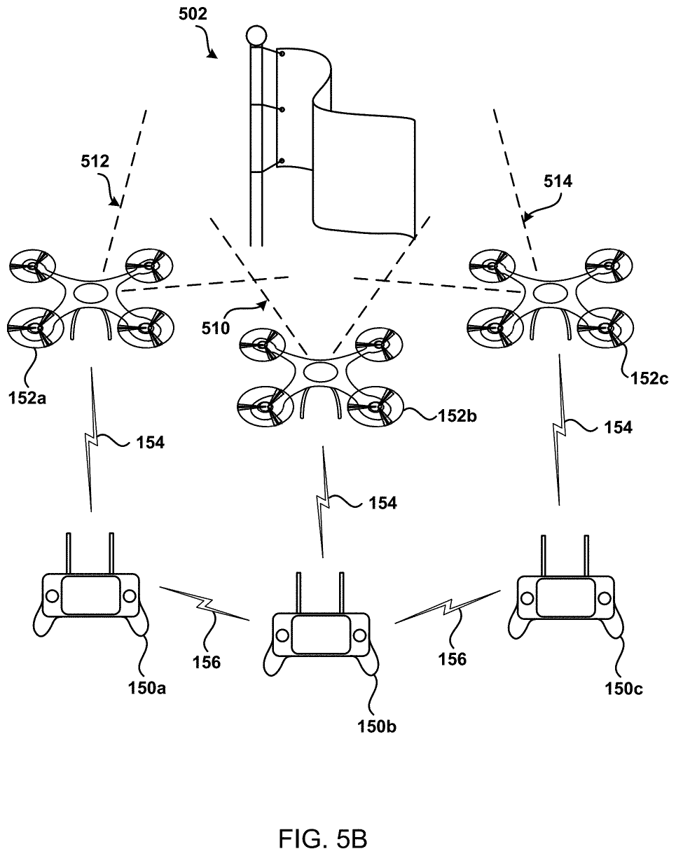

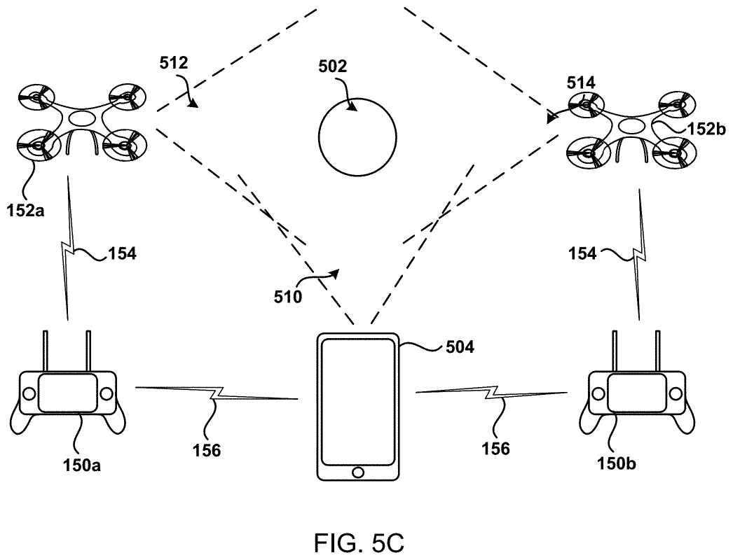

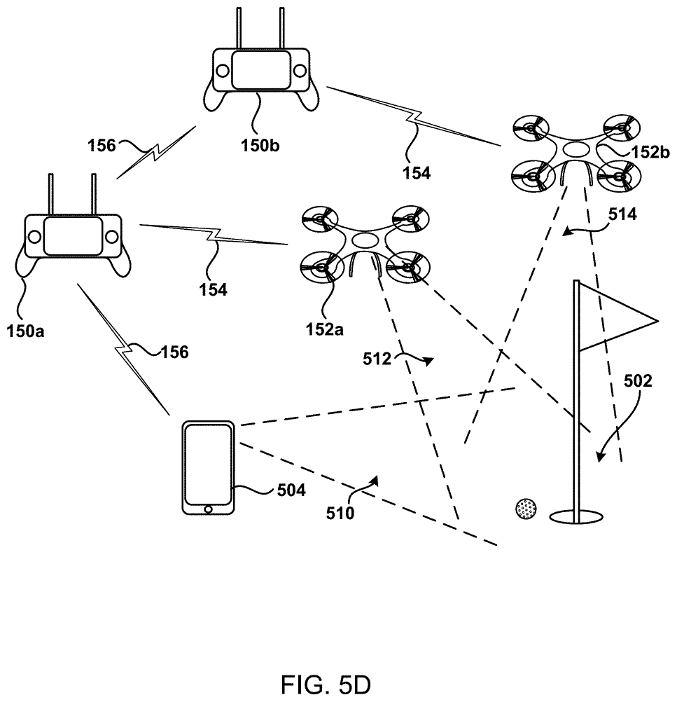

In communication 408, the initiating device 402 may send a request to establish device-to-device wireless communications with the responding device 404. For example, FIG. 5A illustrates an example 500 of three wireless devices 504, 506, 508 available for performing 3D multi-viewpoint photography of a point of interest 502 according to various embodiments. With reference to FIG.1-5A, a user operating the wireless device 504 (e.g., initiating device 402) may see that the wireless device 506 (e.g., responding device 404) is available to establish device-to-device communications, and may select to pair or otherwise establish wireless communication links between the wireless devices 504 and 506. The wireless devices 504, 506, and 508 may be oriented in such a way as to synchronously capture images to create a 3D rendering of the point of interest 502. The wireless devices 504, 506, and 508 have camera view angles 510, 512, and 514 respectively for synchronously capturing images of the point of interest 502. The wireless devices 504, 506, and 508 may present display interfaces that inform users of the wireless devices 504, 506, and 508 about how to align or adjust camera view angles 510, 512, and 514 with respect to the point of interest 502. The wireless devices 504, 506, and 508 may communicate using a device-to-device wireless communication links 516, and with the wireless device 508 via the wireless connection 516. The wireless connections 516 may be any form of close-range wireless communications protocols, such as LTE-D, LTE sidelink, WiFi, BT, BLE, or near field communication (NFC).

FIG. 5B illustrates a similar situation involving three camera-equipped UAVs 152a-152c are available for performing 3D multi-viewpoint photography of a point of interest 502 according to various embodiments. With reference to FIG.1-5B, each of the camera-equipped UAVs 152a-152c may be controlled via wireless communication links 154 by respective UAV controllers 150a-150c. Operators using the UAV controllers 150a-150c may maneuver their respective UAVs 152a-152c in response to maneuver instructions, which may be exchanged via controller-to-controller wireless communication links 156, so that the fields of view 510, 512, 514 of cameras on each UAV focus on the point of interest 502 from different angles.

FIG. 5C illustrates another example of multi-viewpoint photography enabled by camera-equipped UAVs in which two camera-equipped UAVs 152a, 152b and a smartphone initiating device 504 are used for multi-viewpoint photography of a point of interest 502. With reference to FIG.1-5C, in the illustrated example, the two camera-equipped UAVs 152a, 152b and a smartphone initiating device 504 are positioned around the point of interest similar to the examples illustrated in FIGS. 5A and 5B. The use of UAVs 152a, 152b as illustrated may be helpful for generating a 3D image of a point of view 502 where the alternative viewpoints are not accessible except by a UAV, such as imaging a person or object positioned on a point of land (e.g., at the edge of the Grand Canyon).

FIG. 5D illustrates another example of multi-viewpoint photography enabled by camera-equipped UAVs in which a camera-equipped UAV 152 and a smartphone initiating device 504 capture images at ground level from two perspectives and another UAV 152b is positioned to capture images of the point of interest 502 from above.

Referring again to FIG. 4, in response to the user initiating device-to-device communications, a processor of the initiating device 402 may transmit a request to establish device-to-device communications to the responding device 404. The request to establish communications between the initiating device 402 and the responding device 404 may be according wireless communications protocols such as LTE-D, LTE sidelink, WiFi, BT, BLE, and the like.

In response to receiving the request to establish device-to-device communications from the initiating device as described in communication 408, the responding device may display a notification to the user of the responding device during the user the option of accepting or declining the request to establish communications in operation 410.

In communication 412, the initiating device 402 may receive a confirmation to establish device-to-device wireless communications from the responding device 404. In response to receiving the confirmation from the responding device 404, the initiating device may begin the process of negotiating or otherwise creating a device-to-device connection (e.g., LTE-D, LTE sidelink, WiFi, BT, BLE, etc.) between the initiating device 402 and the responding device 404.

In operation 414, the initiating device 402 may receive a selection to operate as a controlling device. The user of the initiating device 402 may select, via a display interface of the initiating device 402, whether to assign control of the multi-viewpoint image capture process to the initiating device 402 in a master-slave configuration as opposed to the responding device. For purposes of this example, the initiating device 402 has been configured or otherwise selected to be the controlling device, hence being labeled an “initiating” device. In examples where the user of a first wireless device assigns or cedes control of the multi-viewpoint image process to another wireless device, then the first wireless device may transition from an “initiating” device into a “responding” device. Similarly, if a responding device is given control or the role of sending positioning and image capture instructions to other devices, the “responding” device may become the “initiating” device. In some embodiments, the responding device 404. The “initiating” device may control or signal when to initiate image capture and any “responding” device in wireless communication with the initiating device may begin image capture in response to the initiating device initiating image capture.

In some embodiments, operation 414 may be bypassed by configuring the initiating device 402 to be automatically set as the controlling device when sending a request to establish device-to-device communications as described in communication 410.

In communications 416 and 418, the initiating device 402 and the responding device 404 may individually request or obtain a synchronization timer or clock for purposes of synchronized image capture. Such time synchronization may be accomplish using various methods, including the initiating device announcing a current time on its internal clock, or the initiating device in responding device using an external time reference, such as a GNSS time signal or a network time signal, such as broadcast by base station of a communication network (e.g., 140). The synchronized clocks or a synchronization timer may be used in each of the participating wireless devices for purposes of capture of images by the initiating device 402 and the responding device 404 as described herein. The synchronization timer may be stored by both the initiating device 402 and the responding device 404. In some embodiments, time signals from a GNSS receiver may be used as a synchronized clock or reference clock.

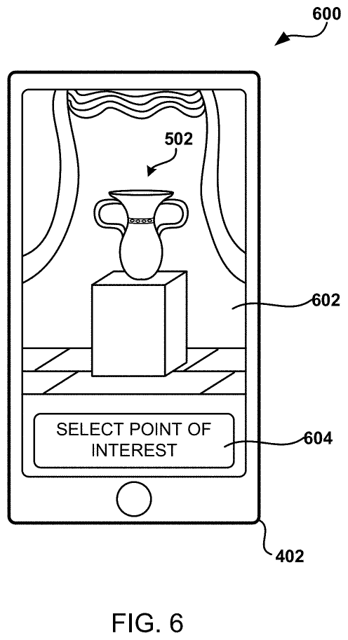

In operation 420, the initiating device 402 may display a preview image feed captured by a camera of the initiating device 402. The initiating device 402 may display the preview image feed in real time to a user via a user interface. For example, the initiating device 402 may display, through the multi-viewpoint image capture application or an existing camera application in communication with the multi-viewpoint image capture application, an image feed as captured by the camera of the initiating device 402. FIG. 6 illustrates an initiating device 600 displaying an example of a user interface display 602 including a point of interest 502 that may be presented on a display of the initiating device. A camera of the initiating device 402 may capture, in real time, a series of preview images or a preview image feed to output to the user interface display 602. Similar displays may be presented on robotic vehicle controllers in implementations using one or more camera-equipped robotic vehicles for capturing some of the images used in simultaneous photography.

In communication 422, the initiating device 402 may transmit an image feed to the responding device 404. The real-time preview image feed captured by the camera of the initiating device 402 as described in operation 420 may be transmitted to the responding device 404 for use display to the user of the responding device so as to inform that user of the point of interest desired for multi-viewpoint photography. This may assist the user in initially pointing the responding device 404 at the point of interest. In some embodiments, the preview image or a series of preview images may be transmitted to the responding device 404 over a period of time to reduce the total data transmission amount as compared to transmitting an image feed in real time.

In operation 424, the responding device 404 may display a preview image feed captured by a camera of the responding device 404. The responding device 404 may display the preview image feed in real time to a user via a user interface. For example, the responding device 404 may display, through the multi-viewpoint image capture application or an existing camera application in communication with the multi-viewpoint image capture application, a preview image feed as captured by the camera of the responding device 404. FIG. 8 illustrates an example user interface display 800 of a responding device showing preview images captured by the camera of the responding device 402 when the cameras pointed at the point of interest 502. Similar displays may be presented on robotic vehicle controllers in implementations using one or more camera-equipped robotic vehicles for capturing some of the images used in simultaneous photography.

In communication 426, the responding device 404 may transmit a preview image or image feed to the initiating device 402. The real-time image feed captured by the camera of the responding device 404 as described in operation 424 may be transmitted to the initiating device 402 for use in later operations (e.g., determining an adjustment to the orientation of the responding device 404 based on the responding device 404 image feed). In some embodiments, an image or a series of images may be transmitted to the initiating device 402 over a period of time to reduce the total data transmission amount as compared to transmitting an image feed in real time.

Operations 420 and 424 and communications 422 and 426 enabling the initiating and responding devices to share preview images may be repeated continuously throughout the processes described in FIG. 4.

In operation 428, the initiating device 402 may receive a user selection of a point of interest, or subject of interest, within the image feed. As illustrated in FIG. 6, a user of the initiating device 402 may be prompted by the user interface display 602 via an indicator 604 to begin selecting one or more points of interest 502. The user may select, via the user interface display 602, a point of interest according to conventional methods for identifying points of interest within a real-time image feed, such as interacting with a touch-screen to focus on an object at a depth or distance from the camera of the user device.

In operation 430, the initiating device 402 may determine location and/or orientation parameters of the initiating device 402. In some embodiments, the location and/or orientation parameters may be based on the user selection of the point of interest as described in operation 428. Location and/or orientation parameters of the initiating device 402 may include location, distance from the selected point of interest, camera settings such as zoom magnification, camera and/or device tilt angle, and elevation with respect to the selected point of interest. In some embodiments, location and/or orientation parameters may be based at least on image processing of the displayed image feed and/or an image captured by the camera of the initiating device 402. A location of the initiating device 402 may be determined by, or in any combination with, Global Navigation Satellite System (GNSS) satellite tracking and geolocation (e.g., via a Global Positioning System (GPS) receiver), WiFi and/or BT pinging, and accelerometers and gyroscopes. A distance between the initiating device 402 and the selected point of interest may be determined using image processing on the real-time image feed and/or on an image taken during the selection of the point of interest. For example, a real-world physical distance between the initiating device 402 and the selected point of interest may be determined by analyzing an apparent size of the point of interest within preview images, a lens focal depth, zoom magnification, and other camera settings. A tilt angle of the camera may be determined by accelerometers and gyroscopes within the camera module and/or initiating device 402 (assuming the camera is affixed to the initiating device 402), as well as image processing of preview images. An elevation of the camera and/or initiating device 402 may be determined by a combination of image processing (e.g., determining where the point of interest is located within a captured image frame of the camera view angle) and accelerometers and gyroscopes. In some embodiments, the initiating device 402 may implement image-processing techniques, such as depth-sensing, object recognition machine-learning, and eye-tracking technologies, to determine location and/or orientation parameters of the initiating device 402, with or without respect to a point of interest.

In operation 432, the responding device 404 may receive a user selection of a point of interest, or subject of interest, within the image feed. A user of the responding device 404 may be prompted by the user interface display to begin selecting one or more points of interest. The user may select a point of interest according to conventional methods for identifying points of interest within a real-time image feed, such as interacting with a touch-screen to focus on an object at a depth or distance from the camera of the user device.

After device-to-device communications have been established, the user of the responding device 404 and the user of the initiating device 402 may seek to simultaneously capture images focused on a point of interest, such that the captured images can be collated or combined to form 3D images, panoramic images, or temporally-related images (e.g., blurred images, time-lapsed images, multi-viewpoint image capture, etc.). For example, in operation 432, the user of the responding device 404 may select a point of interest similar to the point of interest selected by the user of the initiating device 402 as described in operation 428. FIGS. 6 and 8 illustrate examples of users of the initiating device 402 and the responding device 404 selecting or otherwise identifying the similar point of interest 502 for purposes of capturing multiple images from different viewpoints with respect to the point of interest 502. Similar displays may be presented on robotic vehicle controllers in implementations using one or more camera-equipped robotic vehicles for capturing some of the images used in simultaneous photography.

In operation 434, the responding device 404 may determine location and/or orientation parameters of the responding device 404 based on the user selection of the point of interest as described in operation 432. Location and/or orientation parameters of the responding device 404 may include location, distance from the selected point of interest, camera settings such as zoom magnification, camera and/or device tilt angle, and elevation with respect to the selected point of interest. In some embodiments, location and/or orientation parameters may be based at least on image processing on the displayed image feed and/or an image captured by the camera of the responding device 404. A location of responding device 404 may be determined by, or in any combination with, GNSS satellite tracking and geolocation, WiFi and/or BT pinging, and accelerometers and gyroscopes. A distance between the responding device 404 and the selected point of interest may be determined using image processing on the real-time image feed and/or on an image taken during the selection of the point of interest. For example, a real-world physical distance between the responding device 404 and the selected point of interest may be determined by analyzing a lens focal depth, zoom magnification, and other camera settings. A tilt angle of the camera may be determined by accelerometers and gyroscopes within the camera module and/or responding device 404 (assuming the camera is affixed to the responding device 404), as well as image processing of preview images (e.g., to locate the point of interest within the field of view of preview images). An elevation of the camera and/or responding device 404 may be determined by a combination of image processing (e.g., determining where the point of interest is located within a captured image frame of the camera view angle) and accelerometers and gyroscopes.

Operations 428 through 434 may be repeated simultaneously and continuously throughout the processes described in FIG. 4. For example, points of interest may be selected, reselected, or otherwise adjusted, and location and/or orientation parameters may be continuously determined at any time with respect to the processes described in FIG. 4.

In communication 436, the initiating device 402 may transmit location and/or orientation adjustment information to the responding device 404. The location and/or orientation adjustment information may include information useable by the responding device 404 and/or the user of the responding device 404 to adjust a position and/or orientation of the responding device 404 and/or one or more features or settings of the responding device 404. The location and/or orientation information may be configured to enable the responding device 404 to display the location and/or orientation adjustment information on the user interface display (e.g., 802) of the responding device 404. The location and/or orientation information may include the location and orientation parameters of the initiating device 402 as determined in operation 430. In some embodiments, the location and/or orientation information may include a configuration image, such as an image captured during the selection of a point of interest as described in operation 428, or a real-time preview image feed or portions of a real-time image feed, such as described in communication 422.

In some embodiments, the location and/or orientation adjustment information may include commands to automatically execute adjustments to features or settings of the responding device 404. For example, the location and/or orientation adjustment information may include commands to automatically adjust a zoom magnification of the camera of the responding device 404 to be equivalent to the zoom magnification of the camera of the initiating device 402. In embodiments including camera-equipped robotic vehicles, the location and/or orientation adjustment information may include commands or information to cause the responding robotic vehicle to maneuver to adjust a position of the robotic vehicle and/or an orientation of the camera.

In operation 438, the responding device 404 may display the location and/or orientation adjustment information on a user interface display of the responding device 404. As described with reference to FIG. 8, the indicator 804 may display the location and/or orientation adjustment information to the user to adjust an orientation, setting, or feature of the responding device 404. For example, the location and/or orientation adjustment information may configure the indicator 804 to display messages to the user such as “move 1 meter closer,” “zoom in,” “tilt camera up,” “turn on flash,” “tilt camera sideways,” or any other message of varying specificity or degree for adjusting the physical location or orientation of the responding device and/or any feature of the camera. Similar displays may be presented on robotic vehicle controllers in implementations using one or more camera-equipped robotic vehicles for capturing some of the images used in simultaneous photography.

In some embodiments, the responding device 404 may display a configuration image or real-time image feed of the initiating device. The user may reference the configuration image or real-time image feed to determine and perform adjustments to the orientation, features, or settings of the camera and/or responding device 404. For example, the user may determine, based on the visual reference of a real-time image feed, to move closer to the point of interest to be at a similar or equivalent distance from the point of interest as the initiating device 402.

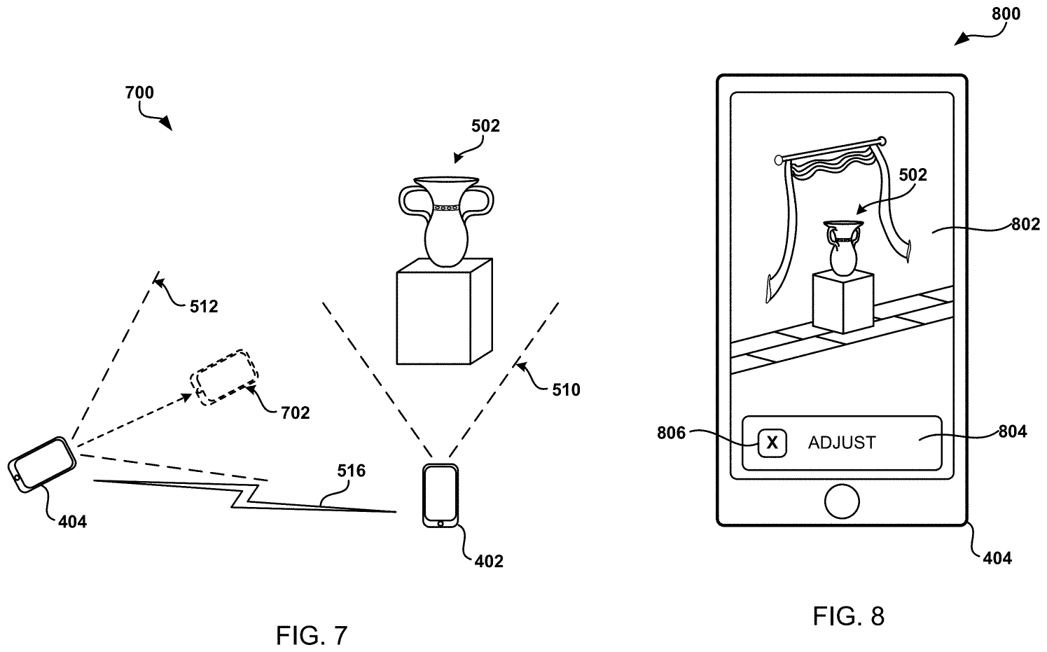

FIG. 7 illustrates an imaging set up 700 in which location and/or orientation adjustment information provided by the initiating device is displayed on the user interface of the responding device 404. In the illustrated example, the location and/or orientation adjustment information indicates that the user should move closer by a certain amount or distance to orient the responding device 404 into new location 702 having a distance from the point of interest 502 that is similar to the distance of the initiating device 402 from the point of interest 502. Similar displays may be presented on robotic vehicle controllers in implementations using one or more camera-equipped robotic vehicles for capturing some of the images used in simultaneous photography.

Referring back to FIG. 4, in operation 440, a user of the responding device 404 may adjust the location and/or orientation of the responding device 404. In some embodiments in which the location and/or orientation adjustment information received from the initiating device 402 in communication 436 includes commands to automatically adjust features or settings of the responding device 404, the responding device may execute those commands. In some embodiments, the commands to adjust features or settings of the responding device 404 may be executed automatically upon receipt, or after the user of the responding device 404 approves the execution of the commands (e.g., via a prompt on the user interface display). For example, based on the received location and/or orientation adjustment information, the responding device 404 may automatically increase a zoom magnification setting of the camera to further focus on a point of interest.

In operation 442, the responding device 404 may determine current location and orientation parameters of the responding device 404. The responding device 404 may determine updated location and orientation parameters of the responding device 404 in response to any adjustments made during operation 440.

In communication 444, the responding device 404 may transmit the updated location and orientation parameters to the initiating device 402. The initiating device 402 may receive the updated location and orientation parameters of the responding device 404 for purposes of determining whether further adjustments to the location and/or orientation of the responding device 404 should be made prior to capturing images for multi-viewpoint image photography.

In some embodiments, the responding device 404 may transmit, along with the updated location and/or orientation parameters, a preview image or images, such as an image captured during the selection of a point of interest as described in operation 432, or a real-time preview image feed or portions of a real-time image feed, such as described in communication 426.

In operation 446, the initiating device 402 may determine whether the updated location and/or orientation parameters of the responding device 404 received in communication 444 correspond to the location and/or orientation adjustment information transmitted in communication 436. In other words, the initiating device 402 may determine whether the responding device 404 is “ready” to perform synchronous multi-viewpoint photography, such by determining whether the responding device 404 is at an appropriate location and orientation (e.g., elevation, tilt angle, camera settings and features, etc.). In some embodiments, operation 446 may involve comparing preview images of the initiating device with preview images received from the responding devices to determine whether the point of interest is similarly positioned and of a similar size in each of the device preview images. When the preview images are aligned, the collection of wireless devices may be ready to capture images for simultaneous multi-viewpoint photography of the point of interest.

The desired location and orientation of a responding device with respect to a point of interest and an initiating device may vary depending on the photography or video capture mode enabled. For example, a 3D image capture mode may indicate to the users of an initiating device and any number of responding devices to be at an equivalent distance from a point of interest and to have a same tilt angle. As another example, a panoramic image capture mode may indicate to the users of an initiating device and any number of responding devices to orient the devices in a linear manner with cameras facing a same direction (e.g., a horizon).

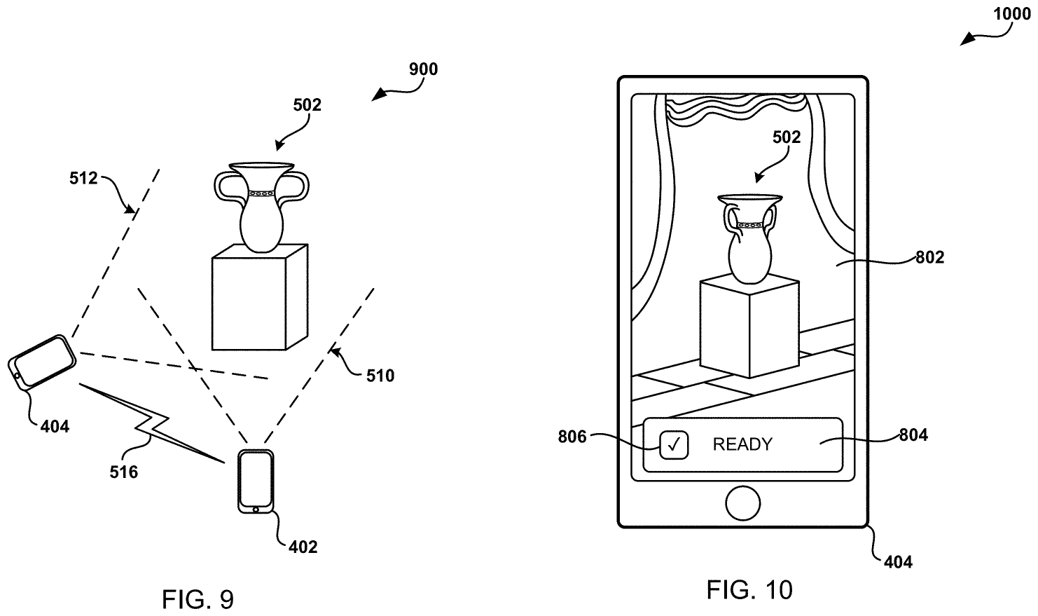

FIG. 9 illustrates an imaging set up 900 after the user of the responding device 404 has adjusted the position of the responding device 404 based on the adjustment instructions provided by the initiating device 402 as shown in FIG. 7. So positioned, the two wireless devices 402, 404 are at a similar distance from the point of interest 502, and so ready to capture a simultaneous multi view image of the point of interest. Similar displays may be presented on robotic vehicle controllers in implementations using one or more camera-equipped robotic vehicles for capturing some of the images used in simultaneous photography.

Referring back to FIG. 4, in some embodiments, determining whether the updated location and/or orientation parameters of the responding device 404 received in communication 444 correspond to the orientation adjustment information transmitted in communication 436 may include determining whether the updated location and/or orientation parameters are within a threshold range of the orientation adjustment information. In some embodiments, this may involve determining whether the relative position of the point of interest in each of the preview images is within a threshold distance of each other sufficient so that the images can be processed to generate a suitable 3D image of the point of interest. For example, the initiating device 402 may determine that a responding device 404 is in a ready state if the camera tilt angle is at least within a threshold range of 5 degrees. As another example, the initiating device 402 may determine that a responding device 404 is in a ready state if within 0.25 meters of a desired location with respect to a point of interest. Image processing may be implemented after obtaining a preview image to account for any variance within a tolerable threshold range for the location and/or orientation parameters of any responding device.

If the initiating device 402 determines that the updated operating parameters of the responding device 404 do not correspond to the location and/or orientation adjustment information (i.e. the responding device 404 location and orientation vary too much from the orientation adjustment information) or the preview images of the various wireless devices are not suitably aligned, and is therefore the wireless devices are not “ready” two capture the images for simultaneous multi-viewpoint photography, the processes n communication 436, operations 438 through 442, and communication 444 may be repeated until the updated location and/or orientation parameters correspond to the location and/or orientation adjustment information or the various preview images lying within the threshold tolerance.

The initiating device 402 may compare location and/or orientation adjustment information with the updated location and/or orientation parameters received from the responding device 404 to determine updated location and/or orientation adjustment information. For example, as illustrated in FIG. 7, the user, based on the original location and/or orientation adjustment information received in communication 436, may relocate the responding device 404. However, the user may move past the location 702 to orient the responding device 404 too close to the point of interest 502 with respect to the location of the initiating device 402. As illustrated in FIG. 8, the responding device 404 indicator 806 would therefore not indicate a ready status. The initiating device 402 would then receive the latest location and/or orientation parameters or preview images of the responding device 404 in communication 444. The initiating device 402 may then determine that the received latest location and/or orientation parameters of the responding device 404 do not correspond to the location and/or orientation adjustment information or that the preview images do not align. Thus, the initiating device 402 may determine a difference between the latest location and/or orientation parameters of the responding device 404 and the last-transmitted location and/or orientation adjustment information. For example, the initiating device 402 may determine that the location and/or orientation parameters and the location and/or orientation adjustment information differ by −0.5 meters. Thus, the initiating device 402 may repeat processes described in communication 436 to transmit updated location and/or orientation adjustment information to the responding device 404 based on the last received location and/or orientation parameters of the responding device 404 to enable the user of the responding device 404 to readjust based on the updated location and/or orientation adjustment information. For example, the updated location and/or orientation adjustment information may include an instruction to configure the display 802 of the responding device to display to the user “move back 0.5 meters.”

In some embodiments, the initiating device 402 may display a configuration image or real-time preview image feed from the responding device 404. The user of the initiating device 402 may use the configuration image or real-time preview image feed to determine whether the responding device 404 is positioned to capture the desired images for simultaneous multi-viewpoint photography, and may then provide an indication to be transmit to the responding device to indicate the acknowledgment of a “ready” status. For example, the user of the initiating device 402 may determine, based on the visual reference of a configuration from the responding device 404, to determine that all devices are ready to begin image capture. This may be useful when performing synchronous multi-viewpoint photography in a multi-viewpoint mode involving multiple different points of interest.

If the initiating device 402 determines that the updated parameters of the responding device 404 correspond to the location and/or orientation adjustment information or that the multiple preview images online within a predetermined threshold difference, the initiating device may be permitted to begin the image capture process. Until processor determines that all of the wireless devices are appropriately positioned to capture the images for simultaneous multi-viewpoint photography, the initiating device 402 may be prevented from starting the image capture process. Until all wireless devices are ready, the initiating device 402 may display an indication that at least one connected responding device is not in a ready state, but may allow the initiating device to proceed regardless of the status of the responding devices.

Referring back to FIG. 4, in communication 448, the initiating device 402 may transmit an instruction to the responding device 404 to indicate that the updated location and/or orientation parameters of the responding device 404 received in communication 444 correspond to the location and/or orientation adjustment information transmitted in communication 436 (i.e., the responding device 404 is ready). As illustrated in FIG. 8, the indicator 806 may indicate that the responding device 404 is not in a ready status, indicating to the user that the location, orientation, and/or features or settings of the responding device 404 need to be adjusted. FIG. 10 illustrates a user interface display 1000 of a responding device showing an indicator 806 indicating that the responding device 404 is positioned so that the system of wireless devices is ready to capture the images for simultaneous multi-viewpoint photography. Similar displays may be presented on robotic vehicle controllers in implementations using one or more camera-equipped robotic vehicles for capturing some of the images used in simultaneous photography. This may indicate to the user other responding device 404 that he/she should hold the wireless device steady at the location and orientation until the images captured. In some embodiments, the indicator 806 may indicate a default state of “not ready.” In some embodiments, a ready status as shown by indicator 806 may revert to a “not ready” status if the latest location and/or orientation parameters of the responding device 404 are altered to be outside the acceptable threshold range as determined by the location and/or orientation adjustment information of the initiating device 402.

Referring back to FIG. 4, in operation 450, the initiating device 402 may receive a selection by the user to begin image capture. Operation 450 may be performed at any time after the responding device 404 is determined to be in a ready status by the initiating device 402. The user may select or press a button or virtual display button or icon to begin image capture.

In communication 452, the initiating device 402 may transmit, to the responding device 404 an instruction to begin image capture. The instruction may be configured to enable the camera of the responding device 404 to capture at least one image at approximately the same time that the camera of the initiating device 402 captures an image. In some embodiments, the instruction may include an initiate time value corresponding to the time that the user-initiated image capture as described in operation 450. In some embodiments, the initiate time value may be based on the time synchronization values received by the initiating device 402 and the responding device 404 as described in communications 416 and 418. The time synchronization values, as stored on the initiating device 402 and the responding device 404, may be used to identify and correlate images captured and stored within cyclic buffers within each device as described in later operations. In some embodiments, the initiate time value may be based on a local clock frequency of the initiating device 402.

In some embodiments, initiating image capture may automatically initiate generation of an analog signal for purposes of synching image capture. An analog signal may be generated and output by the initiating device 402 in place of communication 452 to initiate image capture. For example, the initiating device 402 may generate a flash via the camera flash or an audio frequency “chirp” via speakers to instruct the responding device 404 to begin image capture automatically. The responding device 404 may be configured to detect a flash or audio frequency “chirp” generated by the initiating device 402, and begin the process to capture at least one image in response to such detection. In some embodiments, a test analog signal may be generated to determine the time between generation of the analog signal and the time upon which the responding device 404 detects the analog signal. The determined analog latency may be used to offset when the responding device 404 should generate a camera flash for purposes of image capture and/or when the responding device 404 should capture an image.

In some embodiments, the instruction transmitted in communication 452 may include a delay value. The responding device 404 may be configured to display an indication to initiate or otherwise automatically initiate image capture after the duration of the delay value has passed. A delay value may reduce the amount of electronic storage used when capturing more than one image in a cyclic buffer, such that proceeding to capture images after a certain delay value may be closer to the point in time at which the initiating device begins capturing at least one image. The delay value may include a latency between the initiating device 402 and the responding device 404, in which the latency is caused by wireless communications protocols and handshaking and physical distance separating the devices. A delay value may include additional delay time in embodiments involving more than one responding device to account for the possibility that each responding device may have a different latency value for communications with the initiating device. For example, the delay value may be equal to at least the time value of the largest latency value among the involved responding devices. Thus, the automatic capture of images by each responding device may be offset by at least the difference between their individual time delays and the largest latency value among the responding devices.

In some embodiments, the delay value may be used to automatically and simultaneously generate a camera flash by the initiating device 402, the responding device 404, and any other responding devices. Automatically and simultaneously generating a camera flash may be useful in illuminating points of interest from multiple angles. For example, an initiating device and multiple responding devices may be used to create a 360-degree 3D image of a point of interest.

FIG. 15 illustrates a configuration 1500 in which four wireless devices are being used to capture a 360-degree 3D synchronous multi-viewpoint image. The four wireless devices 1504, 1506, 1508, and 1510 have camera view angles 1512, 1514, 1516, and 1518 respectively that will capture a full 360-degree synchronized image of the point of interest 1502. Using a delay value based at least on the latencies of the wireless communications links (not shown) between devices can allow the initiating device (e.g., wireless device 1504) to instruct all devices to generate a camera flash simultaneously. This may allow the point of interest 1502 to be fully illuminated with little to no shadow effects. In some embodiments, the simultaneous camera flashes may be initiated after detection of an analog signal, such as a flash or a frequency “chirp.”

In some embodiments, the instruction to begin image capture may include a command to be executed by the responding device 404, such as to display an indication on the user interface display of the responding device 404 to instruct the user to initiate image capture.

Referring back to FIG. 4, in operation 454, the responding device 404 may display an indication to the user of the responding device 404 to initiate image capture. Assuming automatic image capture in response to an instruction (e.g., instruction received from communication 452) or detected audio signal is not enabled in the responding device 404, the responding device 404 may display an indication for the user to select or otherwise initiate image capture. In some embodiments in which automatic image capture is enabled and does not require user input, a display to indicate that image capture has begun, is being performed, and/or has finished may be output to the user interface display of the responding device 404.

In operation 456, the responding device 404 may receive a selection by the user to begin image capture. Assuming automatic image capture in response to an instruction (e.g., instruction received from communication 452) or detected audio signal is not enabled in the responding device 404, the responding device 404 may receive a selection by the user via the user interface display to begin image capture. Operation 456 may be performed at any time after the responding device 404 is determined to be in a ready status by the initiating device 402. The user may select or press, through the multi-viewpoint image capture application or an existing camera application in communication with the multi-viewpoint image capture application, a button or virtual display button or icon to begin image capture.

In operation 458, the camera of the responding device 404 may begin capturing at least one image. In some embodiments, the responding device 404 may store an image, a burst of images, or video data, such as within a cyclic buffer. The cyclic buffer may assign a timestamp value to each image captured. The timestamp value may be based on the synchronization timer received by the responding device 404 as described in communication 418. The time stamp value may correspond to a timestamp value assigned to images captured by the initiating device 402 (i.e. in operation 460). For example, the timestamp value may be based on a universal timer or clock received or derived from a network server (e.g., communication network 140, GNSS time, etc.). In some embodiments, the time synchronization values, as stored on the initiating device 402 and the responding device 404, may be used to identify and correlate images captured and stored within the cyclic buffer. In some embodiments, the timestamp value may be based at least on a local clock frequency of the responding device 404.

In operation 460, the camera of the initiating device 402 may begin capturing at least one image. The initiating device 402 may begin image capture in response to receiving a selection by the user to begin image capture as described in operation 450. In some embodiments, the operation 460 may occur automatically some delay time amount after performing operation 450, such as a time amount roughly equivalent to the time to perform communication 454 and operation 458. The initiating device 402 may store an image, a burst of images, or video data within a cyclic buffer. The cyclic buffer may assign a timestamp value to each image captured. The timestamp value may be based on the synchronization timer received by the initiating device 402 as described in communication 416, in which the time stamp value may correspond to a timestamp value assigned to images captured by the responding device in operation 458. For example, the timestamp value may be based on a universal timer or clock received or derived from a network server (e.g., communication network 140, GNSS time, etc.). The time synchronization values, as stored on the initiating device 402 and the responding device 404, may be used to identify and correlate images captured and stored within the cyclic buffer. In some embodiments, the timestamp value may be based at least on a local clock frequency of the initiating device 402.

In some embodiments, the operations 458 and 460 may be initiated automatically after communication 448, bypassing operations 450, 454, 456, 458, 460 and communication 452. For example, upon determining that the location and/or orientation adjustment information corresponds to the location and/or orientation parameters received from the responding device 404, the initiating device 402 and the responding device 404 may begin capturing images without receiving further user input (e.g., operation 450 receiving a selection by the user to begin image capture).

In communication 462, the initiating device 402 may transmit a timestamp value associated with a captured image to the responding device 404. In some embodiments, the initiating device 402 may transmit multiple timestamp values associated with multiple captured images or frames within a video file. In some embodiments, a user of the initiating device 402 may select an image from the images captured within the cyclic buffer in operation 460, upon which the timestamp value associated with the selected image is transmitted to the responding device 404.

In communication 464, the responding device 404 may transmit one or more captured images having a timestamp value that is equal to or approximately equal to the timestamp value transmitted in communication 464. The responding device 404 may analyze the cyclic buffer to determine which captured images have a timestamp equivalent to or closest to the timestamp received from the initiating device 402. The image(s) determined by the responding device 404 to have a timestamp close or equal to the initiating device timestamp value may correspond to a same instance upon which the initiating device captured the image associated with the initiating device timestamp value.

In operation 466, the initiating device 402 may correlate the image(s) received from the responding device 404 in communication 464 with the image(s) captured in operation 460. For example, the initiating device 402 may correlate or otherwise process the images captured by the initiating device 402 and the responding device 404 to form a single image file having multiple viewpoints of one or more points of interest. For example, as described with reference to FIGS. 5A-5D, images captured by initiating device 504 and responding devices 506 and 508 can be correlated to create a 3D image or video file that may display multiple view angles of point of interest 502 taken at a same time. The resulting correlated image file may be generated according to conventional image processing techniques to account for variance in the threshold location and/or orientation parameters of each device while capturing the images. The resulting correlated image file may be a “.gif” file, video file, or any other data file that may include more than one viewpoint or a series of image files. In some embodiments, the initiating device 402 may transmit the image(s) captured in operation 460 and the image(s) received in communication 464 to an external image processing device or application (e.g., network server, desktop computer, photography application, etc.).

The operations and communications illustrated FIG. 4 may be performed in an order different than shown in the figure. For example, the operations 416 and 418 may be performed in any order before operation 450. The operations and communications for performing synchronous multi-viewpoint photography may be performed by multiple wireless devices, and may be continuous and ongoing while other communications between wireless devices and/or servers are performed for performing synchronous multi-viewpoint photography.

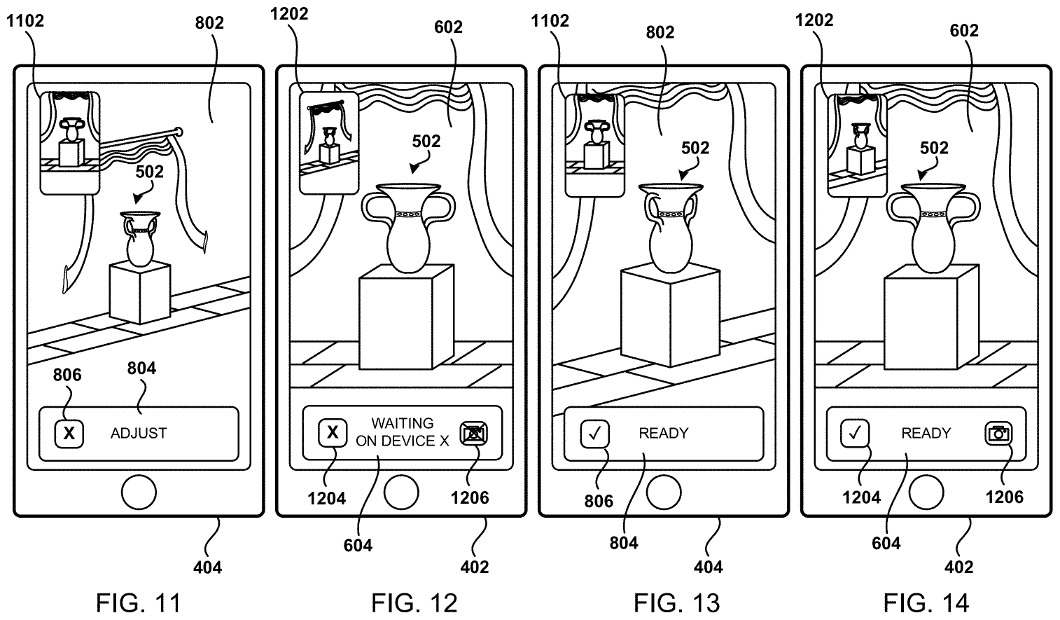

FIGS. 11-14 illustrate an initiating device and a responding device showing examples of user interface displays that may be implemented in various embodiments. FIG. 11 illustrates a responding device 404 and FIG. 12 illustrates an initiating device 402 showing examples of user interface displays while performing operations of synchronous multi-viewpoint photography according to some embodiments. Similar displays may be presented on robotic vehicle controllers in implementations using one or more camera-equipped robotic vehicles for capturing some of the images used in simultaneous photography.

With reference to FIGS. 1-12, the initiating device 402 and responding device 404 are shown in FIGS. 11 and 12 in the “not ready” when the responding device is not yet achieved a position suitable for multi-viewpoint imaging. For example, the responding device 404 shows on the user interface display 802 that the point of interest 502 as identified by the initiating device 402 is not within a threshold perspective (e.g., the point of interest is too far away with respect to the camera of the responding device 404) to capture an image that can be correlated with an image captured by the initiating device 402.

As illustrated, the “not ready” status may be indicated on the user display interface 802 of responding device 404 by the indicator 806, and on the user display interface 602 of initiating device 402 by the indicator 1204 (e.g., depicted as an “X” for example). An indicator 804 may display a desired change in location and/or orientation of the responding device 404 to the user of the responding device 404. The desired change in orientation of the responding device may be based on current location and/or orientation parameters of the responding device 404 and location and/or orientation adjustment information received from the initiating device 402 as described. For example, the desired change in orientation may include displaying a message such as “move closer.”

An indicator 604 may display to the user of the initiating device 402 which, if any, responding devices (e.g., 404) are not in an appropriate location, not in an appropriate orientation, and/or not in an appropriate configuration setting four capturing multi-viewpoint imagery of the point of interest 502. In some embodiments, a “not ready” status may prevent the user from initiating image capture of the point of interest 502, or may cause the user interface display 602 to indicate that the user should not begin image capture (e.g., an image capture initialization icon 1206 is not selectable or dimmed). Similar displays may be presented on robotic vehicle controllers in implementations using one or more camera-equipped robotic vehicles for capturing some of the images used in simultaneous photography.

In some embodiments, the user display interface of the responding device 404 may include a real-time preview image feed display 1102 of the camera view perspective of the initiating device 402. The user of the responding device 404 may utilize the real-time image feed display 1102, in addition to any message prompt displayed by the indicator 804, to adjust an orientation, location, or setting of the responding device 404. For example, the real-time image feed display 1102 may indicate to the user that the initiating device 402 is closer to the point of interest 502 than the responding device 404, and therefore the user should move the responding device 404 closer to the point of interest 502.

In some embodiments, the user display interface of the initiating device 402 may include a real-time preview image feed display 1202 of the camera view perspective of the responding device 404. The user of the initiating device 402 may utilize the real-time image feed display 1202, in addition to any message prompt displayed by the indicator 604, to determine whether the responding device 404 is close to a desired location or orientation. For example, the real-time image feed display 1202 may indicate to the user that the responding device 404 should be moved closer to the point of interest 502.

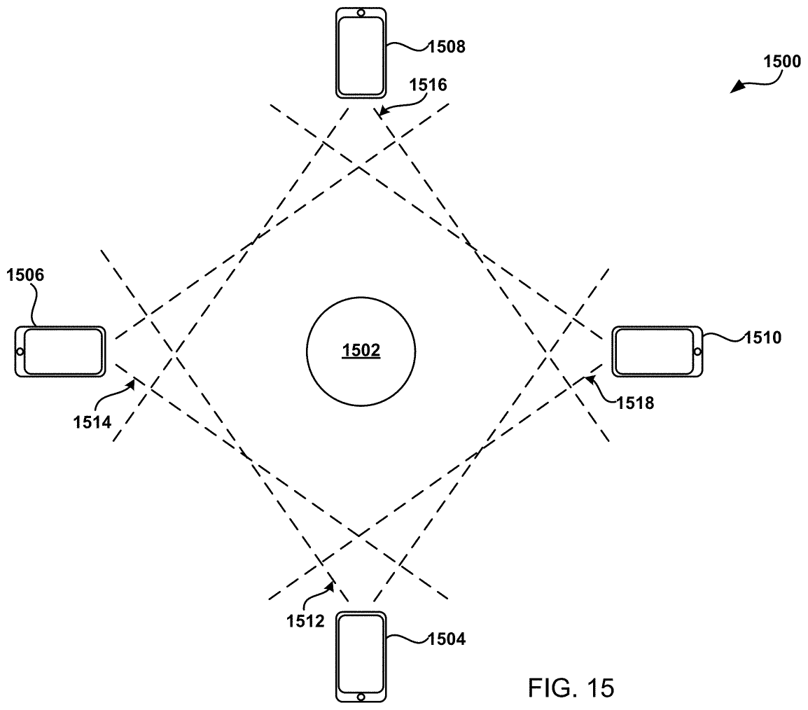

FIG. 13 illustrates a responding device 404 and FIG. 14 illustrates an initiating device 402 when the responding device 404 has moved to a position and orientation with respect to the point of interest such that the wireless devices are now “ready” two capture images for simultaneous multi-viewpoint photography. In the illustrated example, the real-time image feed displays 1102 and 1202 display a similar perspective of the point of interest 502, and the user interfaces 602 and 802 may display, via the indicators 604, 804, 806, and 1204, that the responding device 404 and the initiating device 402 are ready to begin image capture. Thus, the responding device 402 is at a location, in an orientation, and/or has appropriate features or settings to capture an image having a perspective that that may be combined or correlated with an image of the point of interest captured by the initiating device 402. Similar displays may be presented on robotic vehicle controllers in implementations using one or more camera-equipped robotic vehicles for capturing some of the images used in simultaneous photography.

Once in a “ready” status, a user of the initiating device 402 may select or press the image capture initialization icon 1206 or otherwise use a button or feature of the initiating device 402 to begin capturing at least one image. In some embodiments, selecting or pressing the image capture initialization icon 1206 may cause the initiating device to transmit an instruction to the responding device 404. The instruction may configure the responding device 404 to begin capturing images at approximately the same time that the initiating device is capturing images. In some embodiments, the instruction may configure the responding device 404 to display (e.g., via the user interface display 802) an indication for the user of the responding device 404 to begin image capture.

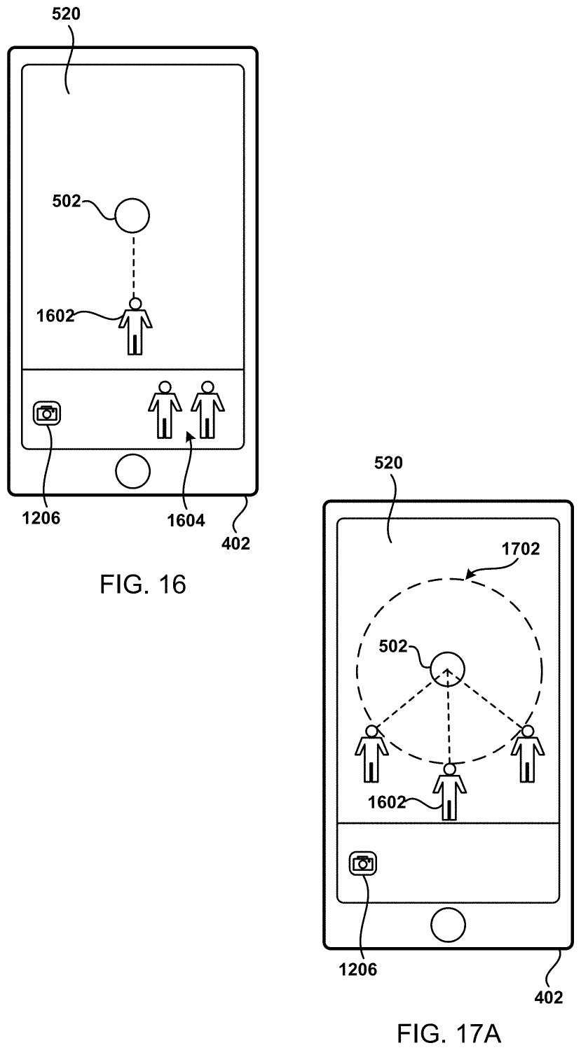

FIGS. 16-20 illustrate a planning interface that may be presented on a display of an initiating device 402 for performing synchronous multi-viewpoint photography according to some embodiments. With reference to FIGS. 1-20, an initiating device 402 may executing a multi-viewpoint image capture application may display the user interface that indicates desired locations or orientations of one or more responding devices to achieve successful multi-viewpoint imaging. Similar displays may be presented on robotic vehicle controllers in implementations using one or more camera-equipped robotic vehicles for capturing some of the images used in simultaneous photography. The initiating device 402 may include a button or display icon with the user display interface 602 to allow a user to select and/or alternate between an image capture mode and planning mode. For example, an image capture mode may include a real-time image feed from a camera of the initiating device 402 as shown in the user display interface 602 in FIGS. 12 and 14. A planning mode may include an image capture mode icon to return to an image capture mode.

A planning mode may allow a user of the initiating device 402 to select a desired location and/or orientation of any responding device having active device-to-device communications with the initiating device 402. For example, as illustrated in FIG. 16, a user interface display 520 may include a user icon 1602 may indicate a location and orientation, including view angle and direction, of the initiating device 402 with respect to a point of interest 502 identified via image capture mode. A location and orientation of the initiating device 402, and consequently user icon 1602, may be based at least on lens focal depth with respect to the point of interest 502, where the lens focal depth is a current lens focal depth or a stored lens focal depth recorded at the time the point of interest 502 was identified in an image capture mode. The location and orientation of the initiating device 402 and user icon 1602 may be based at least on accelerometers, GNSS tracking, WiFi or BT/BLE pinging, or any other conventional geo-positioning hardware or software.

In some embodiments, a planning mode may be a bird's-eye, top-down view or an angled perspective view with respect to the point of interest 502. The user display interface may include user responding device icons 1604 that may be dragged, selected, or otherwise placed within the planning mode interface. The user responding device icons 1604 may indicate a desired location and/or orientation of any actively connected responding devices as determined by the user of the initiating device. For example, placement of a user responding device icon 1604 may provide an indication to the user of the corresponding responding device that the location or orientation of the responding device should be adjusted. Based on the placement of the user responding device icons 1604, location and/or orientation adjustment information transmitted by the initiating device 402 to a responding device may be updated accordingly to reflect a change in desired location and orientation of the responding device with respect to the location of the initiating device 402 and the point of interest 502, as well as the orientation of the initiating device 402.

In some embodiments, the planning mode of the multi-viewpoint image capture application may display a mode selection including various image capture modes such as 3D, panoramic, blur/time lapse, multi-viewpoint/multi-perspective, 360-degree, and 360-degree panoramic.

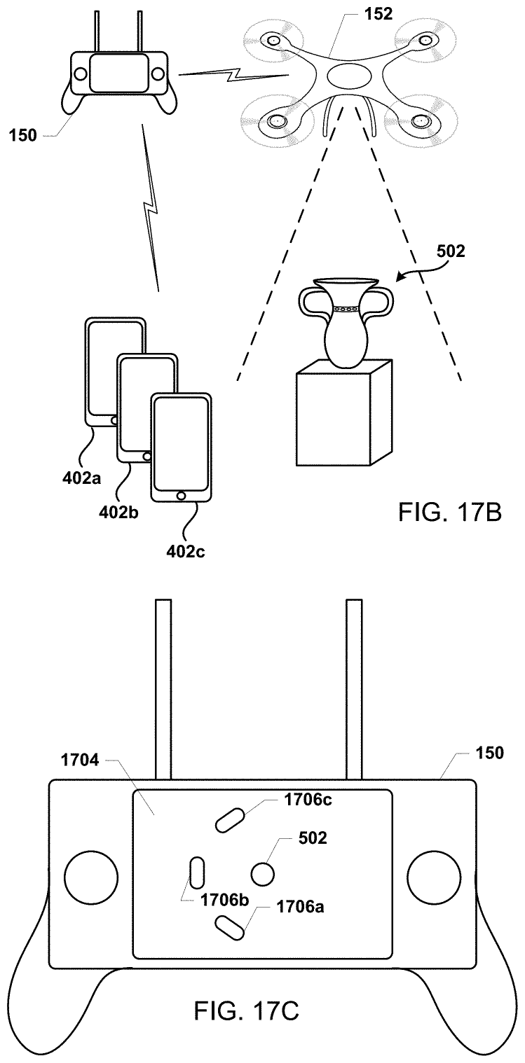

Location and/or orientation adjustment information may be based at least on a selected image capture mode. For example, FIG. 17A shows a user interface display 520 showing a 3D-image planning mode in which a dashed line ring 1702 the case a circumference around which responding device icons 1604 may be positioned. In some embodiments, the initiating device 402 may place the user responding device icons 1604 automatically around the ring 1702 at a distance equivalent to the distance between the initiating device 402 and the point of interest 502. In some embodiments, the user of the initiating device 402 may manually select or place the desired location and orientation of the user responding device icons 1604. For example, the user may “drag and drop” the user responding device icons 1604 to “snap” to the shape of the ring 1702. As another example, the user may override any planning mode to place the user responding device icons 1604 in any desired location or orientation with respect to the user icon 1602 within the user display interface 602. In some embodiments, the size of the ring 1702 may be adjusted based on the physical position of the initiating device 402 with respect to the point of interest 502. For example, the ring 1702 may shrink if the user operating the initiating device 402 moves physically closer to the point of interest 502.

As another example, FIG. 17B shows a situation in which simultaneous multi-viewpoint photography is to be performed using three smai (phone responding devices 402a-402c imaging the point of interest 502 at ground level and a UAV 152 imaging the point of view from overhead. FIG. 17C shows an example of a user interface display 1704 on a UAV controller 150 suitable for planning an overhead multi-viewpoint shot. In this example, the positions of the three smartphone responding devices 402a-402c with respect to the point of interest 502 may be shown with icons 1706a-1706c from the overhead viewing perspective of the UAV 152. Such a display may enable an operator to redirect the positioning of the smartphone responding devices 402a-402c about the point of interest 502 while also viewing how the UAV 152 is positioned over the point of interest 502. In some embodiments, the user interface display 1704 on the UAV controller 150 may be in the form of preview images received from a camera of the UAV 152. In some embodiments, the user interface display 1704 on a UAV controller 150 may show symbols or outlines of the responding devices and the point of interest 502, rather than or in addition to live preview images from the UAV 152.

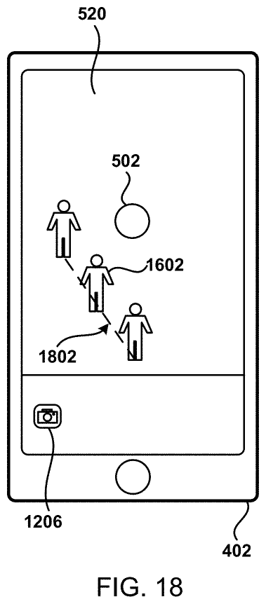

As another example of operating modes, FIG. 18 shows a user interface display 520 of a 3D-image planning mode that may result in a 3D-zooming image capture (e.g., a “gif” gradually zooming inward or outward while appearing to rotate about the point of interest 502). The placement icon 1802 may be customizable by the user of the initiating device 402 to create any conceivable icon shape or size to which the user icon 1602 and the user responding device icons 1604 may be assigned.

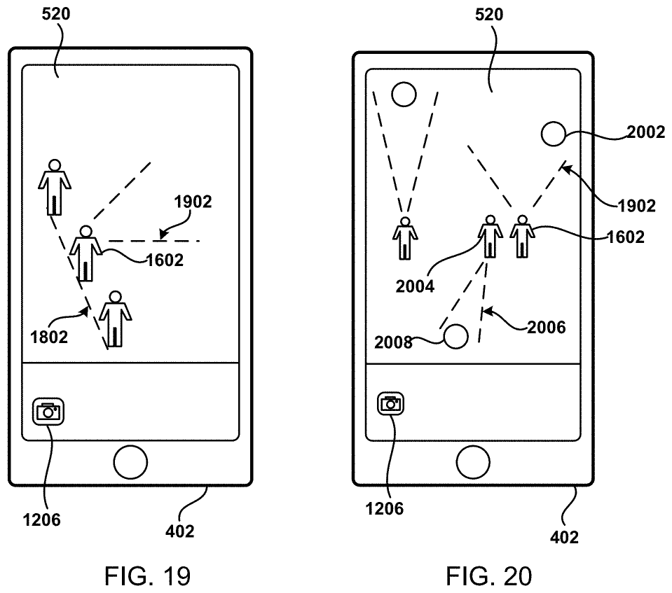

As a further example, the planning mode may display and/or allow the user of the initiating device 402 to select, via the user icon 1602 and user responding device icons 1604 rendered on the graphical user interface, a desired orientation of the initiating device 402 and any active responding devices. For example, as illustrated in FIG. 19, the user display interface 520 may indicate a current camera view angle 1902. The user of the initiating device 402 may adjust the camera view angle 1902 with respect to the placement icon 1802. This may allow the initiating device 402 to be configured to display an indication to the user to adjust the location and/or orientation parameters of the initiating device 402. For example, the user of the initiating device 402 may want to align the respective camera angles of the initiating device 402 and any active responding devices to be perpendicular to the placement icon 1802, such as when performing panoramic image capture.

In some embodiments, the planning mode may allow the user of the initiating device 402 to select varying points of interest and/or camera view angles for the initiating device 402 and any active responding devices. This may be useful for capturing synchronous multi-viewpoint images or image files using multiple camera angles focused on different points of interest. For example, as illustrated in FIG. 20, a user of the initiating device 402 may interact with an interface user interface display 520 select a placement of the user icon 1602 and a corresponding camera view angle 1902 to focus on a point of interest 2002. The user of the initiating device 402 may further select a placement of the user responding device icon 2004 and a corresponding camera view angle 2006 to focus on a point of interest 2008. Thus, once image capture begins as initiated by the user of the initiating device 402, images captured synchronously by both the initiating device 402 and the responding device corresponding to the user responding device icon 2004 may have a same timestamp value that can be used to collate or correlate images with varying camera view angles and points of interest.

In some embodiments, the planning mode may display both current locations and orientations of initiating devices and responding devices, as well as desired or user-selected locations and orientations.

In some examples, the initiating device 402 may implement augmented reality (AR) within an environment having a point of interest and one or more active responding devices. For example, a real-time image feed as captured by a camera of the initiating device 402 may include an AR overlay to indicate current locations and orientations of active responding devices, desired locations and orientations of user responding device icons, and locations of points of interest. Similarly, active responding devices may utilize AR to display and allow a user to view current locations and orientations of other active responding devices and the initiating device, desired locations and orientations of other user responding device icons, locations of points of interest.

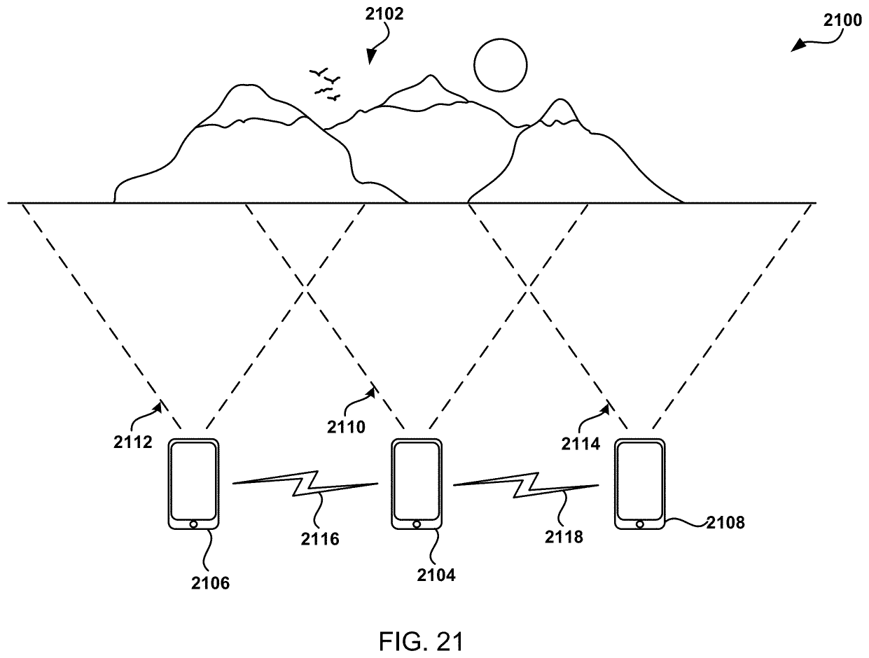

FIG. 21 illustrates an implementation 2100 using various embodiments to capture a panoramic view using an initiating device 2104 and responding devices 2106 and 2108 that have camera view angles 2110, 2112, and 2114, respectively. With reference to FIGS.1-21, the initiating device 2104 may be in device-to-device communication with the wireless device 2106 via a wireless connection 2116, and with the wireless device 2108 via a wireless connection 2118.

Using various embodiments to perform synchronous panoramic multi-viewpoint photography may be useful to photograph environments in which objects or terrain within the within the panorama are moving (e.g., birds, water surfaces, trees, etc.). For example, a single image capture device may not be able to achieve a single time-synced panoramic image, since a conventional device is unable to simultaneously capture more than one image at any given time. Thus, any changes within the camera viewing angle that occur due to time that passes while performing image capture may result in image distortion. Various embodiments, enable multiple wireless devices to capture a single synchronized panoramic image or video file that eliminates such distortions by collating time-synced images captured at approximately the same time.

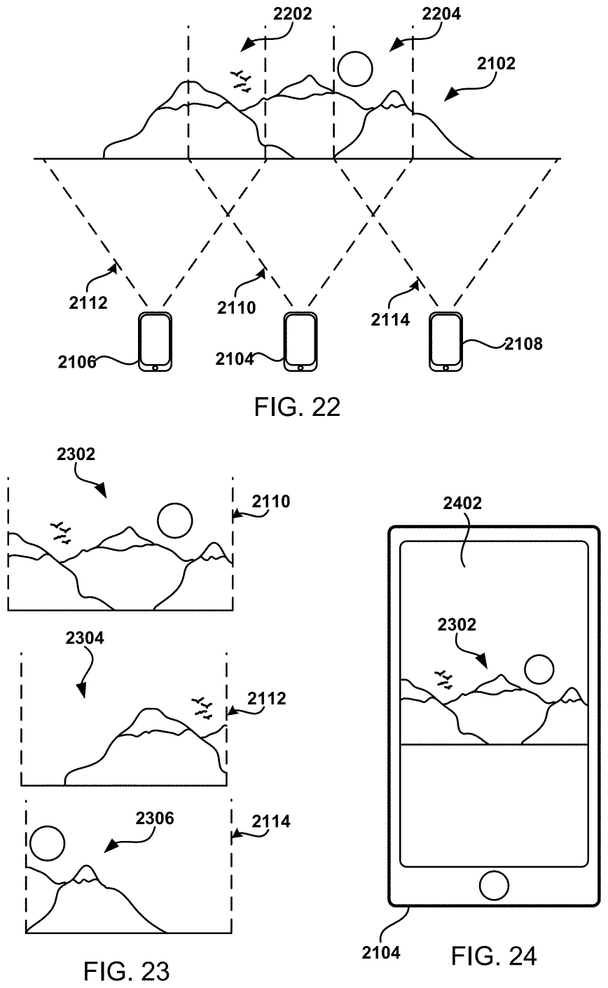

FIG. 22 illustrates an example of positioning multiple wireless devices to perform synchronous panoramic multi-viewpoint photography according to some embodiments. With reference to FIGS.1-22, the initiating device 2104 and responding devices 2106 and 2108 may be oriented towards a subject of interest 2102. The camera view angles 2110, 2112, and 2114 of the initiating device 2104 and responding devices 2106 and 2108 may be oriented so as to capture overlapping images of a panoramic view. For example, the camera view angles 2110 and 2112 (as displayed within a user display interface of the responding device 2106 and initiating device 2104) include overlapping portion 2202, and the camera view angles 2110 and 2114 may include overlapping portion 2204.

As described, responding devices may transmit preview images to the initiating device that can be processed to determine appropriate adjustment information. Overlapping portions 2202 and 2204 the preview images may be used by the initiating device 2104 to determine how the different device images are aligned and determine appropriate location and/or orientation adjustment information for each of the responding devices 2106 and 2108. In configurations in which the camera view angles of responding devices do not initially include any overlapping portions with a camera view angle of an initiating device, the initiating device may transmit location and/or orientation adjustment information to the responding devices to configure the responding devices to display a notification to the responding device user(s) to adjust the orientation of the responding device(s) (e.g., display message or notification “turn around, ” “turn right,” etc.). This may be performed until at least a portion of the subject of interest 2102 visible within the camera view angle 2110 is identifiable within the camera view angles 2112 and/or 2114 as determined by the initiating device 2104.

The location and/or orientation adjustment information used in panoramic image capture may be based at least on image processing of the camera view angles 2112 and 2114 with respect to the overlapping portions 2202 and 2204, such that an edge of the camera view angles 2112 and 2114 is at least identifiable within the camera view angle 2110 of the initiating device 2104. For example,

FIG. 23 illustrates initiating device 2104 and responding devices 2106 and 2108 camera view angles 2110, 2112, and 2114 that include real-time preview image feed content 2302, 2304, and 2306 respectively. The initiating device 402 may initiate image capture at least when the real-time image feed content 2304 and 2306 overlaps with a portion (e.g., overlapping portions 2202, 2204) of the real-time image feed content 2302. FIG. 24 illustrates an initiating device 2104 displaying a real-time preview image feed 2302 on a user display interface 2402. The location, orientation, and camera settings of the initiating device 2104 may determine the resulting real-time image feed content 2302. The location and/or orientation adjustment information transmitted to the responding devices 2106 and 2108 may be based on the real-time image feed content 2302.

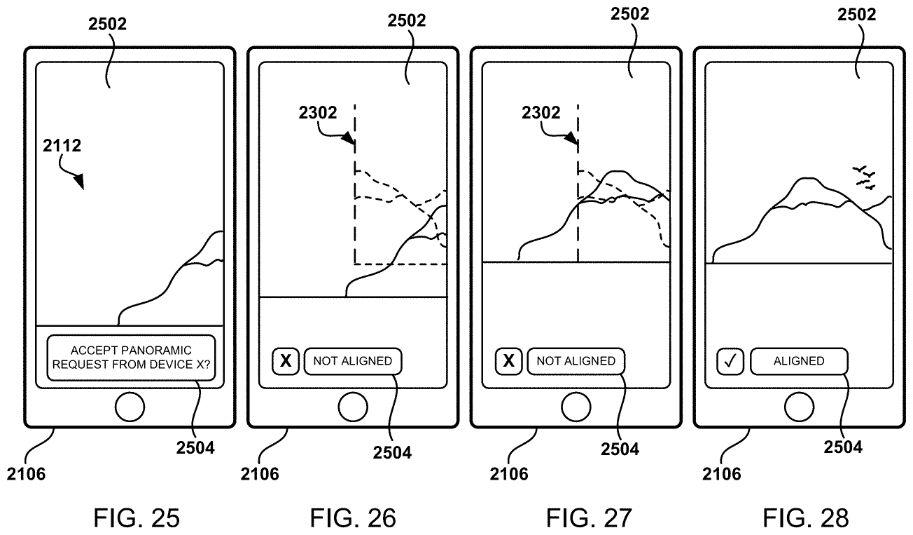

FIGS. 25-28 illustrate a progression of adjusting location and/or orientation parameters of a responding device 2106 while performing synchronous panoramic multi-viewpoint photography according to some embodiments. With reference to FIGS. 1-28, the responding device 2106 may include a user display interface 2502 that displays real-time preview images of the camera view angle 2112. The user display interface 2502 may display an indicator 2504 to provide a notification to the user to accept a request from the initiating device 2104 to perform synchronous panoramic image capture.

As illustrated in FIGS. 26 and 27, after a user accepts the request from the initiating device 2104 to perform synchronous panoramic image capture, the user display interface may display an edge or portion of the real-time preview image feed 2302 transmitted to the responding device 2106. The edge or portion of the real-time image feed content 2302 may be overlaid (e.g., dimmed, outlined, faded, etc.) on top of the real-time image feed content displayed by the user display interface 2502. The real-time image feed content 2302 may be included as location and/or orientation adjustment information or may otherwise be transmitted to the responding device 2106 within the same communication as the location and/or orientation adjustment information. The location and/or orientation adjustment information may include a notification via indicator 2504 to inform the user of the responding device 2106 to adjust a location, orientation, or setting of the responding device 2106. For example, the location and/or orientation adjustment information may include an instruction to configure the indicator 2504 to display a message such as “tilt camera upwards,” an arrow indicator, or any other conceivable user-implementable direction to adjust the orientation of the responding device 2106.

FIG. 28 illustrates the user interface display when the orientation of the responding device 2106 have successfully been adjusted to conform to the location and/or orientation adjustment information received from the initiating device 2104. Thus, the real-time image feed content of the camera view angle 2112 is aligned with a portion of the real-time image feed content 2302. Once aligned, the indicator 2504 may display a notification indicating that the responding device 2106 is properly aligned (i.e. the location and/or orientation parameters of the responding device 2106 correspond to the location and/or orientation adjustment information).

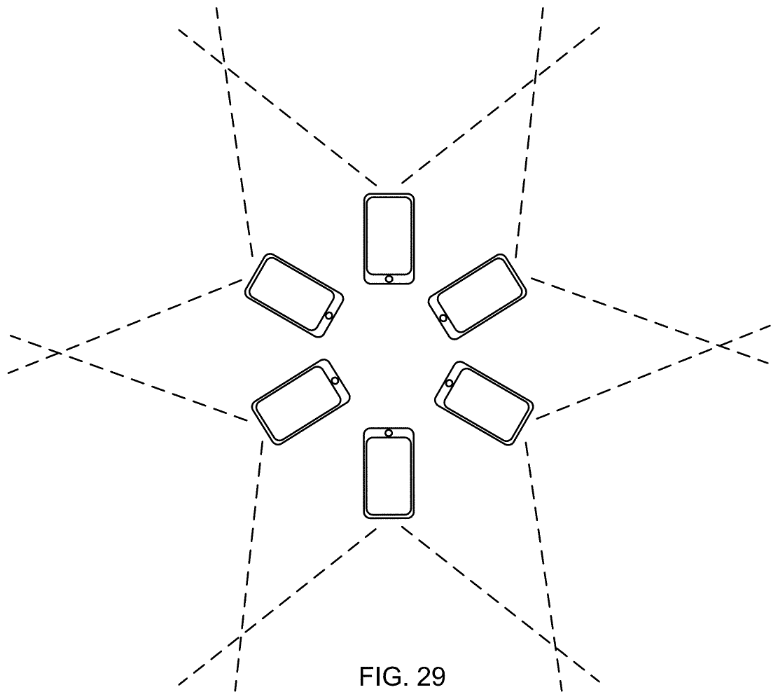

FIG. 29 illustrates an example of using various embodiments for performing 360-degree synchronous panoramic multi-viewpoint photography. Implementing the same concepts as described with reference to FIGS. 21-28, using three or more wireless devices may allow for fully-encompassing 360-degree panoramic image or video capture. For example, multiple devices may be used to synchronously capture images to collate and render a 360-degree panoramic image. Such 360-degree panoramic images may be created in embodiments in which the edges of the camera fields of view of the wireless devices overlap to form a full 360-degree view in a single moment.

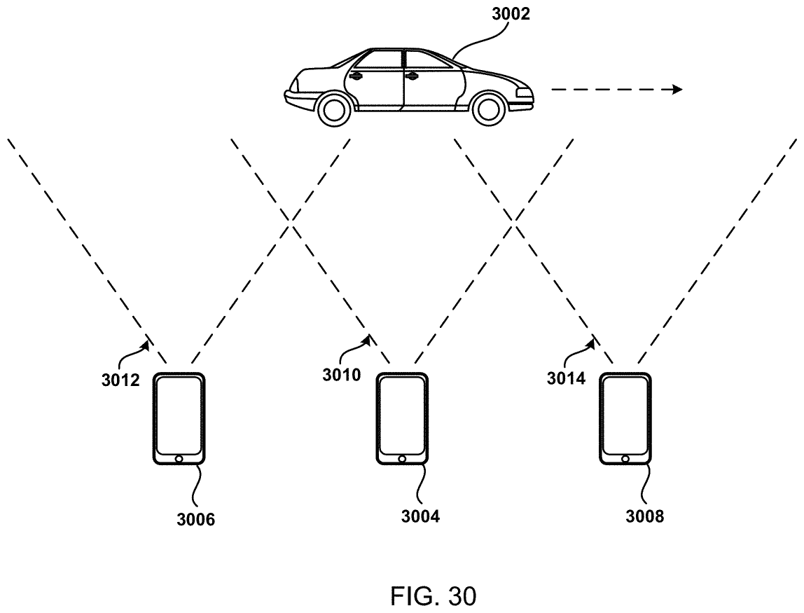

FIG. 30 illustrates an example of using various embodiments for performing synchronous multi-viewpoint photography having a blur effect. For example, an initiating device 3004 may be in wireless communication with responding devices 3006 and 3008, with camera view angles 3010, 3012, and 3014 respectively. The initiating device 3004 may receive a selection from a user to perform synchronous panoramic multi-viewpoint photography using a blur effect. For example, the subject of interest 3002 may be travelling at high speeds, and a user may desire to render an image of the subject of interest 3002 using multiple devices to create a visual blur or time lapse effect. In some embodiments, the location and/or orientation adjustment information transmitted to the responding devices may include an adjustment to a camera exposure setting.

A blur or time lapse effect may be created by offsetting the image capture time of the initiating device 3004 and the responding devices 3006 and 3008. The offset times may be based at least on an order in which the subject of interest 3002 may travel through the collective field of view (e.g., collective view of camera view angles 3010, 3012, and 3014) of the initiating device 3004 and the responding devices 3006 and 3008. For example, as illustrated in FIG. 30, the subject of interest is travelling through the camera view angles 3012, 3010, and 3014 in that order. Thus, to create a blur or time lapse effect from the motion of the subject of interest 3002, the responding device 3006 may capture a first image, the initiating device 3004 may capture a second image sometime after the first image, and the responding device 3008 may capture a third image sometime after the second image. Each image may be stored in a cyclic buffer in each respective device and associated with a timestamp value that is offset by the respective offset time determined by the initiating device 3004. The offset times for each device may be based at least on a velocity of the subject of interest and the desired magnitude of the blur effect. The offset times may be included in the instruction (e.g., communication 452 with reference to FIG. 4) transmitted by the initiating device 3004 to configure the responding devices 3006 and 3008 to begin image capture

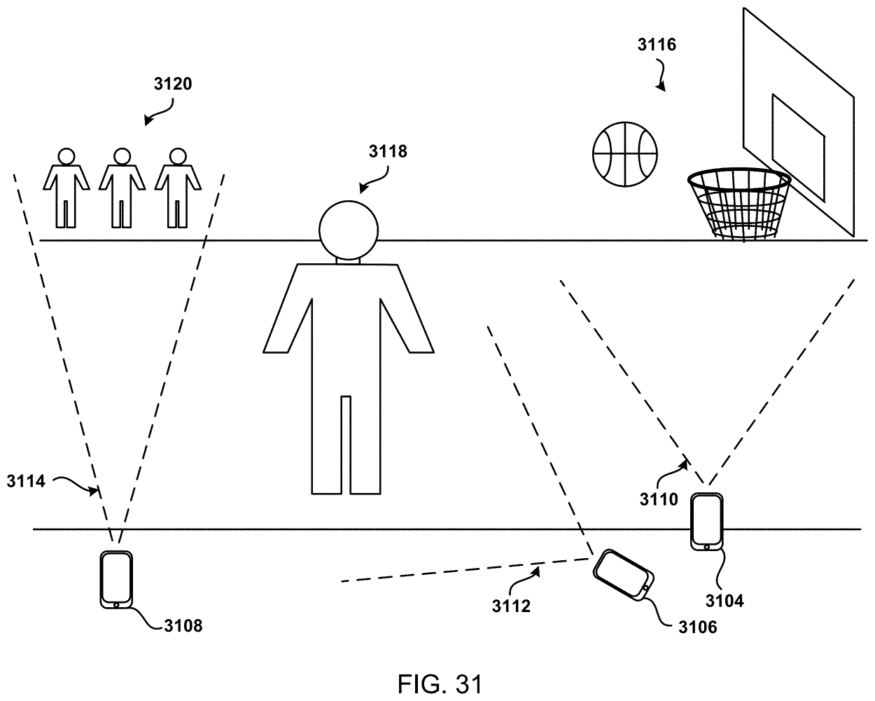

FIG. 31 illustrates an example of using various embodiments for performing synchronous multi-viewpoint photography that show can show the simultaneous actions of various scenes or actors that are not together. For example, synchronous multi-viewpoint photography may be implemented to capture the events or objects present within one camera view angle at the same time as the events or objects in another camera view angle are captured. An initiating device 3104 may be wirelessly connected to responding devices 3106 and 3108. The initiating device 3104 may have a camera view angle 3110 in preparation of capturing a subject of interest 3116. The responding device 3106 may have a camera view angle 3112 in preparation of capturing a subject of interest 3118. The responding device 3108 may have a camera view angle 3114 in preparation of capturing a subject of interest 3120.

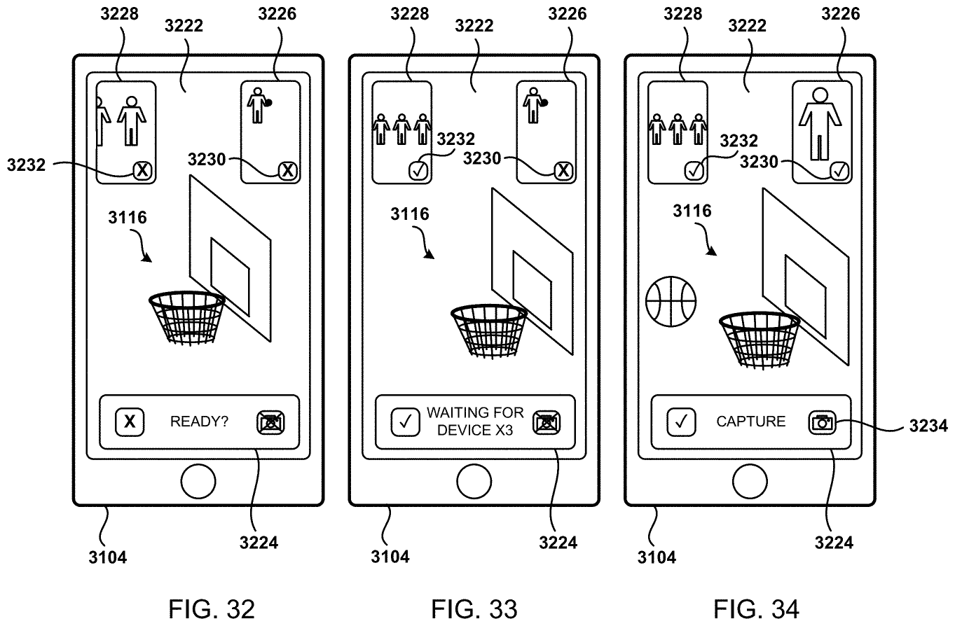

FIGS. 32-34 illustrate an initiating device 3104 showing a user display interface 3222 configured to display a real-time preview image feed including subject of interest 3116 as captured within the camera view angle 3110. The user display interface 3222 may be configured to display a real-time preview image feed 3226 including subject of interest as captured within the responding device camera view angle 3112. The user display interface 3222 may be configured to display a real-time preview image feed 3228 including subject of interest as captured within the responding device camera view angle 3114. The initiating device 3104 may continuously receive real-time preview image feeds from the responding devices 3106 and 3108 to enable monitoring the fields of view of all responding devices.

The user display interface 3222 may be configured to display a status indicator 3224 indicating whether the initiating device 3104 is ready to begin image capture. In some embodiments, the initiating device 3104 may receive a selection from the user, such as a manual selection of the status indicator 3224, to alternate the status between “not ready” and “ready.” For example, as illustrated in FIG. 33, the status indicator 3224 may display an indication (e.g., check mark) to indicate to the user of the initiating device 3104 that the initiating device 3104 is ready to begin image capture. In some embodiments, the initiating device 3104 may automatically determine a transition between a “not ready” and “ready” status. For example, the initiating device 3104 may automatically determine a “ready” status by processing images captured in real time within the camera view angle 3110 to determine that the camera is focused on the subject of interest 3116. As another example, the initiating device may automatically determine a “ready” status by determining, via accelerometers, that the initiating device 3104 has not been moved or otherwise reoriented for a period of time. In some embodiments, the initiating device 3104 may transmit an instruction to configure the responding devices 3106 and 3108 to display, in their respective user display interfaces, an indication or notification that the initiating device 3104 is ready to begin image capture.

The responding devices 3106 and 3108 may determine a transition between a “not ready” and a “ready” status manually or automatically in a mariner similar to the initiating device 3104. In some embodiments, the responding devices 3106 and 3108 may separately transmit instructions to the initiating device 3104 to configure the initiating device 3104 to display, via indicators 3230 and 3232 respectively, an indication or notification that the responding devices 3106 and 3108 are ready to begin image capture. For example, as illustrated in FIG. 34, the indicators 3230 and 3232 may display an indication (e.g., check mark) that the responding devices 3106 and 3108 are ready to begin image capture.

As illustrated in FIG. 34, once all devices indicate a “ready” status, the indicator 3224 may indicate or otherwise display a notification alerting the user that all devices are ready to begin image capture. For example, an image capture initialization icon 3234 may be unlocked, highlighted, or otherwise available for the user of the initiating device 3104 to select to begin image capture across the initiating device 3104 and responding devices 3106 and 3108. In some embodiments, the initiating device 3104 may receive a selection to begin image capture despite any responding device being in a “not ready” state.

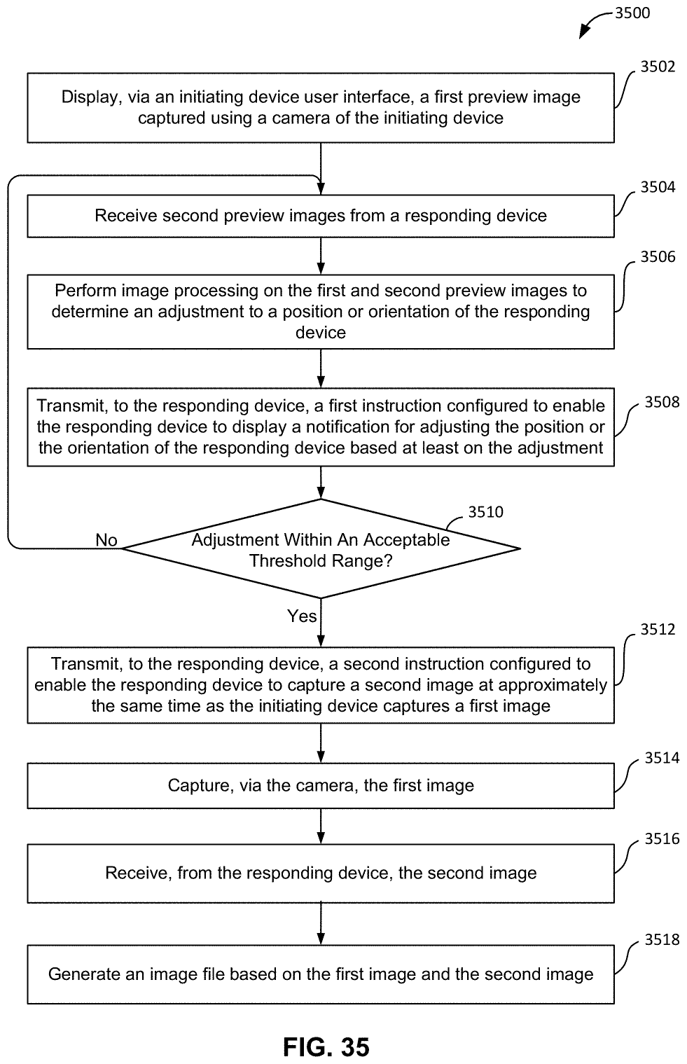

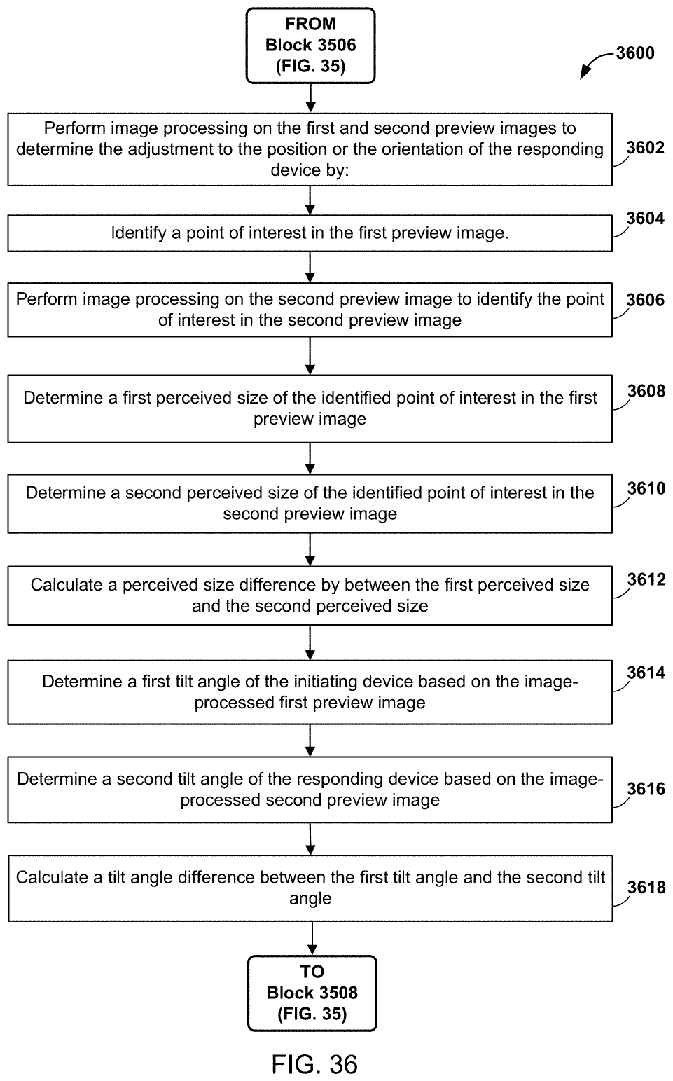

FIG. 35 is a process flow diagram illustrating a method 3500 implementing an initiating device to perform synchronous multi-viewpoint photography according to some embodiments. With reference to FIGS. 1-35, the operations of the method 3500 may be performed by a processor (e.g., processor 210, 212, 214, 216, 218, 252, 260, 322) of a wireless device (e.g., the wireless device 120a-120e, 200, 120, 150, 152, 402, 404).

The order of operations performed in blocks 3502-3518 is merely illustrative, and the operations of blocks 3502-3518 may be performed in any order and partially simultaneously in some embodiments. In some embodiments, the method 3500 may be performed by a processor of an initiating device independently from, but in conjunction with, a processor of a responding device. For example, the method 3500 may be implemented as a software module executing within a processor of an SoC or in dedicated hardware within an SoC that monitors data and commands from/within the server and is configured to take actions and store data as described. For ease of reference, the various elements performing the operations of the method 3500 are referred to in the following method descriptions as a “processor.”

In block 3502, the processor may perform operations including displaying, via an initiating device user interface, a first preview image captured using a camera of the initiating device. A camera of an initiating device may be used to render a preview image or an image feed on a display of a user interface to allow a user to observe a camera view angle in real time. Displaying the preview image may allow the user to position or orient the wireless device, or adjust camera settings to focus on a subject or a point of interest such that the preview image may contain the subject or point of interest. In some embodiments, the initiating device may transmit the first preview image to one or more responding devices, with the first preview image configured to be displayed within a responding device user interface to guide a user of the responding device to adjust the position or the orientation of the responding device. In some embodiments, the initiating device may display and transmit additional preview images to one or more responding devices after a position, orientation, or camera setting of the initiating device has been adjusted.

In block 3504, the processor may perform operations including receiving second preview images from a responding device. The initiating device may receive one or more preview images from one or more responding devices. The images can be displayed to the user interface of the initiating device and/or processed to determine whether an adjustment to a position, orientation, or camera setting of any responding device is needed for purposes of configuring synchronous multi-viewpoint photography in various modes (e.g., 3D, panoramic, blur or time lapse, multi-viewpoint, 360-degree 3D, and 360-degree panoramic mode). The received preview images may be used by the initiating device to determine (or enable a user to determine) whether an adjustment to a position, orientation, or camera setting of a responding device is needed for purposes of configuring synchronous multi-viewpoint photography. In some embodiments, the received preview image may be used by the initiating device to automatically determine whether an adjustment to a position, orientation, or camera setting of a responding device is needed for purposes of configuring synchronous multi-viewpoint photography.

In some embodiments, receiving a first preview image from an initiating device may include receiving and displaying a first preview image feed captured by the camera of the initiating device. In some embodiments, receiving second preview images from a responding device may include receiving and displaying a second preview image feed captured by a camera of the responding device.

In block 3506, the processor may perform operations including performing image processing on the first and second preview images to determine an adjustment to a position or orientation of the responding device. The initiating device may perform image processing to identify and determine parameters of a feature, subject or point of interest in a preview image. For example, the initiating device may perform image processing on a preview image to determine that a point of interest, identified by a user or automatically identified, is centered within a frame of the camera view angle and consequently the image feed as displayed on the user interface of the initiating device. As another example, the initiating device may perform image processing on a preview image to identify a size, height, width, elevation, shape, distance from camera or depth, and camera and/or device tilt angle in three dimensions. In some embodiments, the image processing may be based on automatic based on depth-sensing, object recognition machine-learning, and eye tracking. By comparing the determined parameters of a common subject or point of interest in a first preview image from an initiating device and a second preview image from a responding device, the initiating device can determine what adjustment to a position, orientation, or camera setting of the responding device is needed based on the implemented photography mode.

In block 3508, the processor may perform operations including transmitting, to the responding device, a first instruction configured to enable the responding device to display a notification for adjusting the position or the orientation of the responding device based at least on the adjustment. Based on the determined adjustment in block 3506, the initiating device may transmit an instruction or notification to the responding device including the adjustment information, which describes how a position, orientation, or camera setting of the responding device should be manually or automatically adjusted. In some embodiments, the instruction can be configured to cause indicators to be displayed on an interface of the responding device to guide a user to adjust the responding device accordingly. In some embodiments, the instruction may be configured to automatically adjust a camera setting (e.g., focus, zoom, flash, etc.) of the responding device.

In block 3510, the processor may perform operations including determining whether the determined adjustment is within an acceptable threshold range for conducting simultaneous multi-viewpoint photography. The initiating device may determine whether the position, orientation, or camera settings of a responding device as determined from image processing performed in block 3506 correspond to the location and/or orientation adjustment information transmitted in communication 436. In other words, the initiating device 402 may determine whether the responding device 404 is “ready” to perform synchronous multi-viewpoint photography, such that the responding device 404 is at a desired, ultimate location and orientation (e.g., elevation, tilt angle, camera settings and features, etc.). The desired location and orientation of a responding device with respect to a point of interest and an initiating device may vary depending on the photography or video capture mode enabled. For example, a 3D image capture mode may indicate to the users of an initiating device and any number of responding devices to be at an equivalent distance from a point of interest and to have a same tilt angle. As another example, a panoramic image capture mode may indicate to the users of an initiating device and any number of responding devices to orient the devices in a linear manner with cameras facing a same direction (e.g., a horizon).

In some embodiments, determining whether the adjustment determined in block 3506 is within an acceptable threshold range of the location and/or orientation adjustment information may include determining that further adjustments to the position, orientation, or camera settings of the responding device are needed (i.e. the determined adjustment in block 3506 is outside of a threshold range), or that no further adjustments to the position, orientation, or camera settings of the responding device are needed (i.e. the determined adjustment is block 3506 is within a threshold range). When the initiating device determines that no further adjustments to the responding device are needed, the responding device may be considered to be in a “ready” state, such that synchronous image capture may begin. For example, the initiating device may determine that a responding device is in a ready state if the camera tilt angle is at least within a threshold range of 5 degrees. As another example, the initiating device may determine that a responding device is in a ready state if within 0.25 meters of a desired location with respect to a point of interest. As a further example, the initiating device may determine that a responding device is in a ready state if a point of interest is centered within preview images. Image processing may be implemented after obtaining a preview image to account for any variance within a tolerable threshold range for the location and/or orientation parameters of any responding device.

In some embodiments, the initiating device may determine that the determined adjustment is not within an acceptable threshold range for conducting simultaneous multi-viewpoint photography. In response to determining that the determined adjustment is not within the acceptable threshold range for conducting simultaneous multi-viewpoint photography, the initiating device may transmit the first instruction configured to enable the responding device to display the notification for adjusting the position or the orientation of the responding device based at least on the adjustment. In response to determining that the determined adjustment is not within an acceptable threshold range for conducting simultaneous multi-viewpoint photography, processes described in blocks 3504 through 3508 may be repeated until no further adjustment to the responding device is needed. In other words, the initiating device may determine that a responding device is not in a “ready” status until the responding device has been positioned and oriented correctly with respect to the initiating device, a subject or point of interest, and/or any other responding devices. This may be performed by continuously receiving preview images from the responding device, processing the preview images to determine whether an adjustment is needed, and transmitting updated adjustment information in an instruction to the responding device. For example, the initiating device may receive further second preview images from the responding device, performing image processing on the first preview image and the further second preview images to determine a second adjustment to the position or the orientation of the responding device, and transmit, to the responding device, a third instruction configured to enable the responding device to display a second notification for adjusting the position or the orientation of the responding device based at least on the second adjustment.

In block 3512, the processor may perform operations including transmitting, to the responding device, a second instruction configured to enable the responding device to capture a second image at approximately the same time as the initiating device captures a first image. The processes described in block 3512 may be performed after the initiating device determines that no further adjustments to the responding device are needed, such that the responding device is in a “ready” status to begin image capture. For example, the initiating device may transmit the second instruction in response to determining that the determined adjustment is within the acceptable threshold range for conducting simultaneous multi-viewpoint photography.

The second instruction may include configuration information to implement one or more various methods for synchronous image capture. In some embodiments, the initiating device may store a first time value when the first image is captured. The second instruction may include this first time value.

The second image, or the image captured by the responding device as a result of implementing or otherwise being configured by the second instruction received from the initiating device, may be associated with a second time value corresponding to when the second image is captured. The second time value may be approximate to the first time value. For example, the instruction transmitted by the initiating device may include the time (e.g., timestamp) at which the image was captured by the initiating device, The responding device may use this time value associated with the initiating device captured image to determine which of any images captured in a cyclic buffer of the responding device have timestamps closest to the timestamp of the image captured by the initiating device.

In some embodiments, the instruction may include an initiate time value corresponding to the time that a user-initiated image capture (e.g., as described with reference to operation 450 of FIG. 4). In some embodiments, the initiate time value may be based on the time synchronization values received by the initiating device and the responding device, such as GNSS time signals (e.g., as described with reference to communications 416 and 418 of FIG. 4). The time synchronization values, as stored on the initiating device and the responding device, may be used to identify and correlate images captured and stored within cyclic buffers within each device. In some embodiments, the initiate time value may be based at least on a local clock frequency of the initiating device.

In some embodiments, the instruction transmitted by the initiating device may include configuration information to automatically initiate the generation of an analog signal for purposes of synching image capture. An analog signal may be generated and output by the initiating device to initiate image capture. For example, the initiating device may generate a flash via the camera flash or an audio frequency “chirp” via speakers to instruct the responding device to begin image capture automatically. The responding device may be capable of detecting a flash or audio frequency “chirp” generated by the initiating device, and may begin the process to capture at least one image. In some embodiments, a test analog signal may be generated to determine the time between generation of the analog signal and the time upon which the responding device detects the analog signal. The determined analog latency value may be used to offset when the responding device may begin generating a camera flash for purposes of image capture and/or when the responding device begins image capture.

In some embodiments, the instruction transmitted by the initiating device may include a delay value. The responding device may be configured to display an indication to initiate or otherwise automatically initiate image capture after the duration of the delay value has passed. A delay value may reduce the amount of electronic storage used when capturing more than one image in a cyclic buffer, such that proceeding to capture images after a certain delay value may be closer to the point in time in which the initiating device begins capturing at least one image. The delay value may be based at least on a latency between the initiating device and the responding device (e.g., Bluetooth Low Energy (BLE) communications latency), where the latency is caused by wireless communications protocols and handshaking and physical distance separating the devices. A delay value may include additional delay time in embodiments involving more than one responding device, such that each responding device may have a different latency value for communications with the initiating device. For example, the delay value may be equal to at least the time value of the largest latency value among the involved responding devices. Thus, the automatic capture of images by each responding device may be offset by at least the difference between their individual time delays and the largest latency value among the responding devices.

In some embodiments, the instruction transmitted by the initiating device to begin image capture may include a command to be executed by the responding device, such as to display an indication on the user interface display of the responding device to instruct the user to initiate image capture manually.

In block 3514, the processor may perform operations including capturing, via the camera, the first image. After performing operations as described in block 3512 to initiate image capture, the initiating device may capture one or more images. In some examples, capturing one or more images may be initiated at least after a time delay according to various embodiments.

In block 3516, the processor may perform operations including receiving, from the responding device, the second image. The initiating device may receive one or more images from the responding device associated with an image captured by the initiating device as described in block 3512. The one or more images received from the responding device may have timestamps approximate to the timestamps of any image captured by the initiating device.

In block 3518, the processor may perform operations including generating an image file based on the first image and the second image. Depending on the image capture mode (e.g., 3D, panoramic, blur or time lapse, multi-viewpoint, 360-degree 3D, and 360-degree panoramic mode), the generated image file may have different stylistic and/or perspective effects. In some embodiments in which an initiating device, responding device, and any other responding devices each capture multiple images in a sequence or burst fashion, the plurality of images may be used to generate a time-lapse image file, or a video file. In some examples, the first image, the second image, and any additional images taken by the initiating device, the responding device, and any other responding devices may be uploaded to a server for image processing and generation of the image file. This may save battery life and resources for the initiating device.

FIG. 36 is a process flow diagram illustrating alternative operations 3600 that may be performed by a processor (e.g., processor 210, 212, 214, 216, 218, 252, 260, 322) of a wireless device (e.g., the wireless device 120a-120e, 200, 120, 150, 152, 402, 404) as part of the method 3500 for performing synchronous multi-viewpoint photography according to some embodiments.

Referring to FIG. 36, in some embodiments following the performance of block 3506 of the method 3500 (FIG. 35), the processor may perform operations described in blocks 3604 through 3618. For example, in block 3602, the processor may perform operations including performing image processing on the first and second preview images to determine the adjustment to the position or the orientation of the responding device by performing the operations as described with respect to blocks 3604 through 3618.

In block 3604, the processor may perform operations including identifying a point of interest in the first preview image. In some embodiments, identifying the point of interest in the first preview image may include receiving a user input on the user interface identifying a region or feature appearing in the first preview image. In some embodiments, identifying the point of interest in the first preview image may include performing image processing to identify as the point of interest a prominent feature centered in the first preview image.

In block 3606, the processor may perform operations including performing image processing on the second preview image to identify the point of interest in the second preview image. Identifying the point of interest in the second preview image may be performed similarly to identifying the point of interest in the first preview image as described in block 3604.

In block 3608, the processor may perform operations including determining a first perceived size of the identified point of interest in the first preview image. For example, the initiating device may perform image processing to determine the size of an object with respect to height and width dimensions at a depth from the camera of the initiating device.

In block 3610, the processor may perform operations including determining a second perceived size of the identified point of interest in the second preview image. For example, the initiating device may perform image processing to determine the size of an object with respect to height and width dimensions at a depth from the camera of the responding device.

In block 3612, the processor may perform operations including calculating a perceived size difference between the first perceived size and the second perceived size. The calculated perceived size difference may be used to determine or may be otherwise included in adjustment information for adjusting a position, orientation, or camera setting of the responding device. For example, the adjustment transmitted to the responding device as part of the instruction as described in block 3508 of the method 3500 (FIG. 35) may be based at least on the perceived size difference.

In block 3614, the processor may perform operations including determining a first tilt angle of the initiating device based on the first preview image such as after image processing e. A tilt angle may include any degree of rotation or orientation with respect to 3D space. In some embodiments, the tilt angle may be referenced with respect to a global tilt angle based on gravitational forces (e.g., accelerometers) or with respect to a reference point, such as a subject or point of interest as identified within a preview image.

In block 3616, the processor may perform operations including determining a second tilt angle of the responding device based on the second preview image such as after image processing.

In block 3618, the processor may perform operations including calculating a tilt angle difference between the first tilt angle and the second tilt angle. The calculated tilt angle difference may be used to determine or may be otherwise included in adjustment information for adjusting a position, orientation, or camera setting of the responding device. For example, the adjustment transmitted to the responding device as part of the instruction as described in block 3508 of the method 3500 (FIG. 35) may be based at least on the tilt angle difference.

The processor may then perform the operations of block 3508 of the method 3500 (FIG. 35) as described.

In some embodiments, the initiating device may receive a third preview image from a second responding device, perform image processing on the third preview image to determine a second adjustment to a second position or a second orientation of the second responding device, and transmit, to the second responding device, a third instruction configured to enable the second responding device to display a second notification based at least on the second adjustment.

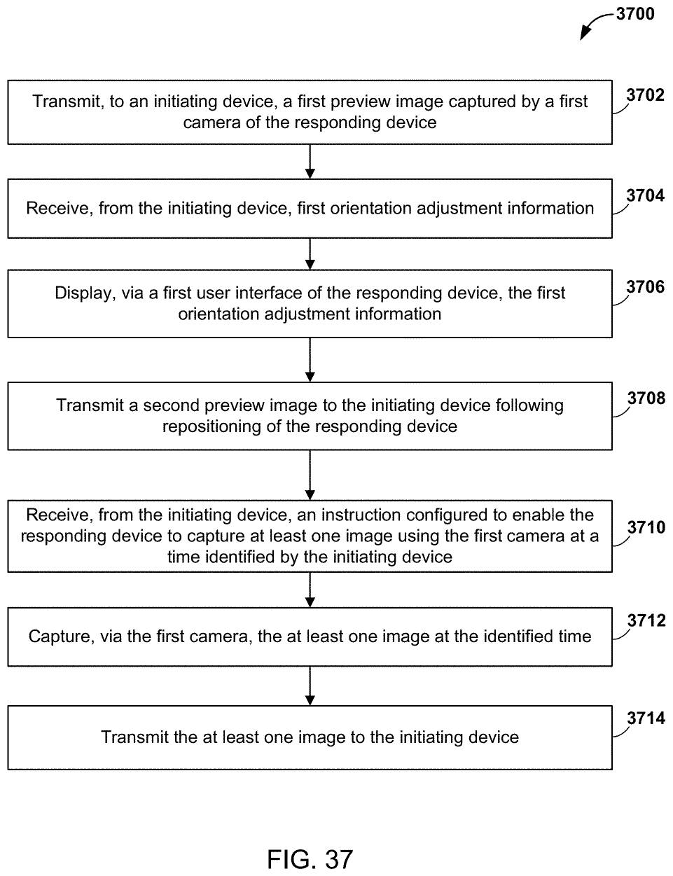

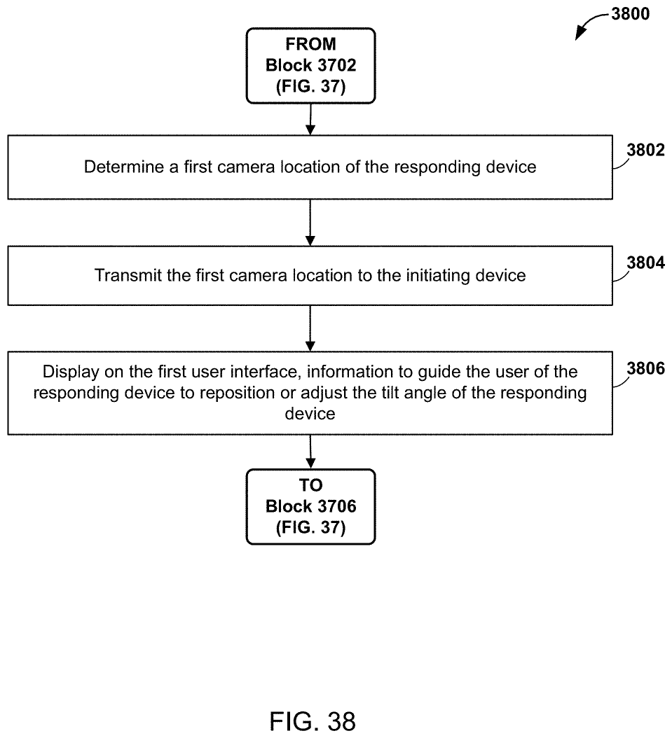

FIG. 37 is a process flow diagram illustrating a method 3700 implementing a responding device to perform synchronous multi-viewpoint photography according to various embodiments. With reference to FIGS. 1-37, the operations of the method 3700 may be performed by a processor (e.g., processor 210, 212, 214, 216, 218, 252, 260, 322) of a wireless device (e.g., the wireless device 120a-120e, 200, 120, 150, 152, 402, 404).

The order of operations performed in blocks 3702-3714 is merely illustrative, and the operations of blocks 3702-3714 may be performed in any order and partially simultaneously in some embodiments. In some embodiments, the method 3700 may be performed by a processor of an initiating device independently from, but in conjunction with, a processor of a responding device. For example, the method 3700 may be implemented as a software module executing within a processor of an SoC or in dedicated hardware within an SoC that monitors data and commands from/within the server and is configured to take actions and store data as described. For ease of reference, the various elements performing the operations of the method 3700 are referred to in the following method descriptions as a “processor.”

In block 3702, the processor may perform operations including transmitting, to an initiating device, a first preview image captured by a first camera of the responding device. The responding device may transmit one or more preview images to the initiating device, where the preview images can be displayed to the user interface of the initiating device and/or processed to determine whether an adjustment to a position, orientation, or camera setting of the responding device is needed for purposes of configuring synchronous multi-viewpoint photography in various modes (e.g., 3D, panoramic, blur or time lapse, multi-viewpoint, 360-degree 3D, and 360-degree panoramic mode). The transmitted preview image may be used by the initiating device to allow a user to determine whether an adjustment to a position, orientation, or camera setting of a responding device is needed for purposes of configuring synchronous multi-viewpoint photography. In some embodiments, the transmitted preview image may be used by the initiating device to automatically determine whether an adjustment to a position, orientation, or camera setting of a responding device is needed for purposes of configuring synchronous multi-viewpoint photography. In some embodiments, transmitting a first preview image from a responding device may include receiving and displaying a first preview image feed captured by the camera of the responding device.

In block 3704, the processor may perform operations including receiving, from the initiating device, first location and/or orientation adjustment information. The first location and/or orientation adjustment information may be included as part of a notification or instruction configured to enable the responding device to display the location and/or orientation adjustment information.

In block 3706, the processor may perform operations including displaying, via a first user interface of the responding device, the first location and/or orientation adjustment information. The location and/or orientation adjustment information can be used by the responding device or can guide a user of the responding device to adjust a position, orientation, or camera settings of the responding device. In some embodiments, the instruction may be configured to cause indicators, such as messages or arrows, to be displayed on a user interface of the responding device to guide a user to adjust the responding device accordingly. In some embodiments, the instruction may be configured to automatically adjust a camera setting (e.g., focus, zoom, flash, etc.) of the responding device.

In some embodiments, the responding device may receive an indication of a point of interest for imaging from the initiating device, and may display, via the user interface of the responding device, the first preview image and the indication of the point of interest within the first preview image. In some embodiments, the responding device may receive, from the initiating device, an image including a point of interest, and display the image within the first user interface with an indication of the point of interest. Displaying a reference or preview image received from the initiating device may allow a user of the responding device to reference the preview image for purposes of adjusting a position, orientation, or camera setting of the responding device. The visual representation can allow a user of the responding device to compare the image or image feed received from the initiating device with a current image or image feed as captured by the camera of the responding device and rendered within a user interface of the responding device.

In block 3708, the processor may perform operations including transmitting a second preview image to the initiating device following repositioning of the responding device. After the position, orientation, or camera settings of the responding device have been adjusted accordingly based at least on the location and/or orientation adjustment information received and displayed as described in blocks 3704 and 3706, the responding device may transmit another preview image to the initiating device. The initiating device may use the second preview image to determine whether any additional location and/or orientation adjustment information is needed by the responding device to correctly adjust the position, orientation, or camera settings of the responding device. For example, if a responding device is adjusted, but varies too much from the location and/or orientation adjustment information, the responding device may transmit the latest preview image, and the initiating device may determine that the responding device is outside the threshold of the location and/or orientation adjustment information originally received by the responding device as described in block 3704, and therefore indicating that the responding device is not ready to begin image capture. Thus, the processes described in block 3702 through 3708 may be repeated until the responded device is positioned, oriented, or otherwise configured correctly according to the last received location and/or orientation adjustment information.

In block 3710, the processor may perform operations including receiving, from the initiating device, an instruction configured to enable the responding device to capture at least one image using the first camera at a time identified by the initiating device. The processes described in block 3710 may be performed after the initiating device determines that no further adjustments to the responding device are needed, such that the responding device is in a “ready” status to begin image capture. For example, the responding device may receive the instruction in response to the initiating device determining that the position, orientation, and/or camera settings of the responding device, as determined from the second preview image, are within an acceptable threshold range defined by the received location and/or orientation adjustment information.

The instruction may include configuration information to implement one or more various methods for synchronous image capture. In some embodiments, the responding device, as part of the instruction, may receive a time value for when the initiating device captures an image. In some embodiments, the time value may be received by the responding device as part of a separate instruction after receiving the initial instruction configured to enable the responding device to capture at least one image.

The image captured by the responding device as a result of implementing or otherwise being configured by the instruction received from the initiating device may be associated with one or more time values corresponding to when the responding device captures one or more images. The time values associated with any images captured by the responding device may be approximate to the time identified by the initiating device. For example, the instruction received by the responding device may include the time (e.g., timestamp) at which the image was captured by the initiating device. The responding device may use this identified time value associated with the initiating device captured image to determine which of any images captured in a cyclic buffer of the responding device have timestamps closest to the timestamp of the image captured by the initiating device.

In block 3712, the processor may perform operations including capturing, via the first camera, the at least one image at the identified time. After performing operations as described in block 3710 to initiate image capture, the responding device may capture one or more images. In some examples, capturing one or more images may be initiated at least after a time delay according to various embodiments. If multiple images are captures in a series or burst fashion, the images may be stored within a cyclic buffer that may be referenced by timestamps corresponding to the time at which the images were captured by the camera of the responding device.

In block 3714, the processor may perform operations including transmitting the at least one image to the initiating device. The responding device may transmit one or more images from the responding device associated with an image captured by the initiating device. The one or more images transmitted by the responding device may have timestamps approximate to the timestamps of any image captured by the initiating device that is received as described in block 3710.

FIG. 38 is a process flow diagram illustrating alternative operations 3800 that may be performed by a processor (e.g., processor 210, 212, 214, 216, 218, 252, 260, 322) of a wireless device (e.g., the wireless device 120a-120e, 200, 120, 150, 152, 402, 404) as part of the method 3700 for performing synchronous multi-viewpoint photography according to some embodiments.

Following the performance of the operations of block 3702 of the method 3700, the processor may perform operations including determining a first camera location of the responding device in block 3802. A first camera location of the responding device may be determined by GNSS or other geolocation methods. In some embodiments, a first camera location may be based on processing a preview image displayed within a user interface of the responding device.

In block 3804, the processor may perform operations including transmitting the first camera location to the initiating device. Receiving first location and/or orientation adjustment information from the initiating device may include information configured to be displayed on the first user interface to guide a user of the responding device to move the first camera to a second location removed from the first camera location or to adjust a tilt angle of the first camera.

In block 3806, the processor may perform operations including displaying on the first user interface, information to guide the user of the responding device to reposition or adjust the tilt angle of the responding device.

The processor may then perform the operations of block 3706 of the method 3700 (FIG. 37) as described.

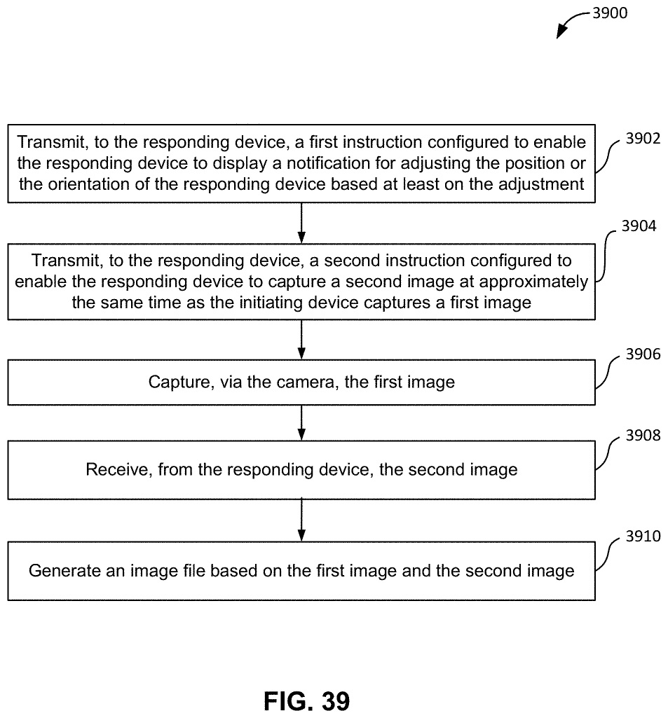

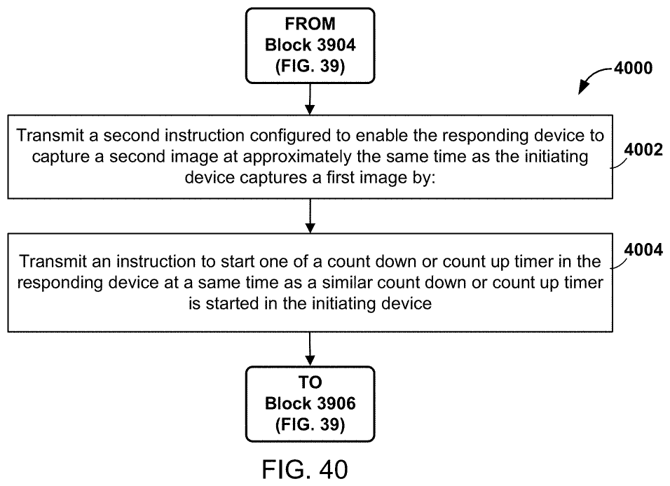

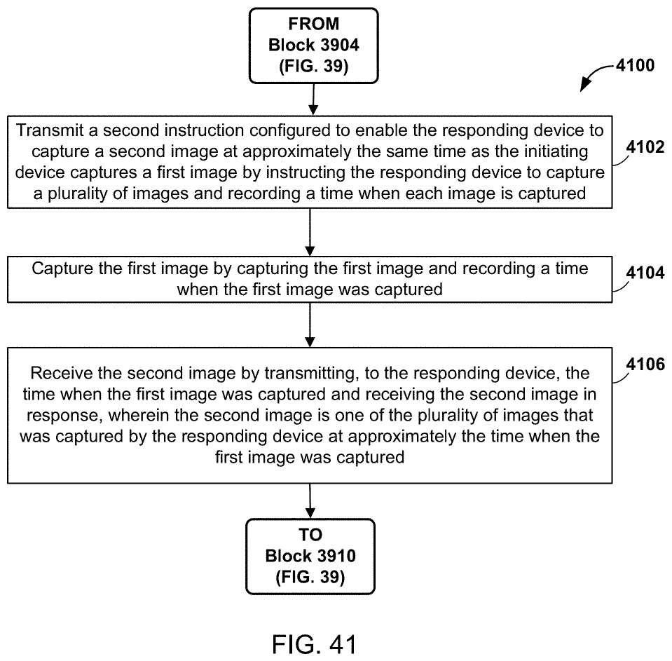

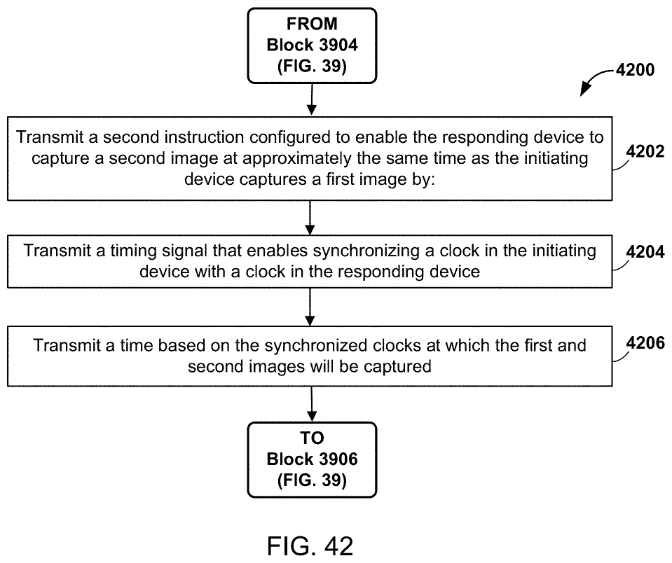

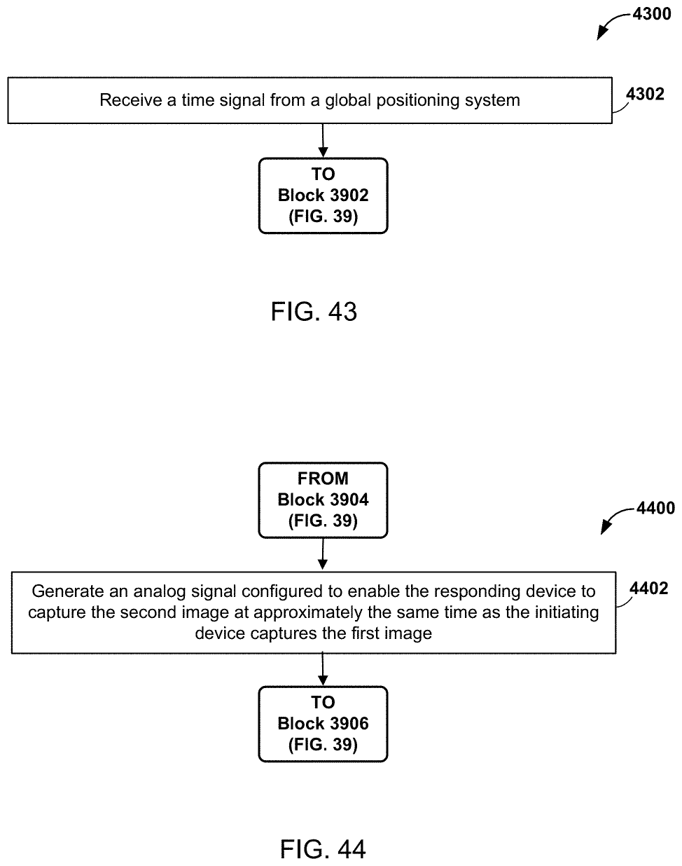

FIG. 39 is a process flow diagram illustrating a method 3900 implementing an initiating device to perform synchronous multi-viewpoint photography according to various embodiments. With reference to FIGS. 1-39, the operations of the method 3900 may be performed by a processor (e.g., processor 210, 212, 214, 216, 218, 252, 260, 322) of a wireless device (e.g., the wireless device 120a-120e, 200, 120, 150, 152, 402, 404).

The order of operations performed in blocks 3902-3910 is merely illustrative, and the operations of blocks 3902-3910 may be performed in any order and partially simultaneously in some embodiments. In some embodiments, the method 3900 may be performed by a processor of an initiating device independently from, but in conjunction with, a processor of a responding device. For example, the method 3900 may be implemented as a software module executing within a processor of an SoC or in dedicated hardware within an SoC that monitors data and commands from/within the server and is configured to take actions and store data as described. For ease of reference, the various elements performing the operations of the method 3900 are referred to in the following method descriptions as a “processor.”

In block 3902, the processor may perform operations including transmitting, to a responding device, a first instruction configured to enable the responding device to display a notification for adjusting a position or an orientation of the responding device. Based on an adjustment (e.g., location and/or orientation adjustment information) determined by the initiating device based on preview images received from the responding device, the initiating device may transmit an instruction or notification to the responding device including the adjustment information, which describes how a position, orientation, or camera setting of the responding device should be manually or automatically adjusted. In some embodiments, the instruction may be configured to cause indicators to be displayed on an interface of the responding device to guide a user to adjust the responding device accordingly. In some embodiments, the instruction may be configured to automatically adjust a camera setting (e.g., focus, zoom, flash, etc.) of the responding device.

In block 3904, the processor may perform operations including transmitting, to the responding device, a second instruction configured to enable the responding device to capture a second image at approximately the same time as the initiating device captures a first image. The processes described in block 3904 may be performed after the initiating device determines that no further adjustments to the responding device are needed, such that the responding device is in a “ready” status to begin image capture. For example, the initiating device may transmit the second instruction in response to determining that the determined adjustment is within the acceptable threshold range for conducting simultaneous multi-viewpoint photography.

The second instruction may include configuration information to implement one or more various methods for synchronous image capture. In some embodiments, the initiating device may store a first time value when the first image is captured. The second instruction may include this first time value. The second image, or the image captured by the responding device as a result of implementing or otherwise being configured by the second instruction received from the initiating device, may be associated with a second time value corresponding to when the second image is captured. The second time value may be approximate to the first time value. For example, the instruction transmitted by the initiating device may include the time (e.g., timestamp) at which the image was captured by the initiating device, The responding device may use this time value associated with the initiating device captured image to determine which of any images captured in a cyclic buffer of the responding device have timestamps closest to the timestamp of the image captured by the initiating device.

In some embodiments, the instruction may include an initiate time value corresponding to the time that a user-initiated image capture (e.g., as described with reference to operation 450 of FIG. 4). In some embodiments, the initiate time value may be based on the time synchronization values received by the initiating device and the responding device, such as GNSS time signals (e.g., as described with reference to communications 416 and 418 of FIG. 4). The time synchronization values, as stored on the initiating device and the responding device, may be used to identify and correlate images captured and stored within cyclic buffers within each device. In some embodiments, the initiate time value may be based at least on a local clock frequency of the initiating device.

In some embodiments, the instruction transmitted by the initiating device may include configuration information to automatically initiate the generation of an analog signal for purposes of synching image capture. For example, the second instruction may be further configured to enable the responding device to generate a camera flash and capture the second image at approximately the same time as the initiating device generates a camera flash and captures the first image. An analog signal may be generated and output by the initiating device to initiate image capture. For example, the initiating device may generate a flash via the camera flash or an audio frequency “chirp” via speakers to instruct the responding device to begin image capture automatically. The responding device may be capable of detecting a flash or audio frequency “chirp” generated by the initiating device, and may begin the process to capture at least one image. In some embodiments, a test analog signal may be generated to determine the time between generation of the analog signal and the time upon which the responding device detects the analog signal. The determined analog latency value may be used to offset when the responding device may begin generating a camera flash for purposes of image capture and/or when the responding device begins image capture.

In some embodiments, the instruction transmitted by the initiating device may include a delay value. The responding device may be configured to display an indication to initiate or otherwise automatically initiate image capture after the duration of the delay value has passed. A delay value may reduce the amount of electronic storage used when capturing more than one image in a cyclic buffer, such that proceeding to capture images after a certain delay value may be closer to the point in time in which the initiating device begins capturing at least one image. The delay value may be based at least on a latency between the initiating device and the responding device (e.g., BLE communications latency), where the latency is caused by wireless communications protocols and handshaking and physical distance separating the devices. A delay value may include additional delay time in embodiments involving more than one responding device, such that each responding device may have a different latency value for communications with the initiating device. For example, the delay value may be equal to at least the time value of the largest latency value among the involved responding devices. Thus, the automatic capture of images by each responding device may be offset by at least the difference between their individual time delays and the largest latency value among the responding devices.

In some embodiments, the instruction transmitted by the initiating device to begin image capture may include a command to be executed by the responding device, such as to display an indication on the user interface display of the responding device to instruct the user to initiate image capture manually.

In block 3906, the processor may perform operations including capturing the first image. After performing operations as described in block 3904 to initiate image capture, the initiating device may capture one or more images. In some examples, capturing one or more images may be initiated at least after a time delay according to various embodiments.

In block 3908, the processor may perform operations including receiving, from the responding device, the second image. The initiating device may receive one or more images from the responding device associated with an image captured by the initiating device as described in block 3906. The one or more images received from the responding device may have timestamps approximate to the timestamps of any image captured by the initiating device.

In block 3910, the processor may perform operations including generating an image file based on the first image and the second image. Depending on the image capture mode (e.g., 3D, panoramic, blur or time lapse, multi-viewpoint, 360-degree 3D, and 360-degree panoramic mode), the generated image file may have different stylistic and/or perspective effects. In some embodiments in which an initiating device, responding device, and any other responding devices each capture multiple images in a sequence or burst fashion, the plurality of images may be used to generate a time-lapse image file, or a video file. In some examples, the first image, the second image, and any additional images taken by the initiating device, the responding device, and any other responding devices may be uploaded to a server for image processing and generation of the image file. This may save battery life and resources for the initiating device.

In some embodiments, the processor may perform operations including capturing a third image, storing a third time value when the third image is captured, transmitting the third time value to the responding device, receiving, from the responding device, a fourth image corresponding to the third time value, and generating the multi-image file based on the third image and the fourth image received from responding device.

FIG. 40 is a process flow diagram illustrating alternative operations 4000 that may be performed by a processor (e.g., processor 210, 212, 214, 216, 218, 252, 260, 322) of a wireless device (e.g., the wireless device 120a-120e, 200, 120, 150, 152, 402, 404) as part of the method 3900 for performing synchronous multi-viewpoint photography according to some embodiments.

Referring to FIG. 40, in some embodiments during or after the performance of block 3904 of the method 3900 (FIG. 39), the processor may perform operations described in blocks 4002 through 4004. For example, in block 4002, the processor may perform operations including transmitting a second instruction configured to enable the responding device to capture a second image at approximately the same time as the initiating device captures a first image by performing the operations as described with respect to block 4004.

In block 4004, the processor may perform operations including transmitting an instruction to start one of a countdown timer or a count up timer in the responding device at a same time as a similar count down or count up timer is started in the initiating device. The instruction may include information to configure or inform the responding device to capture the second image upon expiration of the countdown timer or upon the count up timer reaching a defined value. For example, the countdown timer or count up timer may be based at least on determining a communication delay between the initiating device and the responding device, such that the countdown timer or count up timer are of a time value greater than or equal to the delay. A count up timer or countdown timer may be based at least on a delay as determined by various embodiments.

The processor may then perform the operations of block 3906 (FIG. 39) as described.

FIG. 41 is a process flow diagram illustrating alternative operations 4100 that may be performed by a processor (e.g., processor 210, 212, 214, 216, 218, 252, 260, 322) of a wireless device (e.g., the wireless device 120a-120e, 200, 120, 150, 152, 402, 404) as part of the method 3900 for performing synchronous multi-viewpoint photography according to some embodiments.

Referring to FIG. 41, in some embodiments during or after the performance of block 3904, 3906, and 3908 of the method 3900 (FIG. 39), the processor may perform operations described in blocks 4102 through 4106.

In block 4102, the processor may perform operations including transmitting a second instruction configured to enable the responding device to capture a second image at approximately the same time as the initiating device captures a first image by instructing the responding device to capture a plurality of images and recording a time when each image is captured.

In block 4104, the processor may perform operations including capturing the first image by capturing the first image and recording a time when the first image was captured.

In block 4106, the processor may perform operations including receiving the second image by transmitting, to the responding device, the time when the first image was captured and receiving the second image in response, wherein the second image is one of the plurality of images that was captured by the responding device at approximately the time when the first image was captured.

The processor may then perform the operations of block 3910 (FIG. 39) as described.

FIG. 42 is a process flow diagram illustrating alternative operations 4200 that may be performed by a processor (e.g., processor 210, 212, 214, 216, 218, 252, 260, 322) of a wireless device (e.g., the wireless device 120a-120e, 200, 320, 402, 404) as part of the method 3900 for performing synchronous multi-viewpoint photography according to some embodiments.

Referring to FIG. 42, in some embodiments during or after the performance of block 3904 of the method 3900 (FIG. 39), the processor may perform operations described in blocks 4202 through 4206. For example, in block 4202, the processor may perform operations including transmitting a second instruction configured to enable the responding device to capture a second image at approximately the same time as the initiating device captures a first image by performing the operations as described with respect to blocks 4204 and 4206.

In block 4204, the processor may perform operations including transmitting a timing signal that enables synchronizing a clock in the initiating device with a clock in the responding device. The initiating device may transmit the timing signal to the responding device for synchronization purposes. In some embodiments, the initiating device may transmit, alternatively or in addition to the time signal, an instruction to configure the responding device to request or retrieve the timing signal from a source in which the initiating device received the timing signal. For example, the initiating device may transmit an instruction to configure the responding device to request a timing signal from the same GNSS that the initiating device received the timing signal. The timing signal may be a server referenced clock signal, a GNSS timing or clock signal, a local clock (e.g., crystal oscillator clock) of the initiating device, or any other timing signal as described by various embodiments.

In block 4206, the processor may perform operations including transmitting a time based on the synchronized clocks at which the first and second images will be captured. The initiating device can store a time value for each image captured by the initiating device. The time value may be used to reference and retrieve images captured by the responding device for purposes of synchronous multi-viewpoint image capture as described by embodiments.

The processor may then perform the operations of block 3906 of the method 3900 (FIG. 39) as described.

FIG. 43 is a process flow diagram illustrating alternative operations 4300 that may be performed by a processor (e.g., processor 210, 212, 214, 216, 218, 252, 260, 322) of a wireless device (e.g., the wireless device 120a-120e, 200, 120, 150, 152, 402, 404) as part of the method 3900 for performing synchronous multi-viewpoint photography according to some embodiments.

Prior to the performance of the operations of block 3902 of the method 3900 (FIG. 39), the processor may perform operations including receiving a time signal from a global positioning system (GPS) in block 4302. The initiating device may receive a time signal from a GNSS receiver for use in creating and referencing timestamped images as described in embodiments. In some embodiments, the initiating device may receive or request the time signal from a GNSS receiver in response to determining that a user of the initiating device has initiated an application or process to performing synchronous multi-viewpoint image capture. In some examples, transmitting the second instruction configured to enable the responding device to capture a second image at approximately the same time as the initiating device captures a first image includes indicating a time based on GNSS time signals at which the responding device should capture the second image.

The processor may then perform the operations of block 3902 of the method 3900 (FIG. 39) as described.

FIG. 44 is a process flow diagram illustrating alternative operations 4400 that may be performed by a processor (e.g., processor 210, 212, 214, 216, 218, 252, 260, 322) of a wireless device (e.g., the wireless device 120a-120e, 200, 120, 150, 152, 402, 404) as part of the method 3900 for performing synchronous multi-viewpoint photography according to some embodiments.

Following the performance of the operations of block 3904 of the method 3900 (FIG. 39), the processor may perform operations including generating an analog signal configured to enable the responding device to capture the second image at approximately the same time as the initiating device captures the first image in block 4402. In some embodiments, the analog signal may be a camera flash or an audio frequency signal. In some embodiments, capturing the first image may be performed a predefined time after generating the analog signal.

In some embodiments, an analog signal may be generated and output by the initiating device to initiate image capture. For example, the initiating device may generate a flash via the camera flash or an audio frequency “chirp” via speakers to instruct the responding device to begin image capture automatically. The responding device may be capable of detecting a flash or audio frequency “chirp” generated by the initiating device, and may begin the process to capture at least one image a predefined or configurable time after detecting the analog signal. In some embodiments, a test analog signal may be generated to determine the time between generation of the analog signal and the time upon which the responding device detects the analog signal. The determined analog latency value may be used to offset when the responding device may begin generating a camera flash for purposes of image capture and/or when the responding device begins image capture. The predefined time may be based at least on the determined analog latency value.

The processor may then perform the operations of block 3906 of the method 3900 (FIG. 39) as described.

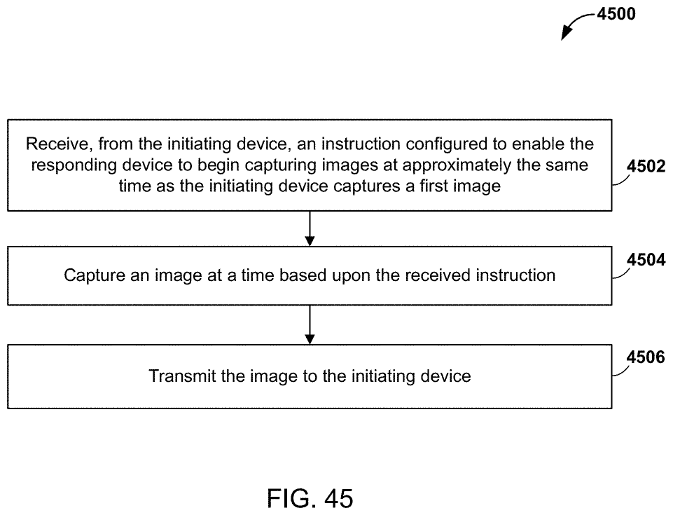

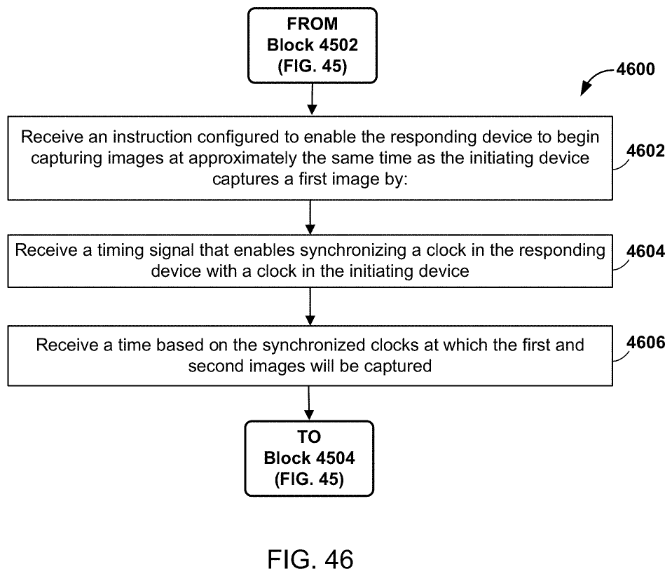

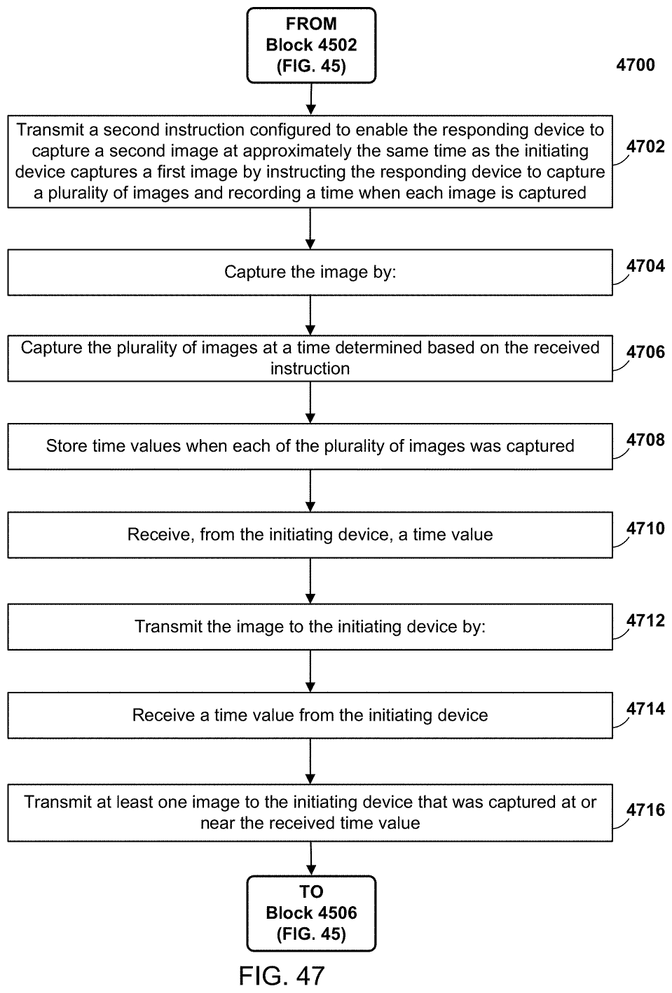

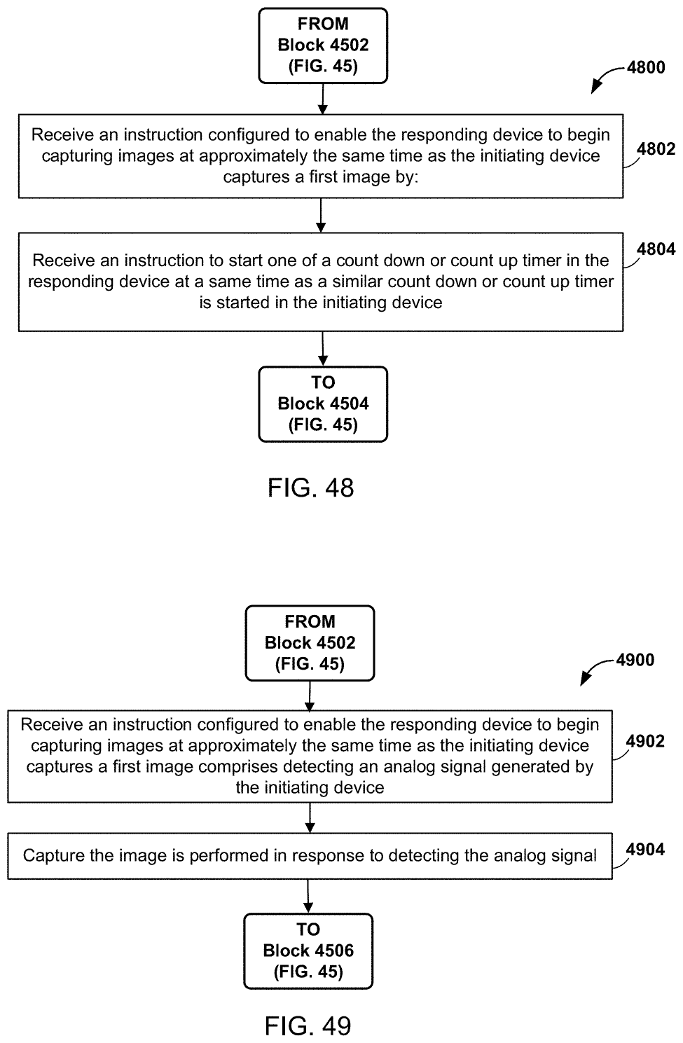

FIG. 45 is a process flow diagram illustrating a method 4500 implementing a responding device to perform synchronous multi-viewpoint photography according to various embodiments. With reference to FIGS. 1-45, the operations of the method 4500 may be performed by a processor (e.g., processor 210, 212, 214, 216, 218, 252, 260, 322) of a wireless device (e.g., the wireless device 120a-120e, 200, 120, 150, 152, 402, 404).

The order of operations performed in blocks 4502 through 4506 is merely illustrative, and the operations of blocks 4502-4505 may be performed in any order and partially simultaneously in some embodiments. In some embodiments, the method 4500 may be performed by a processor of an initiating device independently from, but in conjunction with, a processor of a responding device. For example, the method 4500 may be implemented as a software module executing within a processor of an SoC or in dedicated hardware within an SoC that monitors data and commands from/within the server and is configured to take actions and store data as described. For ease of reference, the various elements performing the operations of the method 4500 are referred to in the following method descriptions as a “processor.”

In block 4502, the processor may perform operations including receiving, from an initiating device, an instruction configured to enable the responding device to capture an image at approximately the same time as the initiating device captures a first image. The processes described in block 3710 may be performed after the initiating device determines that no further adjustments to the responding device are needed, such that the responding device is in a “ready” status to begin image capture. For example, the responding device may receive the instruction in response to the initiating device determining that the position, orientation, and/or camera settings of the responding device, as determined from the second preview image, are within an acceptable threshold range defined by the received location and/or orientation adjustment information.

The instruction may include configuration information to implement one or more various methods for synchronous image capture. In some embodiments, the responding device, as part of the instruction, may receive a time value for when the initiating device captures an image. In some embodiments, the time value may be received by the responding device as part of a separate instruction after receiving the initial instruction configured to enable the responding device to capture at least one image.

The image captured by the responding device as a result of implementing or otherwise being configured by the instruction received from the initiating device may be associated with one or more time values corresponding to when the responding device captures one or more images. The time values associated with any images captured by the responding device may be approximate to the time identified by the initiating device. For example, the instruction received by the responding device may include the time (e.g., timestamp) at which the image was captured by the initiating device. The responding device may use this identified time value associated with the initiating device captured image to determine which of any images captured in a cyclic buffer of the responding device have timestamps closest to the timestamp of the image captured by the initiating device.

In some embodiments, the responding device, as part of the instruction or in addition to the instruction received in block 4502, may receive an instruction or information to capture an image at a time based upon a GNSS time signal.

In block 4504, the processor may perform operations including capturing an image at a time based upon the received instruction. After performing operations as described in block 4502 to initiate image capture, the responding device may capture one or more images. In some examples, capturing one or more images may be initiated at least after a time delay according to various embodiments. If multiple images are captures in a series or burst fashion, the images may be stored within a cyclic buffer that may be referenced by timestamps corresponding to the time at which the images were captured by the camera of the responding device.

In block 4506, the processor may perform operations including transmitting the image to the initiating device. The responding device may transmit one or more images from the responding device associated with an image captured by the initiating device. The one or more images transmitted by the responding device may have timestamps approximate to the timestamps of any image captured by the initiating device.

FIG. 46 is a process flow diagram illustrating alternative operations 4600 that may be performed by a processor (e.g., processor 210, 212, 214, 216, 218, 252, 260, 322) of a wireless device (e.g., the wireless device 120a-120e, 200, 120, 150, 152, 402, 404) as part of the method 4500 for performing synchronous multi-viewpoint photography according to some embodiments.

Referring to FIG. 46, in some embodiments during or after the performance of block 4502 of the method 4500 (FIG. 45), the processor may perform operations described in blocks 4602 through 4606. For example, in block 4602, the processor may perform operations including receiving an instruction configured to enable the responding device to capture an image at approximately the same time as the initiating device captures a first image by performing the operations as described with respect to blocks 4604 and 4606.

In block 4604, the processor may perform operations including receiving a timing signal that enables synchronizing a clock in the responding device with a clock in the initiating device. The responding device may receive the timing signal from the initiating device for synchronization purposes. In some embodiments, the responding device may receive, alternatively or in addition to the time signal, the instruction to configure the responding device to request or retrieve the timing signal from a source in which the initiating device received the timing signal. For example, the responding device may receive an instruction to configure the responding device to use a timing signal from the same GNSS that the initiating device received. The timing signal may be a server referenced clock signal, a GNSS timing or clock signal, a local clock (e.g., crystal oscillator clock) of the initiating device, or any other timing signal as described by various embodiments.

In block 4606, the processor may perform operations including receiving a time based on the synchronized clocks at which the first and second images will be captured. The initiating device may store a time value for each image captured by the initiating device. The responding device may receive the time values for each image that the initiating devices captures. The time values may be used to reference and retrieve images captured by the responding device for purposes of synchronous multi-viewpoint image capture as described by embodiments. In some embodiments, capturing the image via the camera of the responding device at a time based upon the received instruction comprises capturing the image at the received time based on the synchronized clock.

The processor may then perform the operations of block 4504 of the method 4500 (FIG. 45) as described.

FIG. 47 is a process flow diagram illustrating alternative operations 4700 that may be performed by a processor (e.g., processor 210, 212, 214, 216, 218, 252, 260, 322) of a wireless device (e.g., the wireless device 120a-120e, 200, 120, 150, 152, 402, 404) as part of the method 4500 for performing synchronous multi-viewpoint photography according to some embodiments.

Referring to FIG. 47, in some embodiments during or after the performance of blocks 4502, 4504, and 4506 of the method 4500 (FIG. 45), the processor may perform operations described in blocks 4702 through 4716.

In block 4702, the processor may perform operations including receiving an instruction configured to enable the responding device to capture an image at approximately the same time as the initiating device captures a first image comprises receiving an instruction to capture a plurality of images and recording a time when each image is captured.

In block 4704, the processor may perform operations including capturing the image.

In block 4706 the processor may perform operations including capturing the plurality of images at a time determined based on the received instruction. The responding device may capture multiple images in response to receiving the instruction as described in block 4702.

In block 4708 the processor may perform operations including storing time values when each of the plurality of images was captured. Each image captured by the camera of the responding device may be associated with a time value or a timestamp based on a synchronous clock signal.

In block 4710, the processor may perform operations including receiving a time value from the initiating device.

In block 4712, the processor may perform operations including transmitting the image to the initiating device.

In block 4714, the processor may perform operations including receiving a time value from the initiating device.

In block 4716, the processor may perform operations including transmitting at least one image to the initiating device that was captured at or near the received time value.

The processor may then perform the operations of block 4506 of the method 4500 (FIG. 45) as described.

FIG. 48 is a process flow diagram illustrating alternative operations 4800 that may be performed by a processor (e.g., processor 210, 212, 214, 216, 218, 252, 260, 322) of a wireless device (e.g., the wireless device 120a-120e, 200, 120, 150, 152, 402, 404) as part of the method 4500 for performing synchronous multi-viewpoint photography according to some embodiments.

Referring to FIG. 48, in some embodiments during or after the performance of block 4502 of the method 4500 (FIG. 45), the processor may perform operations described in blocks 4802 through 4804. For example, in block 4802, the processor may perform operations including receiving an instruction configured to enable the responding device to capture an image at approximately the same time as the initiating device captures a first image by performing the operations as described with respect to block 4804.

In block 4804, the processor may perform operations including receiving an instruction to start one of a countdown timer or a count up timer in the responding device at a same time as a similar count down or count up timer is started in the initiating device. The instruction may include information to configure or inform the responding device to capture the second image upon expiration of the countdown timer or upon the count up timer reaching a defined value. For example, the countdown timer or count up timer may be based at least on determining a communication delay between the initiating device and the responding device, such that the countdown timer or count up timer are of a time value greater than or equal to the delay. A count up timer or countdown timer may be based at least on a delay as determined by various embodiments.

The processor may then perform the operations of block 4504 of the method 4500 (FIG. 45) as described.

FIG. 49 is a process flow diagram illustrating alternative operations that may be performed by a processor (e.g., processor 210, 212, 214, 216, 218, 252, 260, 322) of a wireless device (e.g., the wireless device 120a-120e, 200, 120, 150, 152, 402, 404) as part of the method 4500 for performing synchronous multi-viewpoint photography according to some embodiments.

Following the performance of the operations of block 4502 of the method 4500 (FIG. 45), the processor may perform operations including receiving an instruction configured to enable the responding device to capture an image at approximately the same time as the initiating device captures a first image by detecting an analog signal generated by the initiating device in block 4902. In some embodiments, the analog signal may be a camera flash or an audio frequency signal.

In block 4904, the processor may perform operations including capturing the image is performed in response to detecting the analog signal. In some embodiments, capturing the image may be performed a predefined time after detecting the analog signal.

In some embodiments, an analog signal may be detected by the responding device to initiate image capture. The responding device may be capable of detecting a flash or audio frequency “chirp” generated by the initiating device, and may begin the process to capture at least one image a predefined or configurable time after detecting the analog signal. In some embodiments, a test analog signal may be detected by the responding device to determine the time between generation of the analog signal and the time upon which the responding device detects the analog signal. The determined analog latency value may be used to offset when the responding device may begin image capture after detecting a camera flash or audio signal. The predefined time may be based at least on the determined analog latency value.

In some embodiments, receiving an instruction configured to enable the responding device to capture an image at approximately the same time as the initiating device captures a first image may include an instruction configured to enable the responding device to generate an illumination flash at approximately the same time as the initiating device generates an illumination flash. For example, an illumination flash may be generated by the initiating device and the responding device may begin image capture some time after detecting the illumination flash based upon the instruction when capturing the image.

The processor may then perform the operations of block 4506 of the method 4500 (FIG. 45) as described.

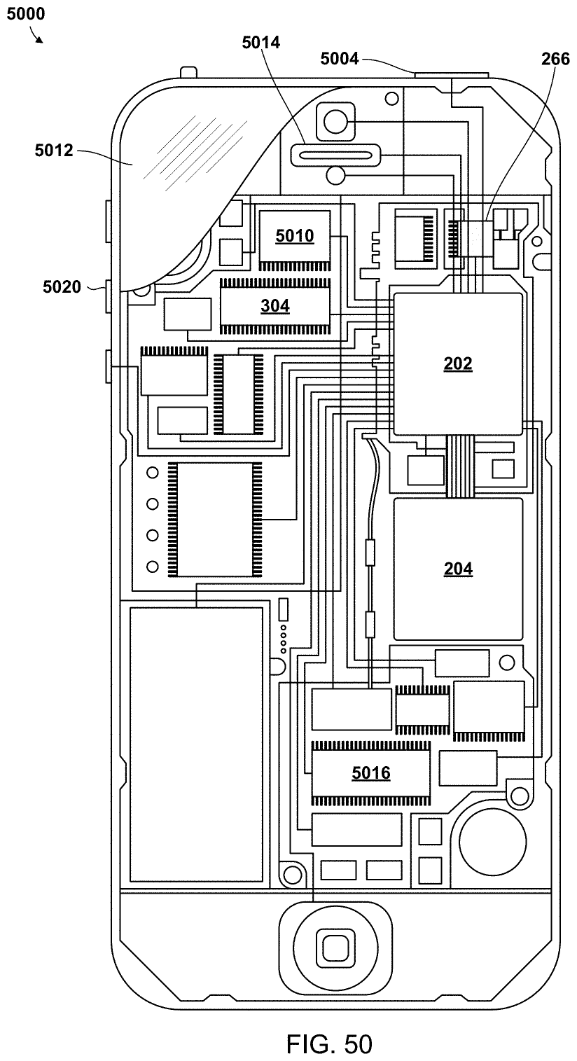

FIG. 50 is a component block diagram of an example wireless device in the form of a smailphone 5000 suitable for implementing some embodiments. With reference to FIGS. 1-50, a smailphone 5000 may include a first SOC 202 (such as a SOC-CPU) coupled to a second SOC 204 (such as a 5G capable SOC). The first and second SOCs 202, 204 may be coupled to internal electronic storage (i.e. memory) 304, 5016, a display 5012, and a speaker 5014. Additionally, the smailphone 5000 may include an antenna 5004 for sending and receiving electromagnetic radiation that may be connected to a wireless data link or cellular telephone transceiver 266 coupled to one or more processors in the first or second SOCs 202, 204. Smartphones 5000 typically also include menu selection buttons or rocker switches 5020 for receiving user inputs.

A typical smailphone 5000 also includes a sound encoding/decoding (CODEC) circuit 5010, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 5010 may include a digital signal processor (DSP) circuit (not shown separately).

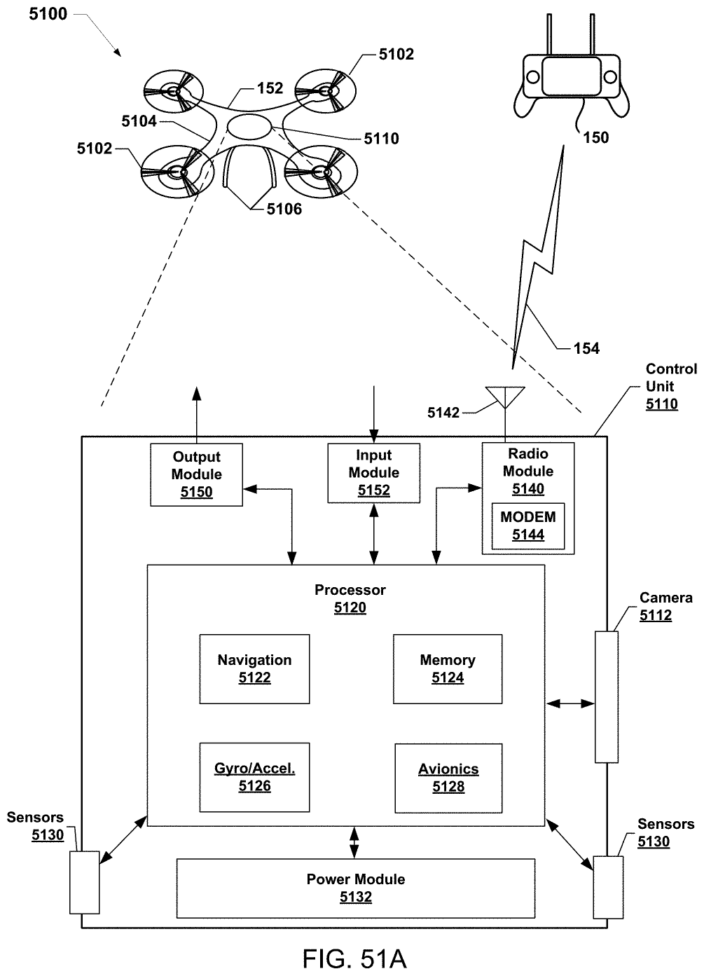

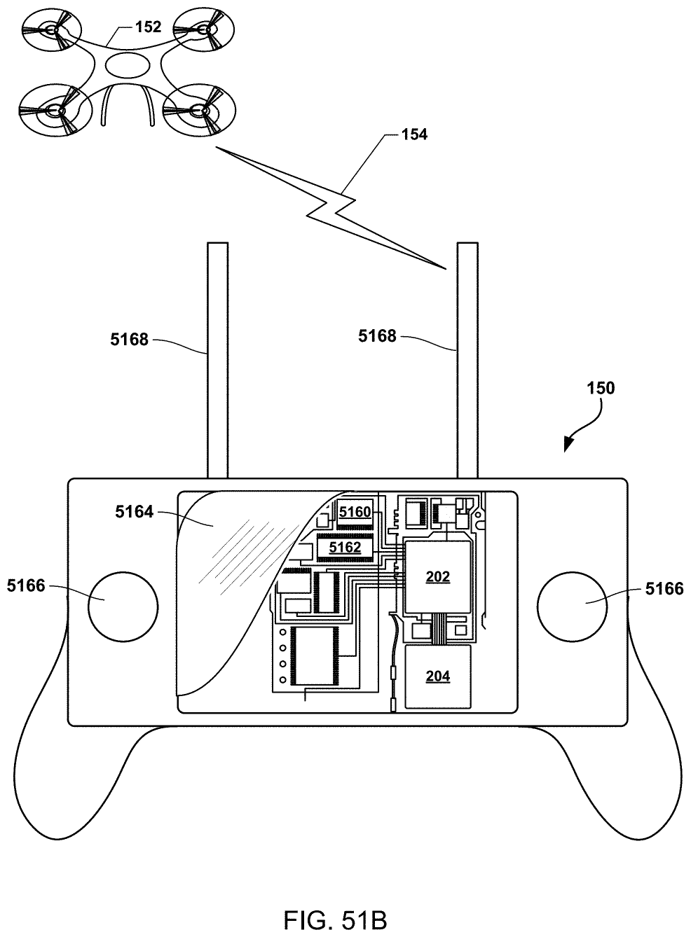

As noted above, in addition to wireless devices, various embodiments may also be implemented on devices capable of autonomous or semiautonomous locomotion, such as unmanned aerial vehicles, unmanned ground vehicles, robots, and similar devices capable of wireless communications and capturing images. Using UAVs as an example, one or more UAVs may be operated according to various embodiments to capture simultaneous or near simultaneous images from different perspectives based upon the location and viewing angle of each of the devices. In some embodiments, one or more robotic vehicles may be used in combination with handheld wireless devices similar to the methods described above. In some embodiments, all of the wireless devices participating in a multi-view imaging session may be robotic vehicles including one of the robotic vehicle functioning as the initiating device. In addition to the unique viewing perspectives achievable with camera-equipped UAVs, modern robotic vehicles have a number of functional capabilities that can be leveraged for capturing multi-perspective images including, for example, GNSS navigation capabilities, navigation or avionics systems that can maintain (e.g., hover in the case of UAVs) the robotic vehicle at a particular location in a particular orientation, and steerable cameras. UAVs may include winged or rotorcraft varieties. FIG. 51A illustrates an example robotic vehicle in the form of a UAV 5100 with a rotary propulsion design that utilizes one or more rotors 5102 driven by corresponding motors to provide lift-off (or take-off) as well as other aerial movements (e.g., forward progression, ascension, descending, lateral movements, tilting, rotating, etc.). The UAV 5100 is illustrated as an example of a robotic vehicle that may utilize various embodiments, but is not intended to imply or require that various embodiments are limited to rotorcraft UAVs. Various embodiments may equally be used with land-based autonomous vehicles and water-borne autonomous vehicles.

With reference to FIGS. 1A-51, the UAV 5100 may include a number of rotors 5102, a frame 5104, and landing columns 5106 or skids. The frame 5104 may provide structural support for the motors associated with the rotors 5102. For ease of description and illustration, some detailed aspects of the UAV 5100 are omitted such as wiring, frame structure interconnects, or other features that would be known to one of skill in the art. For example, while the UAV 5100 is shown and described as having a frame 5104 having a number of support members or frame structures, the UAV 5100 may be constructed using a molded frame in which support is obtained through the molded structure. While the illustrated UAV 5100 has four rotors 5102, this is merely exemplary and various embodiments may include more or fewer than four rotors 5102.

The UAV 5100 may further include a control unit 5110 that may house various circuits and devices used to power and control the operation of the UAV 5100. The control unit 5110 may include a processor 5120, a power module 5130, sensors 5140, payload-securing units 5144, an output module 5150, an input module 5160, and a radio module 5170.

The processor 5120 may be configured with processor-executable instructions to control travel and other operations of the UAV 5100, including operations of various embodiments. The processor 5120 may include or be coupled to a navigation unit 5122, a memory 5124, a gyro/accelerometer unit 5126, and an avionics module 5128. The processor 5120 and/or the navigation unit 5122 may be configured to communicate with a server through a wireless connection (e.g., a cellular data network) to receive data useful in navigation, provide real-time position reports, and assess data.

The avionics module 5128 may be coupled to the processor 5120 and/or the navigation unit 5122, and may be configured to provide travel control-related information such as altitude, attitude, airspeed, heading, and similar information that the navigation unit 5122 may use for navigation purposes, such as dead reckoning between GNSS position updates. The gyro/accelerometer unit 5126 may include an accelerometer, a gyroscope, an inertial sensor, or other similar sensors. The avionics module 5128 may include or receive data from the gyro/accelerometer unit 5126 that provides data regarding the orientation and accelerations of the UAV 5100 that may be used in navigation and positioning calculations, as well as providing data used in various embodiments for processing images.

The processor 5120 may further receive additional information from the sensors 5140, such as an image sensor or optical sensor (e.g., capable of sensing visible light, infrared, ultraviolet, and/or other wavelengths of light). The sensors 5140 may also include a radio frequency (RF) sensor, a barometer, a sonar emitter/detector, a radar emitter/detector, a microphone or another acoustic sensor, or another sensor that may provide information usable by the processor 5120 for movement operations as well as navigation and positioning calculations.

The power module 5130 may include one or more batteries that may provide power to various components, including the processor 5120, the sensors 5140, the output module 5150, the input module 5160, and the radio module 5170. The power module 5130 may include energy storage components, such as rechargeable batteries. The processor 5120 may be configured with processor-executable instructions to control the charging of the power module 5130 (i.e., the storage of harvested energy), such as by executing a charging control algorithm using a charge control circuit. Alternatively or additionally, the power module 5130 may be configured to manage its own charging. The processor 5120 may be coupled to the output module 5150, which may output control signals for managing the motors that drive the rotors 5102 and other components.

The UAV 5100 may be controlled through control of the individual motors of the rotors 5102 as the UAV 5100 progresses toward a destination. The processor 5120 may receive data from the navigation unit 5122 and use such data in order to determine the present position and orientation of the UAV 5100, as well as the appropriate course towards the destination or intermediate sites. In various embodiments, the navigation unit 5122 may include a GNSS receiver (e.g., a Global Positioning System (GPS) receiver) enabling the UAV 5100 to navigate using GNSS signals. Alternatively or in addition, the navigation unit 5122 may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other UAVs, etc.

The radio module 5170 may be configured to receive navigation signals, such as signals from aviation navigation facilities, etc., and provide such signals to the processor 5120 and/or the navigation unit 5122 to assist in UAV navigation. In various embodiments, the navigation unit 5122 may use signals received from recognizable RF emitters (e.g., AM/FM radio stations, Wi-Fi access points, and cellular network base stations) on the ground.

The radio module 5140 may include a modem 5144 and a transmit/receive antenna 5142. The radio module 5140 may be configured to conduct wireless communications with a UAV controller 150 as well as a variety of wireless communication devices, examples of which include wireless devices (e.g., 120, 5000), a wireless telephony base station or cell tower (e.g., base stations 110), a network access point (e.g., 110b, 110c), other UAVs, and/or another computing device with which the UAV 5100 may communicate. The processor 5120 may establish a bi-directional wireless communication link 154 via the modem 5144 and the antenna 5142 of the radio module 5140 and the UAV controller 150 via a transmit/receive antenna 5142. In some embodiments, the radio module 5140 may be configured to support multiple connections with different wireless communication devices using different radio access technologies.

In various embodiments, the wireless communication device 5140 connect to a server, such as for processing images into multi-viewpoint photograph files, through one or more intermediate communication links, such as a wireless telephony network that is coupled to a wide area network (e.g., the Internet) or other communication devices. In some embodiments, the UAV 5100 may include and employ other forms of radio communication, such as mesh connections with other UAVs or connections to other information sources.

In various embodiments, the control unit 5110 may be equipped with an input module 5152, which may be used for a variety of applications. For example, the input module 5152 may receive images or data from an onboard camera or sensor, or may receive electronic signals from other components (e.g., a payload).

While various components of the control unit 5110 are illustrated as separate components, some or all of the components (e.g., the processor 5120, the output module 5150, the radio module 5140, and other units) may be integrated together in a single device or module, such as a system-on-chip module.

FIG. 51B is a component block diagram of an example robotic vehicle controller 150 suitable for use with various embodiments. With reference to FIGS. 1-51B, a robotic vehicle controller 150 may include a first SOC 202 (such as a SOC-CPU) coupled to a second SOC 204 (such as a 5G capable SOC). The first and second SOCs 202, 204 may be coupled to a radio module 5160 configured for communicating with a robotic vehicle, such as a UAV 152, internal electronic storage (i.e. memory) 5162, a display 5164, and input devices, such as buttons or control knobs 5166. Additionally, the robotic vehicle controller 150 may include antennas 5168 coupled to the radio module 5160 for establishing a wireless data and control link with a robotic vehicle, such as a UAV 152.

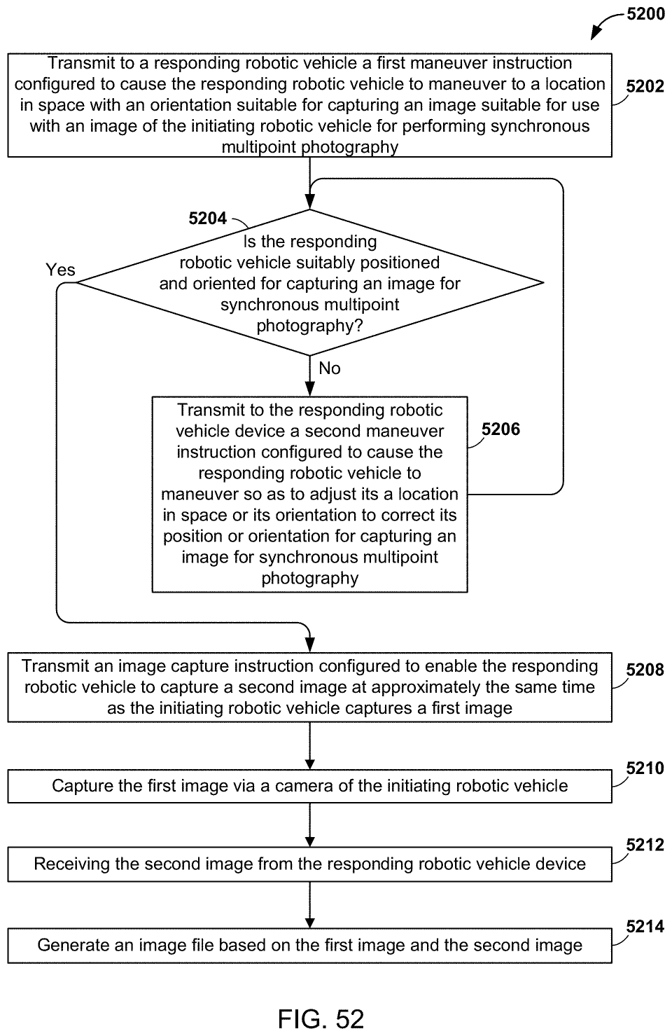

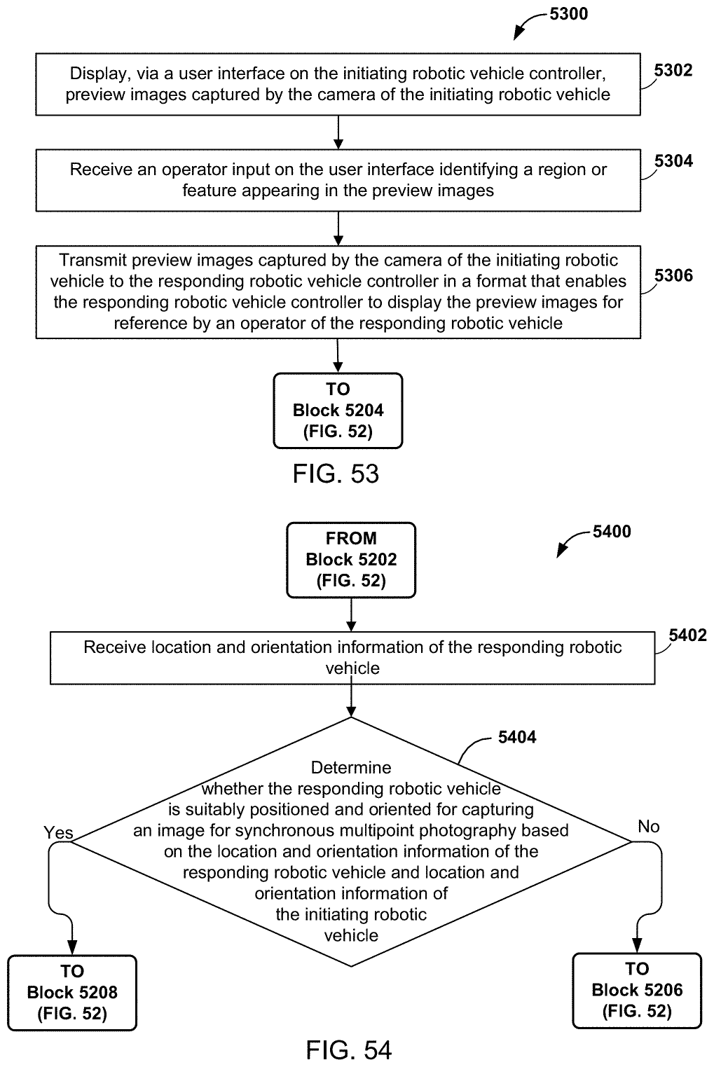

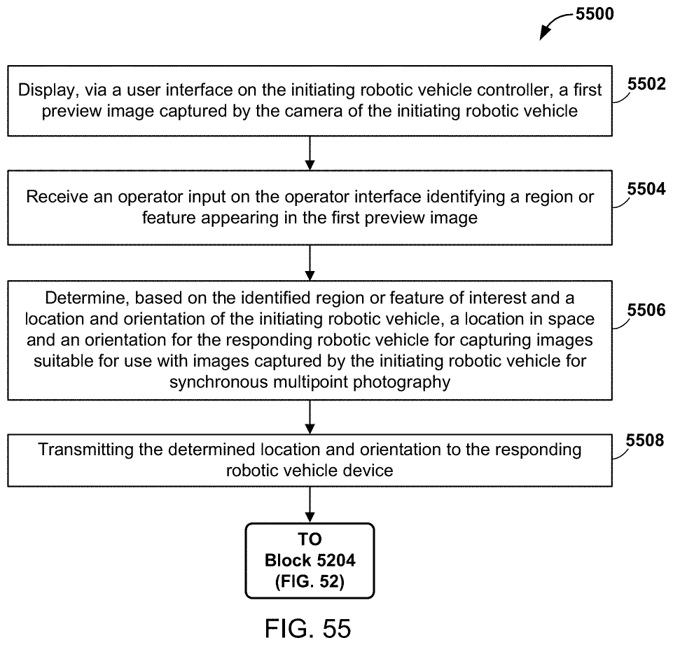

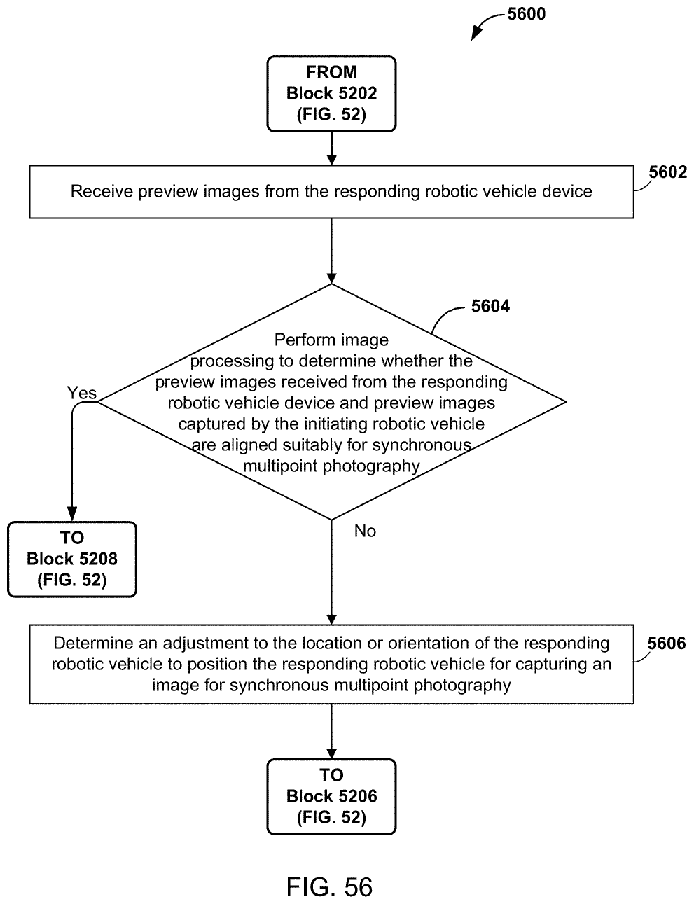

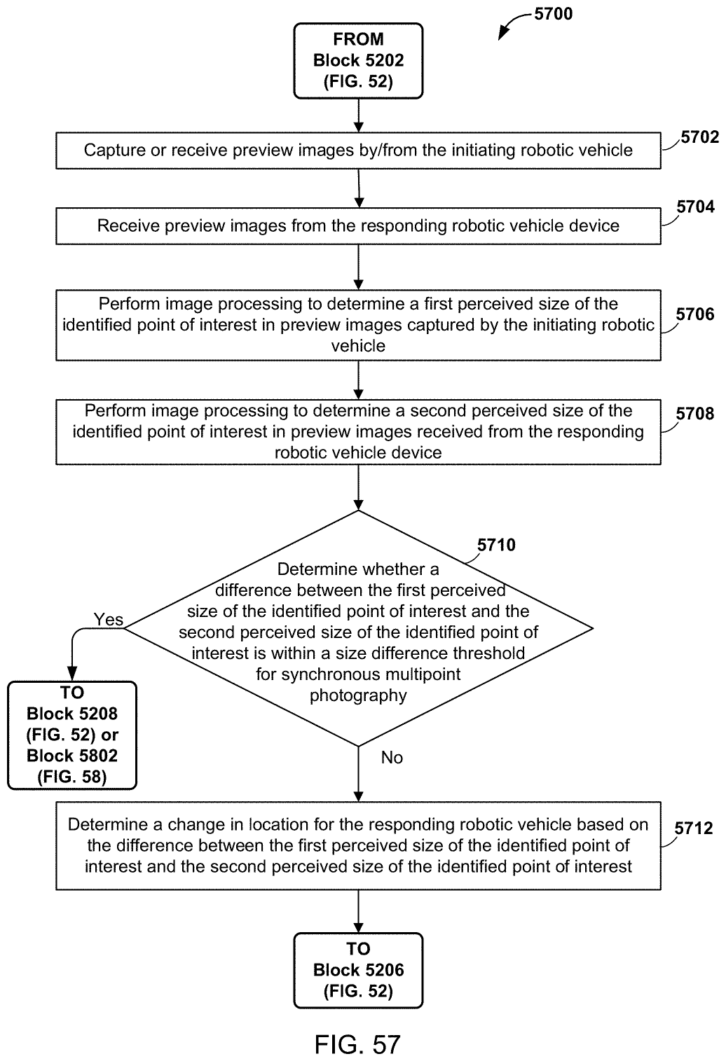

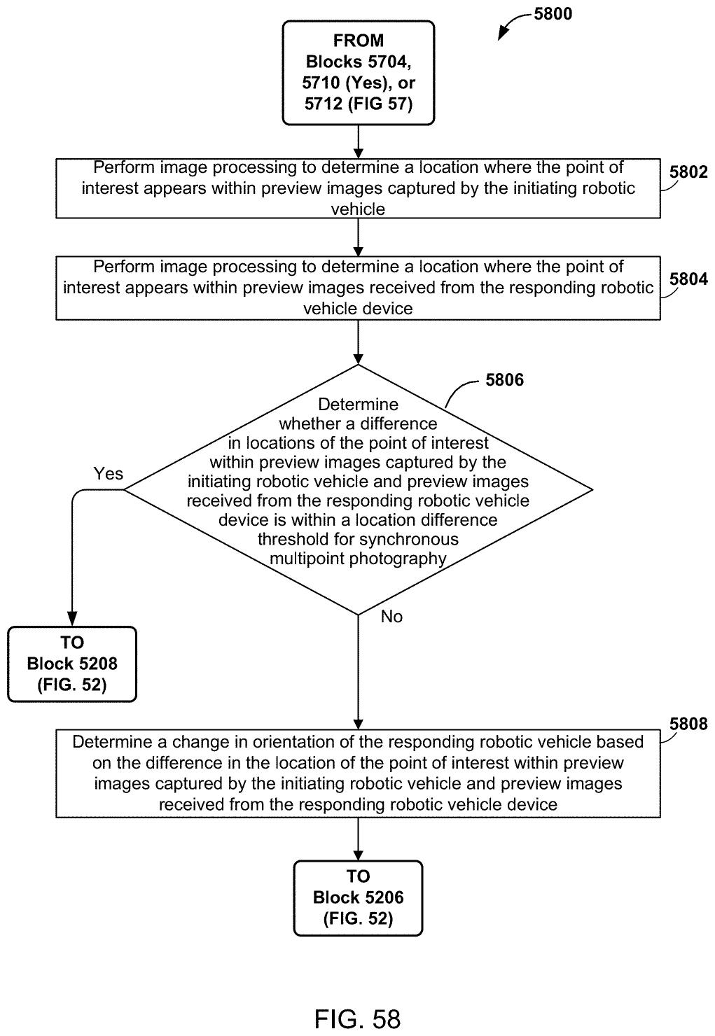

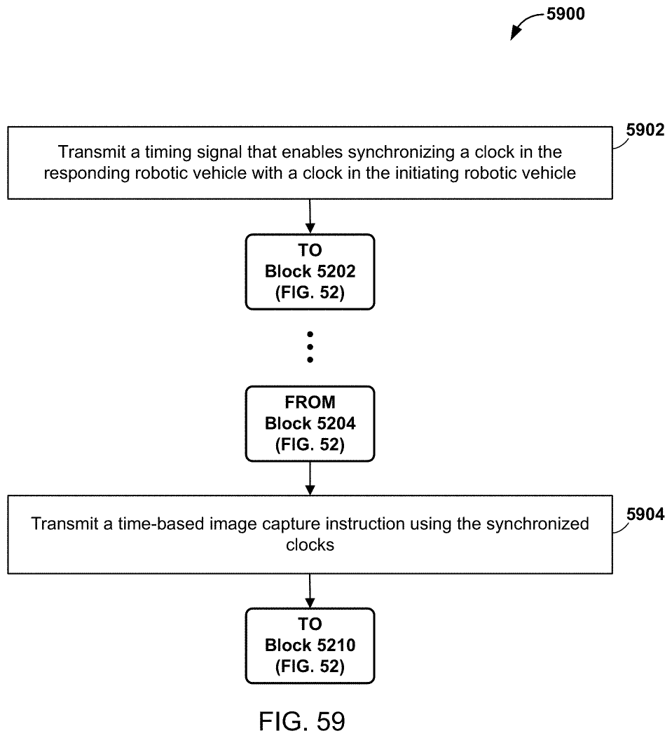

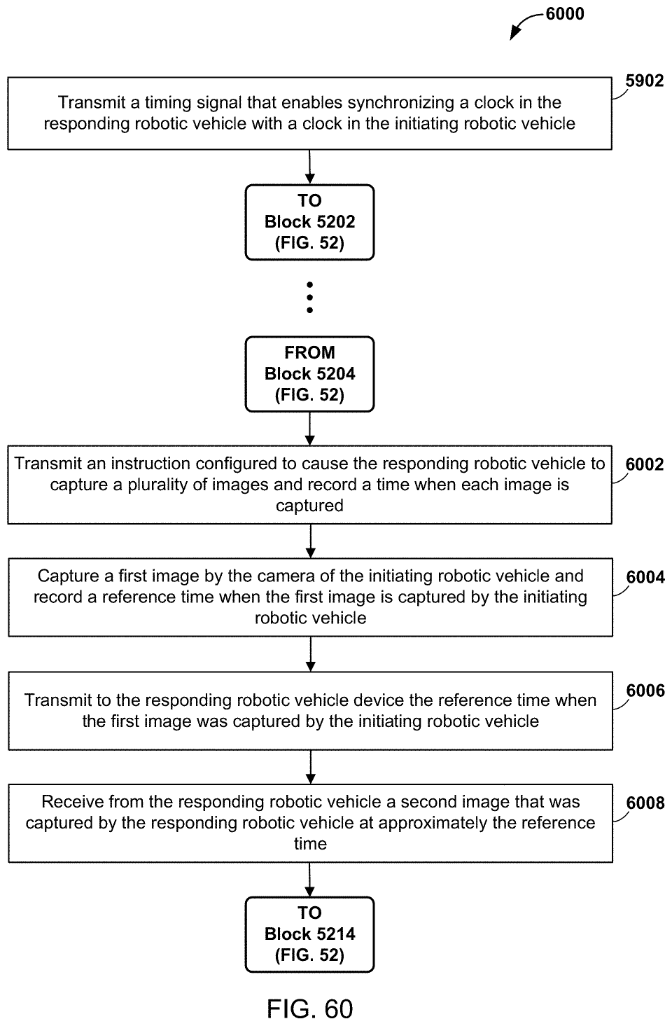

FIG. 52 is a process flow diagram illustrating a method 5200 that may be implemented in an initiating robotic vehicle device (i.e., an initiating robotic vehicle or an initiating robotic vehicle controller) to perform synchronous multi-viewpoint photography according to some embodiments. With reference to FIGS. 1A-52, the operations 5200 of the method 5200 may be performed by a processor (e.g., 202, 204, 5120) of a robotic vehicle (e.g., 152) and/or a robotic vehicle controller (e.g., 150).

The order of operations performed in blocks 5202-5214 is merely illustrative, and the operations may be performed in any order and partially simultaneously in some embodiments. In some embodiments, the method 5200 may be implemented as a software module executing within a processor of an SoC or SIP (e.g., 202, 204), or in dedicated hardware within an SoC that is configured to take actions and store data as described. For ease of reference, the various elements performing the operations of the method 5200 are referred to in the following method descriptions as a “processor.”

In block 5202, the processor may transmit to a responding robotic vehicle device (i.e., a responding robotic vehicle or responding robotic vehicle controller) a first maneuver instruction configured to cause the responding robotic vehicle to maneuver to a location (including altitude for maneuvering a UAV) with an orientation suitable for capturing an image suitable for use with an image captured by the initiating robotic vehicle for performing synchronous multi-viewpoint photography. In some embodiments, the first maneuver instruction may include geographic coordinates, such as latitude and longitude, as well as altitude for UAV robotic vehicles, for the location (including altitude for maneuvering a UAV) where the responding robotic vehicle should capture the photograph. Further, the first maneuver instructions may specify a pointing angle for directing camera capturing an image, such as a compass direction and inclination or declination angle with respect to the horizon along a line perpendicular to the compass direction for aiming the camera. In some situations, the maneuver instructions may also include a tilt angle for the camera about the compass direction. Thus, in some embodiments, the first maneuver instruction may include coordinates for positioning the robotic vehicle and directing the camera for capturing a simultaneous photography image. The coordinates may be specified in 6-degrees of freedom (e.g., latitude and longitude, as well as altitude for UAV robotic vehicles, and pitch, roll, and yaw (or slew) for the camera).

In some embodiments, the processor transmitting the first maneuver instruction may be within an initiating robotic vehicle controller controlling the initiating robotic vehicle (i.e., the initiating robotic vehicle device is an initiating robotic vehicle controller), and the first maneuver instruction may be transmitted to a responding robotic vehicle controller controlling the responding robotic vehicle. In some embodiments, the first maneuver instruction may be configured to enable the responding robotic vehicle controller to display information that enables an operator of the responding robotic vehicle to maneuver the responding robotic vehicle via inputs to the robotic vehicle controller to the location and orientation suitable for capturing an image for simultaneous multi-viewpoint photography. In some embodiments, the processor may determine the coordinates for the first maneuver instruction based upon inputs received from an operator, such as making indications on a display of locations where each of the responding robotic vehicles should be positioned for performing simultaneous multi-viewpoint photography.

In some embodiments, some embodiments, the processor may be within the initiating robotic vehicle (i.e., the initiating robotic vehicle device is an initiating robotic vehicle), and the processor may determine the first maneuver instruction based on own position (e.g. determine from GNSS signals) and camera orientation information while focused on a point of interest, and transmit the first maneuver instructions directly to the responding robotic vehicle via robotic vehicle-to-robotic vehicle wireless communication links.

In determination block 5204, the processor may determine whether the responding robotic vehicle is suitably positioned and oriented for capturing an image for simultaneous multi-viewpoint photography. In some embodiments, this determination may be made based upon information received from the responding robotic vehicle or the responding robotic vehicle controller. For example, as explained in more detail herein, the initiating robotic vehicle device (i.e., initiating robotic vehicle or initiating robotic vehicle controller) may receive position and orientation information from the responding robotic vehicle (e.g., directly or via the responding robotic vehicle controller) and compare that information to the instructed position and orientation for the responding robotic vehicle. As another example, the initiating robotic vehicle device (i.e., initiating robotic vehicle or initiating robotic vehicle controller) may receive preview images from the responding robotic vehicle (e.g., directly or via the responding robotic vehicle controller) and make the determination based upon image analysis.

In response to determining that the responding robotic vehicle is not suitably positioned and oriented (i.e., determination block 5204=“No”), the processor may transmit to the responding robotic vehicle device (i.e., responding robotic vehicle or responding robotic vehicle controller) a second maneuver instruction configured to cause the responding robotic vehicle to maneuver so as to adjust its a location (including altitude for maneuvering a UAV) and/or its orientation (including camera orientation) to correct its position and/or orientation for capturing an image for synchronous multi-viewpoint photography. For example, if the processor determines that a responding UAV robotic vehicle is not in a proper position in 3D space, the processor may transmit a second maneuver instruction that identifies either a correction maneuver (e.g., a distance to travel in a particular direction, or a distance to move in each of three dimensions) or correction in geographic position and/or altitude. As another example, if the processor determines that the responding robotic vehicle camera is not properly directed at the point of interest, the processor may transmit a second maneuver instruction that identifies changes in pitch, roll and/or yaw (or slew) angles for the camera. The processor may then repeat the operations of determination block 5204 to determine whether the responding robotic vehicle and its camera are suitably positioned or oriented after execution of the second maneuver instructions.

In embodiments in which the processor is within the initiating robotic vehicle controller (i.e., the initiating robotic vehicle device is an initiating robotic vehicle controller), the second maneuver instruction or instructions may be configured to enable the responding robotic vehicle controller to display information that enables an operator of the responding robotic vehicle to determine how to adjust the position and/or orientation of the responding robotic vehicle via inputs to the robotic vehicle controller to achieve the location and orientation suitable for capturing an image for simultaneous multi-viewpoint photography.

In response to determining that the responding robotic vehicle is suitably positioned and oriented (i.e., determination block 5204=“Yes”), the processor may transmit to the responding robotic vehicle (e.g., directly or via the responding robotic vehicle controller) an image capture instruction or instructions in block 5208, in which the instructions are configured to enable the responding robotic vehicle to capture a second image at approximately the same time as the initiating robotic vehicle will capture a first image. Alternative ways of configuring the image capture instruction or instructions are described below.

In block 5210, the processor may capture a first image via a camera that is on the initiating robotic vehicle. In some embodiments, the processor may be within a robotic vehicle controller (i.e., the initiating robotic vehicle device is an initiating robotic vehicle controller), in which case the operations in block 5210 may involve receiving a user input to capture the image and transmitting an image capture instruction to the initiating robotic vehicle via a wireless communication link. In some embodiments, the processor may be within the initiating robotic vehicle (i.e., the initiating robotic vehicle device is an initiating robotic vehicle), and the processor may automatically capture an image or images of the point of interest in response to determining that all participating responding robotic vehicles are properly positioned and oriented for the simultaneous photography.

In block 5212, the processor may receive the second image captured by the responding robotic vehicle, such as via a wireless communication link. In some embodiments, the second image may be received from the responding robotic vehicle (e.g., directly or via the responding robotic vehicle controller) following transmission of the image capture instruction in block 5208. In some embodiments, as described in more detail below, the initiating robotic vehicle device processor may transmit further information to the responding robotic vehicle and received the second image in response to such instructions.

In block 5214, a processor may generate an image file based on the first image captured by the initiating robotic vehicle and the second image captured by the responding robotic vehicle. In some embodiments, this generation of the image file may be performed by a processor of the initiating robotic vehicle controller, which may include presenting a composite image (e.g., 3D image) on a display of the robotic vehicle controller. In some embodiments, the first image and the second image may be provided to a wireless device (which may also capture one of the images) for processing. In some embodiments, the first image and the second image may be transmitted to a remote computing device, such as a server via a wireless communication network, and the server may combine the images into an image file, such as simultaneous multi-viewpoint photography images or image sequences as described herein.

FIG. 53 is a process flow diagram illustrating alternative operations 5300 that may be performed by a processor (e.g., 202, 204) of an initiating robotic vehicle controller (e.g., 150) (i.e., the initiating robotic vehicle device is an initiating robotic vehicle controller) as part of the method 5200 for determining where to position the responding robotic vehicle based on operator input according to some embodiments. With reference to FIGS. 1A-53, the operations 5300 may be performed by a processor (e.g., 202, 204) of a robotic vehicle controller (e.g., 150) controlling the initiating robotic vehicle (e.g., 152).

Referring to FIG. 53, in block 5302, the processor may perform operations including displaying on a user interface of the initiating robotic vehicle controller preview images captured by the camera of the initiating robotic vehicle. For example, the initiating robotic vehicle camera may be activated to capture a stream of preview images and transmit a video stream to the initiating robotic vehicle controller where the images are presented on a user interface display (e.g., 5154).

In block 5304, the initiating robotic vehicle controller may receive an operator input on the user interface identifying a region or feature appearing in the preview images to be treated as the point of interest for synchronous multi-viewpoint photography. In some embodiments, the user interface of the robotic vehicle controller may be touch sensitive, and the user input may involve detected touches or swipes of the operator's finger (or a stylus) on the user interface display on or encircling an image feature appearing on the display. In some embodiments, the operator input may be received via one or more mechanical input devices, such as a joystick, control knob or button, and the user interface may include moving a cursor or tracing a path on the display using the input device(s). In some embodiments, the operator may maneuver the initiating robotic vehicle in a conventional manner (e.g., inputting maneuver controls via a joystick) until the point of interest for synchronous multi-viewpoint photography is centered in the display, and then press a button, which the processor may interpret as indicating that features centered in the display are intended to be the point of interest.

In some embodiments, the initiating robotic vehicle controller may transmit commands to the initiating robotic vehicle to maintain position and camera orientation so that the point of interest remains centered in the field of view of the camera. Various known methods form maintaining a robotic vehicle in a given position and orientation may be used to accomplish such functionality. For example, a UAV robotic vehicle may have a flight control system that uses information from accelerometers and gyroscopes to roughly maintain current position and use image processing of preview images to determine maneuvers necessary to continue to hold the indicated point of interest at or near the center of the field of view of the camera. So positioned, the initiating robotic vehicle may thus be ready to capture images for multi-viewpoint photography as soon as the responding robotic vehicle is suitably positioned and oriented to also capture images.

In block 5306, the processor may perform operations including transmitting preview images captured by the camera of the initiating robotic vehicle to the responding robotic vehicle controller (i.e., the controller controlling the responding robotic vehicle). Such preview images may be transmitted in a format that enables the responding robotic vehicle controller to display the preview images for reference by an operator of the responding robotic vehicle. Presenting the operator with images of the point of interest may enable the operator to maneuver the responding robotic vehicle to appropriate position for capturing images useful in synchronous multi-viewpoint photography. Thus, in addition to (or in replace of) receiving a first maneuver instruction from the initiating robotic vehicle controller instructing how to maneuver the responding robotic vehicle to a location (including altitude for maneuvering a UAV) and orientation of the camera, the operator of the responding robotic vehicle may be shown the point of interest from the perspective of the initiating robotic vehicle, which may enable the operator to direct the responding robotic vehicle to another location for imaging the same point of interest.

The processor of the initiating robotic vehicle controller may then perform the operations of the method 5200 beginning with block 5204 as described.

FIG. 5400 is a process flow diagram illustrating alternative operations 5400 that may be performed by a processor (e.g., 202, 204) of an initiating robotic vehicle controller (e.g., 150) (i.e., the initiating robotic vehicle device is an initiating robotic vehicle controller) as part of the method 5200 according to some embodiments. With reference to FIGS. 1A-54, the operations 5400 may be performed by a processor (e.g., 202, 204, 5120) of a robotic vehicle (e.g., 152) and/or a robotic vehicle controller (e.g., 150).

After transmitting the first maneuver instruction to the responding robotic vehicle in block 5202 of the method 5200, the processor may receive location and orientation information from the responding robotic vehicle (e.g., directly or via the responding robotic vehicle controller) in block 5402. In some embodiments, this may be in the form of geographic coordinates, such as latitude, longitude and altitude as may be determined by a GNSS receiver. In some embodiments, camera orientation information may be in the form of angular measurements, such as pitch, roll and yaw (or slew) angles or rotations, with respect to a reference frame, such as North and the gravity gradient or the horizon. Thus, in this embodiment, the responding robotic vehicle device (i.e., a responding robotic vehicle or responding robotic vehicle controller) informs the initiating robotic vehicle device (i.e., initiating robotic vehicle or initiating robotic vehicle controller) of the location (including altitude for maneuvering a UAV) and orientation of the camera of the responding robotic vehicle after it has maneuvered to the location and orientation indicated in the first maneuver instruction.

In determination block 5404, the processor may determine whether the responding robotic vehicle is suitably positioned and oriented for capturing an image for synchronous multi-viewpoint photography based on the received location and orientation information of the responding robotic vehicle device (i.e., a responding robotic vehicle or responding robotic vehicle controller). This may involve comparing the received location and orientation information to the location and orientation information that was included in the first maneuver instruction transmitted in block 5202 of the method 5200.

In some embodiments, the processor may determine whether the difference between the received location and orientation information in the instructed location and orientation information is within a respective tolerance or threshold difference. In other words, the processor may determine whether the responding robotic vehicle is close enough to the instructed location and orientation so that suitable images for simultaneous multi-viewpoint photography can be obtained by the responding robotic vehicle. For example, image processing involved in generating multi-viewpoint photography may account for small differences in altitude and pointing orientation of the camera. Also, slight differences in the location but at the correct altitude may provide a slightly different perspective of the point of interest but still be quite usable for multi-viewpoint synchronous photography. However, if the responding robotic vehicle is too far removed from the indicated location and/or the camera is not oriented properly towards the point of interest, any images captured may not be usable for the desired that synchronous multi-viewpoint photography. The acceptable tolerance or difference threshold may vary for each of the three location coordinates (i.e., latitude, longitude, and altitude) and each of the rotational coordinates (e.g., pitch, roll, yaw or slew). Therefore, in determination block 5404, the processor may compare each of the location and orientation coordinates received from the responding robotic vehicle device (i.e., a responding robotic vehicle or responding robotic vehicle controller) to a corresponding difference threshold in determining whether the responding robotic vehicle is suitably positioned for synchronous multi-viewpoint photography.

In response to determining that the responding robotic vehicle is not suitably positioned and oriented for capturing images for synchronous multi-viewpoint photography (i.e., determination block 5404=“No”), the processor may perform the operations in block 5206 of the method 5200 to transmit a second maneuver instruction to the responding robotic vehicle device (i.e., a responding robotic vehicle or responding robotic vehicle controller) as described.

In response to determining that the responding robotic vehicle is suitably positioned and oriented for capturing images for synchronous multi-viewpoint photography (i.e., determination block 5404=“Yes”), the processor may perform the operations in block 5208 of the method 5200 to transmit the image capture instruction to the responding robotic vehicle device (i.e., a responding robotic vehicle or responding robotic vehicle controller) as described.

FIG. 55 is a process flow diagram illustrating alternative operations 5500 that may be performed by a processor (e.g., 202, 204) of an initiating robotic vehicle controller (e.g., 150) (i.e., the initiating robotic vehicle device is an initiating robotic vehicle controller) as part of the method 5200 for determining where to position the responding robotic vehicle based on operator input according to some embodiments. With reference to FIGS. 1A-53, the operations 5500 may be performed by a processor (e.g., 202, 204) of a robotic vehicle controller (e.g., 150) controlling the initiating robotic vehicle (e.g., 152).

Referring to FIG. 55, in block 5502, the processor may perform operations including displaying on a user interface of the initiating robotic vehicle controller preview images captured by the camera of the initiating robotic vehicle. For example, the initiating robotic vehicle camera may be activated to capture a stream of preview images and transmit a video stream to the initiating robotic vehicle controller where the images are presented on a user interface display (e.g., 5154).

In block 5504, the initiating robotic vehicle controller may receive an operator input on the user interface identifying a region or feature appearing in the preview images to be treated as the point of interest for synchronous multi-viewpoint photography. As described with reference to FIG. 53, in some embodiments, the user interface of the robotic vehicle controller may be touch sensitive, and the user input may involve detected touches or swipes of the operator's finger (or a stylus) on the user interface display on or encircling an image feature appearing on the display. In some embodiments, the operator input may be received via one or more mechanical input devices, such as a joystick, control knob or button, and the user interface may include moving a cursor or tracing a path on the display using the input device(s). In some embodiments, the operator may maneuver the initiating robotic vehicle in a conventional manner (e.g., inputting maneuver controls via a joystick) until the point of interest for synchronous multi-viewpoint photography is centered in the display, and then press a button, which the processor may interpret as indicating that features centered in the display are intended to be the point of interest.

In some embodiments, the initiating robotic vehicle device (i.e., initiating robotic vehicle or the initiating robotic vehicle controller) may determine and implement maneuvers to maintain position and camera orientation so that the point of interest remains centered in the field of view of the camera. Various known methods for maintaining a robotic vehicle in a given position and orientation may be used to accomplish such functionality. For example, a UAV robotic vehicle may have a flight control system that uses information from accelerometers and gyroscopes and geographic coordinates (e.g., latitude, longitude and altitude) obtained from a GNSS receiver to roughly maintain current position, and use image processing of preview images to determine maneuvers necessary to continue to hold the indicated point of interest at or near the center of the field of view of the camera.

In block 5506, the processor may perform operations including using the identified region or feature of interest and the location and orientation of the initiating robotic vehicle camera to determine the location (including altitude for maneuvering a UAV) and the orientation suitable for the responding robotic vehicle for capturing images suitable for use with images captured by the initiating robotic vehicle for synchronous multi-viewpoint photography. In some embodiments, the processor may use image processing of the preview images containing the point of interest and perform geometric transforms of the initiating robotic vehicle's location and orientation information to determine a suitable location and orientation for the responding robotic vehicle. For example, to capture 360° views of the point of interest, the processor may determine a distance of the initiating robotic vehicle from the point of interest, determine a location that would be the same distance from the point of interest but at a point 120 degrees around the point of interest from the initiating robotic vehicle position, and determine the coordinates (e.g., latitude and longitude) of that point. As another example, to capture a panorama of a scene, the processor may use coordinate transformation techniques to determine a position that is a similar distance from the point of interest and removed from the position of the initiating robotic vehicle sufficient so that the field of view of the initiating robotic vehicle camera and the responding robotic vehicle camera just overlap sufficient to enable a computing device to join images captured by the two cameras into a continuous panorama image. Other mechanisms for determining the appropriate location for the responding robotic vehicle may also be implemented by the processor.

In block 5508, the processor may transmit the determined location and orientation to the responding robotic vehicle device (i.e., responding robotic vehicle or responding robotic vehicle controller) in a first maneuver instruction similar to the operations in block 5202 as described.

The processor of the initiating robotic vehicle controller may then perform the operations of the method 5200 beginning with block 5204 as described.

FIG. 56 is a process flow diagram illustrating alternative operations 5600 that may be performed by a processor (e.g., 202, 204, 5120) of an initiating robotic vehicle device (i.e., initiating robotic vehicle (e.g., 152) and/or initiating robotic vehicle controller (e.g., 150)) as part of the method 5200 for determining how to redirect the responding robotic vehicle to achieve a proper position for synchronous multi-viewpoint photography according to some embodiments.

With reference to FIGS. 1A-56, following performance of operations in block 5604 of the method 5200 (FIG. 52), the processor may perform operations in block 5602 including receiving preview images from the responding robotic vehicle (e.g., directly or via the responding robotic vehicle controller). Thus, in this embodiment, the responding robotic vehicle may begin capturing preview images upon maneuvering to a location indicated in the first maneuver instruction transmitted by the initiating robotic vehicle device in block 5202 of the method 5200, and transmitting a stream of images or a video stream to either the initiating robotic vehicle device (i.e., initiating robotic vehicle or initiating robotic vehicle controller).

In determination block 5604, the processor may perform image processing to determine whether the preview images received from the responding robotic vehicle and preview images captured by the initiating robotic vehicle are aligned suitably for synchronous multi-viewpoint photography. For example, the processor may do image processing of the preview images to determine whether the point of interest previously identified by an operator of the initiating robotic vehicle is aligned in the two streams of preview images. To accomplish this, the processor may use image processing to determine whether key features of the point of interest, such as a top surface or angular surfaces are present in similar locations in the preview images. Also, the processor may use image processing to determine whether the point of interest as a similar size in the two streams of preview images.

In doing the comparison in determination block 5604, the processor may determine whether any misalignment of the point of interest between the two streams of preview images is within tolerance or a threshold difference that can be accommodated by image processing performed in synchronous multi-viewpoint photography. For example, if the point of interest appears in both streams of preview images but slightly off-center in one, processing of images captured by the two robotic vehicles may still be joined together into a simultaneous multi-viewpoint photograph by image processing that focuses on the point of interest.

In response to determining that the preview images received from the responding robotic vehicle and preview images captured by the initiating robotic vehicle are not aligned suitably for synchronous multi-viewpoint photography (i.e., determination block 5604=“No”), the processor may determine an adjustment to the location or orientation of the responding robotic vehicle to better position the responding robotic vehicle for capturing an image for synchronous multi-viewpoint photography in block 5606, and then perform the operations in block 5206 of the method 5200 to transmit the second maneuver instruction for accomplishing the determined adjustment to the responding robotic vehicle device as described.

In response to determining that the preview images received from the responding robotic vehicle and preview images captured by the initiating robotic vehicle are aligned suitably for synchronous multi-viewpoint photography the preview images received from the responding robotic vehicle and preview images captured by the initiating robotic vehicle are aligned suitably for synchronous multi-viewpoint photography (i.e., determination block 5604=“Yes”), the processor may perform the operations in block 5208 of the method 5200 to transmit the image capture instruction to the responding robotic vehicle device as described.

FIG. 57 is a process flow diagram illustrating alternative operations 5700 that may be performed by a processor (e.g., 202, 204, 5120) of an initiating robotic vehicle device (i.e., an initiating robotic vehicle (e.g., 152) and/or an initiating robotic vehicle controller (e.g., 150)) as part of the method 5200 for determining how to redirect the responding robotic vehicle to achieve a proper position for synchronous multi-viewpoint photography according to some embodiments.

With reference to FIGS. 1A-57, following performance of operations in block 5202 of the method 5200 (FIG. 52), the processor may perform operations in block 5702 including obtaining preview images captured by the initiating robotic vehicle. In embodiments in which the processor performing the operations 5700 is within the initiating robotic vehicle (i.e., the initiating robotic vehicle device is an initiating robotic vehicle), the operations in block 5702 may include capturing the preview images. In embodiments in which the processor performing the operations 5700 is within the initiating robotic vehicle controller (i.e., the initiate robotic vehicle device is an initiating robotic vehicle controller), the operations in block 5702 may include the robotic vehicle controller sending commands to the initiating robotic vehicle to capture preview images and receiving the preview images from the initiating robotic vehicle device (i.e., a responding robotic vehicle or responding robotic vehicle controller).

In block 5704, the processor may perform operations including receiving preview images from the responding robotic vehicle device (i.e., responding robotic vehicle or responding robotic vehicle controller). Thus, in this embodiment, the responding robotic vehicle may begin capturing preview images upon maneuvering to a location indicated in the first maneuver instruction transmitted by the initiating robotic vehicle device in block 5202 of the method 5200, and transmitting a stream of images or a video stream to the initiating robotic vehicle device (i.e., either the initiating robotic vehicle or the initiating robotic vehicle controller).

In block 5706, the processor may perform image processing to determine a first perceived size of the identified point of interest appearing in preview images captured by the initiating robotic vehicle. For example, the image processing may identify the area or outline encompassing the identified point of interest and estimate a fraction of the field of view occupied by the area or outline of the point of interest, such as in terms of an area ratio of square pixels. As another example, the image processing may measure a dimension of the identified point of interest (e.g., a width or height of at least a portion of the point of interest) and determine a ratio of that measured dimension to the width or height of the field of view of the preview images, such is in terms of a length ratio of pixel values.

In block 5708, the processor may perform similar image processing to determine a second perceived size of the identified point of interest appearing in preview images received from the responding robotic vehicle device (i.e., responding robotic vehicle or responding robotic vehicle controller). For example, similar to the example operations in block 5706, the processor may perform image processing to determine an area ratio or a length ratio of the point of interest appearing in the preview images captured by the responding robotic vehicle.

In determination block 5710, the processor may determine whether a difference between the first perceived size of the identified point of interest in the second perceived size of the identified point of interest is within a size difference threshold or tolerance for synchronous multi-viewpoint photography. If the initiating robotic vehicle and responding robotic vehicle are at similar distances from the point of interest, then the size of the point of interest within the field of view of both robotic vehicle cameras will be similar Multi-viewpoint photography processing may be able to accommodate slight differences in perceived size within some tolerance range through simple image transformation operations. However, if the size of the point of interest difference between the preview images of the initiating robotic vehicle and the responding robotic vehicle is too great, the size difference may result in low quality multi-viewpoint photography. Thus, the determination made in determination block 5710 is whether the responding robotic vehicle is positioned at a distance from the point of interest that is similar enough to the initiating robotic vehicle that any difference in apparent size can be accommodated through multi-viewpoint photography image processing.

In response to determining that the difference between the first perceived size of the identified point of interest in the second perceived size of the identified point of interest is not within a size difference threshold for synchronous multi-viewpoint photography, such as the responding robotic vehicle is too close to or too far from the point of interest compared to the initiating robotic vehicle (i.e., determination block 5710=“No”), the processor may determine an adjustment to the location of the responding robotic vehicle to better position the responding robotic vehicle for capturing an image for synchronous multi-viewpoint photography. For example, if the second perceived size of the identified point of interest is smaller than the perceived size of the point of interest in the field of view of the initiating robotic vehicle by more than the threshold difference, the processor may determine a maneuver instruction that will cause the responding robotic vehicle to move closer to the point of interest. Similarly, if the second perceived size of the identified point of interest is larger than the perceived size of the point of interest in the field of view of the initiating robotic vehicle by more than the threshold difference, the processor may determine a second maneuver instruction that will cause the responding robotic vehicle to move away from the point of interest. The processor then may perform the operations in block 5206 of the method 5200 to transmit the second maneuver instruction to the responding robotic vehicle as described.

In response to determining that the difference between the first perceived size of the identified point of interest in the second perceived size of the identified point of interest is within a size difference threshold or tolerance for synchronous multi-viewpoint photography (i.e., determination block 5710 =“Yes”), the processor may perform the operations in block 5208 of the method 5200 to transmit the image capture instruction to the responding robotic vehicle device (i.e., responding robotic vehicle or responding robotic vehicle controller) as described. Alternatively, the processor may perform operations 5800 illustrated in FIG. 58 beginning with block 5802 as described next.

FIG. 58 is a process flow diagram illustrating alternative operations 5800 that may be performed by a processor (e.g., 202, 204, 5120) of an initiating robotic vehicle device (i.e., a robotic vehicle (e.g., 152) and/or a robotic vehicle controller (e.g., 150)) as part of the method 5200, such as following or preceding the operations 5700 (FIG. 57) for determining how to redirect the responding robotic vehicle device (i.e., responding robotic vehicle or responding robotic vehicle controller) to achieve a proper orientation of the responding robotic vehicle or the responding robotic vehicle camera for synchronous multi-viewpoint photography according to some embodiments.

FIG. 58 illustrates an embodiment in which the operations 5800 are performed after the operations 5700 to determine whether an adjustment is required to the position of the responding robotic vehicle with respect to the point of interest. However, this is just one example of how the operations may be performed. In some embodiments, the operations 5800 may be performed independent of the operations 5700 to adjust the orientation of the camera after preview images received from the initiating robotic vehicle and responding robotic vehicle in blocks 5702 and 5704. In some embodiments, the operations 5800 may be performed before the operations in blocks 5706-5712 to adjust the orientation of the camera before the processor determines whether an adjustment is required to the position of the responding robotic vehicle with respect to the point of interest.

With reference to FIGS. 1A-58, following performance of operations in block 5704 or block 5712 of the method 5700, or in response to determining in determination block 5710 that the difference between the first perceived size of the identified point of interest in the second perceived size of the identified point of interest is within a size difference threshold or tolerance for synchronous multi-viewpoint photography (i.e., determination block 5710=“Yes”), the processor may perform image processing to determine a location where the point of interest appears within in preview images captured by the initiating robotic vehicle in block 5802. For example, the image processing may identify the area or outline encompassing the identified point of interest, determine a center point of that area, and determine a location within the field of view of perceived images where that center point is positioned. As another example, the image processing may identify a particular recognizable element on the identified point of interest (e.g., a corner, bottom, top, etc.) and determine a location within the field of view of perceived images where that particular recognizable element is positioned.

In block 5804, the processor may perform similar image processing to determine a location where the point of interest appears within in preview images received from the responding robotic vehicle device (i.e., responding robotic vehicle or responding robotic vehicle controller). For example, similar to the example operations in block 5802, the processor may perform image processing to identify where a center point or the same particular recognizable element on the point of interest appears in the preview images captured by the responding robotic vehicle.

In determination block 5806, the processor may determine whether a difference between in the location of the point of interest within preview images captured by the initiating robotic vehicle and preview images received from the responding robotic vehicle device is within a location difference threshold (or tolerance) for synchronous multi-viewpoint photography. For example, if cameras on the initiating robotic vehicle and responding robotic vehicle are pointed at the point of interest, but the point of interest is slightly offset from the center of the point of view in one of the preview images, multi-viewpoint photography processing may be able to accommodate such differences through simple image cropping, translation, or transformation operations. However, if the location of the point of interest in the to field of view differ significantly, such as part of the point of interest falls outside of the field of view of the camera on the responding robotic vehicle, satisfactory multi-viewpoint photographic processing may not be feasible. Thus, the determination made in determination block 5710 may be whether the camera of the responding robotic vehicle is pointing at the point of interest similar enough to the camera of the initiating robotic vehicle such that that any difference in the position of the point of interest within the image field of view can be accommodated through multi-viewpoint photography image processing.

In response to determining that the difference between in the location of the point of interest within preview images captured by the initiating robotic vehicle and preview images received from the responding robotic vehicle device is not within a location difference threshold (i.e., determination block 5704 =“No”), the processor may determine an adjustment to the orientation of the camera of the responding robotic vehicle to better orient the camera of the responding robotic vehicle for capturing an image for synchronous multi-viewpoint photography in block 5808. For example, processor may determine how the camera and/or the responding robotic vehicle should be turned through any of the three angles of orientation (e.g., pitch, roll, yaw or slew) so that the point of interest will appear in the field of view of the camera of the responding robotic vehicle at a position the same as or close to that of preview images captured by the initiating robotic vehicle.

The processor then may perform the operations in block 5206 of the method 5200 to transmit the second maneuver instruction including the location and/or orientation adjustment to the responding robotic vehicle device as described. In some embodiments, this transmission of the second maneuver instruction for adjusting the camera orientation may be performed before or after transmission of the second maneuver instruction for adjusting the position of the responding robotic vehicle with respect to the point of interest as determined in block 5712 as described. In some embodiments, the second maneuver instruction may include maneuver instructions for adjusting both the position of the responding robotic vehicle with respect to the point of interest as determined in block 5712 and the camera orientation as determined in block 5808.

In response to determining that the difference between in the location of the point of interest within preview images captured by the initiating robotic vehicle and preview images received from the responding robotic vehicle device is within a location difference threshold (i.e., determination block 5604=“Yes”), the processor may perform the operations in block 5208 of the method 5200 to transmit the image capture instruction to the responding robotic vehicle device (i.e., responding robotic vehicle or responding robotic vehicle controller) as described. Alternatively, in some embodiments the processor may continue with operations 5700 (FIG. 58) beginning with block 5706 as described.

FIG. 59 is a process flow diagram illustrating alternative operations 5900 that may be performed by a processor (e.g., 202, 204, 5120) of an initiating robotic vehicle device (i.e., a robotic vehicle (e.g., 152) and/or an initiating robotic vehicle controller (e.g., 150)) as part of the method 5200 for synchronizing the capture of images by the initiating robotic vehicle and the responding robotic vehicle according to some embodiments.

With reference to FIGS. 1A-59, in block 5902, the processor may perform operations including transmitting a timing signal that enables synchronizing a clock in the responding robotic vehicle device (i.e., responding robotic vehicle or responding robotic vehicle controller) with a clock in the initiating robotic vehicle. In some embodiments, the operations in block 5902 involve signaling that enables an internal clock of the responding robotic vehicle to be synchronized with an internal clock of the initiating robotic vehicle. In some embodiments, the operations in block 5902 involve indicating that a GNSS time signal should be used as the clock for determining when to capture images as two robotic vehicles in relatively close proximity should receive the same GNSS time signals, thus enabling both robotic vehicles to be synchronized to an external reference clock.

In embodiments in which the initiating and responding robotic vehicles synchronized internal clocks, any of a variety of time synchronization signals or signaling may be used for this purpose. For example, the processor may transmit a first synchronization signal to the responding robotic vehicle indicating a time value to which the responding robotic vehicle processor should set an internal clock in response to a second synchronization signal, and then after a brief delay transmit the second synchronization signal, such as a pulse or recognizable character that enables the responding robotic vehicle processor to start an internal clock at the time value indicated in the first synchronization signal.

The operations in block 5902 are illustrated in FIG. 59 as occurring before many operations of the method 5200. However, such synchronization signaling may be performed at any time during the method 5200 prior to transmission of the image capture instruction in block 5208. In some embodiments, the operations in block 5902 may be performed periodically so that the initiating robotic vehicle and responding robotic vehicle clocks can remain synchronized over a period of time.

The processor may continue with the operations of the method 5200, such as beginning with block 5202 as described. Then, in response to determining that the responding robotic vehicle is suitably positioned and oriented for capturing an image for synchronous multi-viewpoint photography (i.e., determination block 5204=“Yes”), the processor may transmit a time-based image capture instruction using the synchronized clocks in block 5904. For example, the image capture instruction configured to enable the responding robotic vehicle to capture a second image at approximately the same time as the initiating robotic vehicle captures a first image in block 5208 may be accomplished by transmitting a time at which the responding robotic vehicle should capture the second image using the synchronized clock determined in block 5902. In embodiments that utilize synchronized internal clocks of the two robotic vehicles, the time-based image capture instruction may specify a time value based on the internal clock of the initiating robotic vehicle. In embodiments that utilize GNSS time signals as the reference clock, the time-based image capture instruction may specify a GNSS time value for capturing images. In some embodiments, the image capture instruction transmitted in block 5904 may specify a start time and an end time or duration for capturing a plurality of images by the responding robotic vehicle using either the internal clock synchronized in block 5902 or GNSS time values.

The processor may then perform the operations of block 5210 of the method 5200 as described.

FIG. 60 is a process flow diagram illustrating alternative operations 6000 that may be performed by a processor (e.g., 202, 204, 5120) of an initiating robotic vehicle device (i.e., a robotic vehicle (e.g., 152) and/or an initiating robotic vehicle controller (e.g., 150) as part of the method 5200 for synchronizing the capture of images by the initiating robotic vehicle and the responding robotic vehicle according to some embodiments.

With reference to FIGS. 1A-60, in block 5902, the processor may perform operations including transmitting a timing signal that enables synchronizing a clock in the responding robotic vehicle with a clock in the initiating robotic vehicle or selecting GNSS time signals for the reference clock as described for the method 5900.

The processor may continue with the operations of the method 5200, such as beginning with block 5202 as described. Then, in response to determining that the responding robotic vehicle is suitably positioned and oriented for capturing an image for synchronous multi-viewpoint photography (i.e., determination block 5204=“Yes”), the processor may transmit an instruction configured to cause the responding robotic vehicle to capture a plurality of images and record a time when each image is captured in block 6002. With the internal clock of the responding robotic vehicle synchronized with the internal clock of the initiating robotic vehicle in block 5902 or the two robotic vehicles using GNSS time signals as the reference clock, the responding robotic vehicle can use the synchronized clock to record a time value when each of the plurality of images is captured that will correspond to similar time values in the initiating robotic vehicle.

In block 6004, the processor may capture a first image by the camera of the initiating robotic vehicle and record a reference time when the first image is captured. Using GNSS time signals or with the internal clock of the initiating robotic vehicle synchronized with the internal clock of the responding robotic vehicle in block 5902, the reference time recorded by the processor should correspond to a very similar time (e.g., subject to any clock drift since the operations in block 5902 were performed) of the internal clock of the responding robotic vehicle.

In block 6006, the processor may transmit to the responding robotic vehicle device (i.e., responding robotic vehicle or responding robotic vehicle controller) the reference time when the first image was captured by the initiating robotic vehicle. Thus, the initiating robotic vehicle device identifies to the responding robotic vehicle device a time based on the synchronized internal clock when the initiating robotic vehicle camera captured the first image.

In block 6008, the processor may receive from the responding robotic vehicle device (i.e., responding robotic vehicle or responding robotic vehicle controller) a second image from among a plurality of images that was captured by the responding robotic vehicle at approximately the reference time that was transmitted in block 6006. In other words, by synchronizing internal clocks in block 5902 or using GNSS time signals as a common reference clock, instructing the responding robotic vehicle device to capture a plurality of images and record the time when each image is captured, and then sending a reference time for selecting a particular one of the plurality of images to the responding robotic vehicle device, the initiating robotic vehicle device may receive a second image that was captured at approximately the same time (e.g. synchronously with) the first image was captured by the initiating robotic vehicle. This embodiment may simplify obtaining synchronized images from the two robotic vehicles because any delay in initiating capture of an image by the camera either of either robotic vehicle can be ignored because the synchronous images can be identified based on synchronize clocks after the images have been captured.

The processor may then perform the operations of block 5214 of the method 5200 as described.

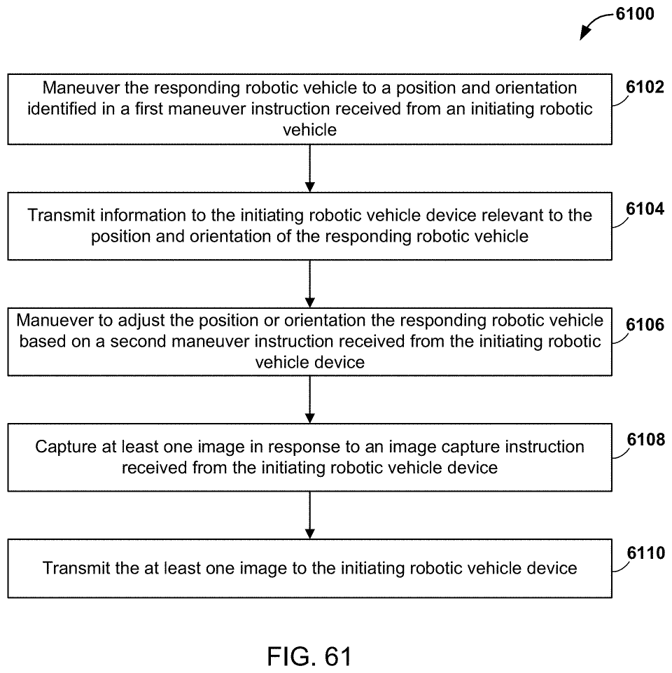

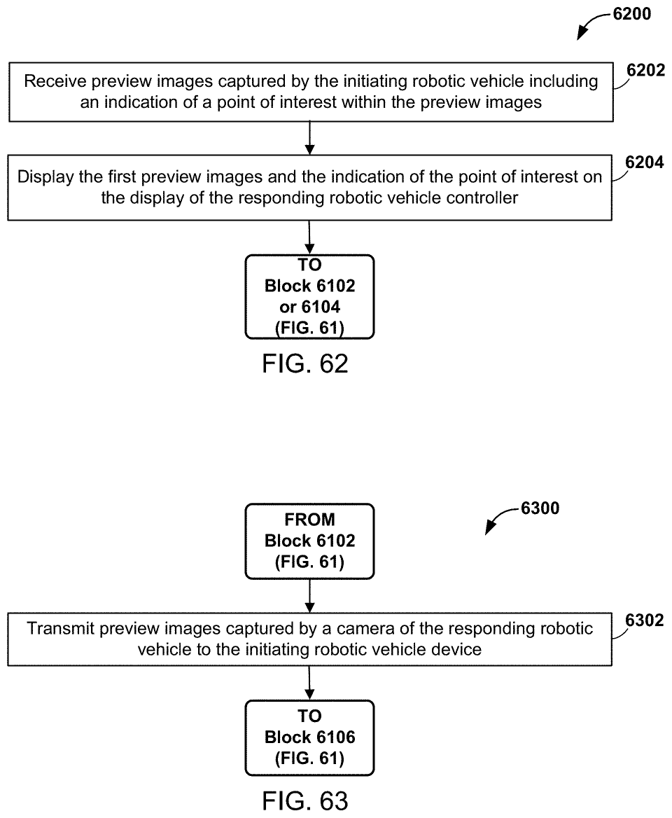

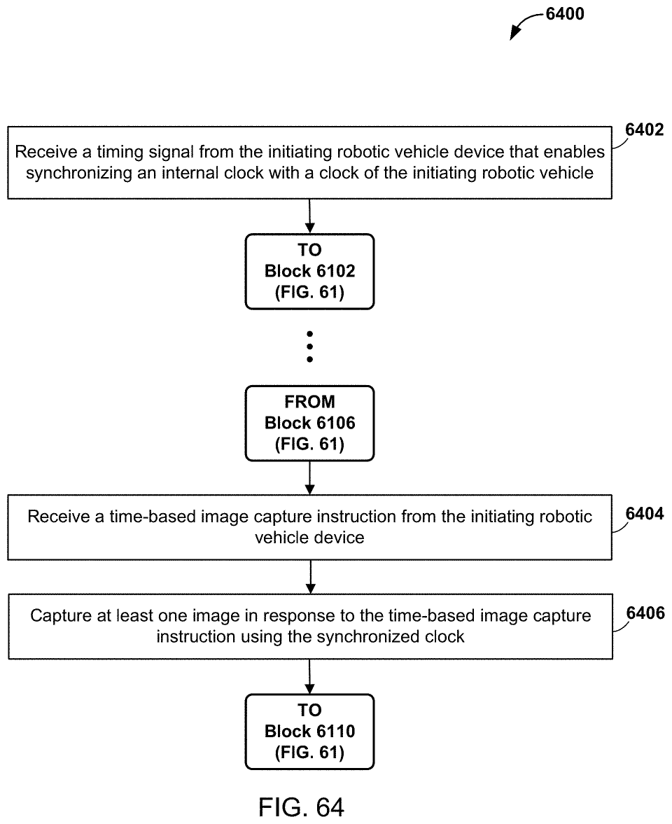

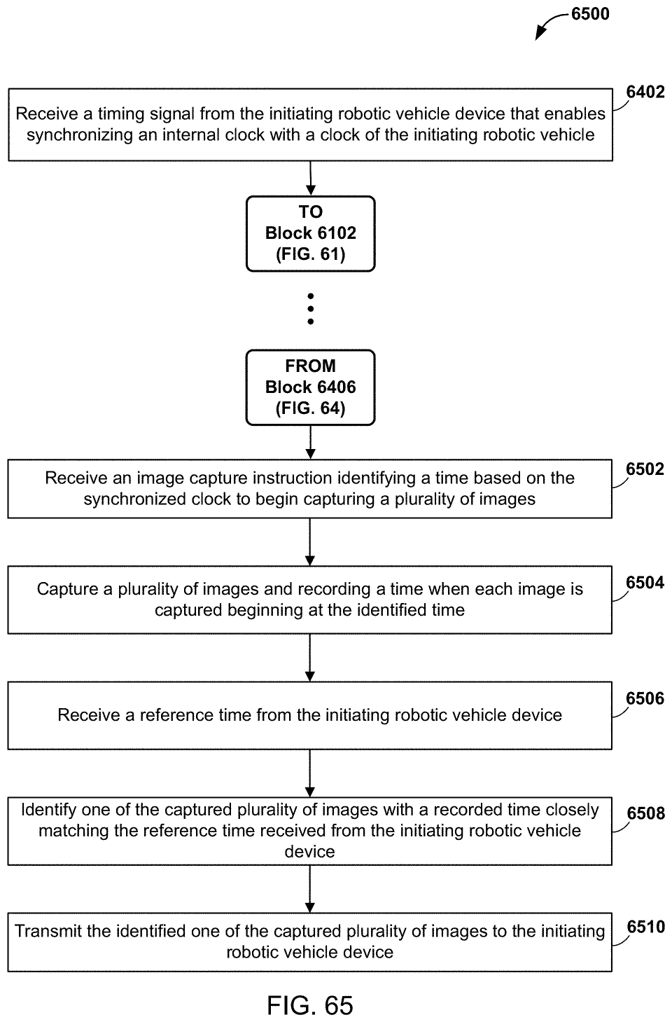

FIG. 61 is a process flow diagram illustrating a method 6100 that may be performed by a responding robotic vehicle device (i.e., responding robotic vehicle or robotic vehicle controller) to perform synchronous multi-viewpoint photography according to some embodiments. With reference to FIGS. 1A-61, the operations of the method 6100 may be performed by a processor (e.g., 202, 204, 5120) of a robotic vehicle (e.g., 152) and/or a robotic vehicle controller (e.g., 150).

The order of operations performed in blocks 6102-6110 is merely illustrative, and the operations may be performed in a different order and partially simultaneously in some embodiments. In some embodiments, the method 6100 may be implemented as a software module executing within a processor of an SoC or SIP (e.g., 202, 204), or in dedicated hardware within an SoC that is configured to take actions and store data as described. For ease of reference, the various elements performing the operations of the method 6100 are referred to in the following method descriptions as a “processor.”

In block 6102, the processor may maneuver the responding robotic vehicle to a position and orientation identified in a first maneuver instruction received from an initiating robotic vehicle. In some embodiments, the received first maneuver instruction may include geographic coordinates, such as latitude longitude and altitude, for the location (including altitude for maneuvering a UAV) where the responding robotic vehicle should capture a photograph for use in simultaneous multi-viewpoint photography. Further, the first maneuver instructions may specify a pointing angle for directing a camera or capturing an image, such as a compass direction and inclination or declination angle with respect to the horizon along a line perpendicular to the compass direction for aiming the camera. In some situations, the maneuver instructions may also include a tilt (i.e., roll) angle for the camera about the compass direction. Thus, in some embodiments, the first maneuver instruction received from the initiating robotic vehicle may include coordinates in 6-degrees of freedom (e.g., latitude, longitude, altitude, pitch, roll, yaw or slew) that the processor can use for maneuvering the responding robotic vehicle and directing the camera for capturing a simultaneous photography image.

In some embodiments, the processor receiving the first maneuver instruction may be within a responding robotic vehicle controller controlling the responding robotic vehicle (i.e., the responding robotic vehicle device is a responding robotic vehicle controller), and the first maneuver instruction may be transmitted by an initiating robotic vehicle controller. In some embodiments, the responding robotic vehicle controller may display information received in the first maneuver instructions that enables an operator of the responding robotic vehicle to maneuver the responding robotic vehicle via inputs to the responding robotic vehicle controller to the location and orientation suitable for capturing an image for simultaneous multi-viewpoint photography. For example, the maneuver instructions may cause the responding robotic vehicle controller to display a vector to the location or an indication on a map display of the location to which the operator should maneuver the robotic vehicle.

In some embodiments, the processor may be within the responding robotic vehicle (i.e., the responding robotic vehicle device is a responding robotic vehicle), and the processor may maneuver to the indicated location, such as using positional information obtained by an internal GNSS receiver for navigating to coordinates (e.g., latitude, longitude, and altitude) included in the received first maneuver instruction. Similarly, the responding robotic vehicle may point a camera based on orientation information included in the received first maneuver instruction.

In block 6104, the processor may transmit to the initiating robotic vehicle device information about the location and orientation of the camera of the responding robotic vehicle once the responding robotic vehicle has arrived at the position and orientation included in the received first maneuver instruction. Such information may be in the form of coordinates (e.g., latitude, longitude, altitude, pitch, roll, yaw or slew), preview images obtained by the camera when so positioned, combinations of such information, or other information that may be used by the initiating robotic vehicle device (i.e., initiating robotic vehicle or initiating robotic vehicle controller) for determining whether the responding robotic vehicle is properly positioned for synchronous multi-viewpoint photography as described.

In block 6106, the processor may receive a second maneuver instruction from the initiating robotic vehicle device (i.e., initiating robotic vehicle or initiating robotic vehicle controller) and maneuver the responding robotic vehicle to adjust the position and orientation of the responding robotic vehicle and camera based on information in the second maneuver instruction. For example, the second maneuver instruction may include information that enables a responding robotic vehicle to adjust its position and/or the pointing angle of the camera. The operations in block 6106 may be performed multiple times as the processor receives subsequent second maneuver instructions from the initiating robotic vehicle and refines its position and camera orientation accordingly.

In block 6108, the processor may capture at least one image in response to receiving an image capture instruction or instructions. As described herein, the image capture instruction or instructions may include information that enables the processor to capture the at least one image at a particular instance that corresponds to a time when an image is captured by the initiating robotic vehicle.

In block 6110, the processor may transmit to the initiating robotic vehicle device (i.e., initiating robotic vehicle or initiating robotic vehicle controller) the at least one image captured by the camera of the responding robotic vehicle.

FIG. 62 is a process flow diagram illustrating alternative operations 6200 that may be performed by a processor (e.g., 202, 204) of a responding robotic vehicle controller (e.g., 150) (i.e., the responding robotic vehicle device is a responding robotic vehicle controller) as part of the method 6100 according to some embodiments.

With reference to FIGS. 1A-62, in block 6202, the processor may receive preview images captured by the camera of the initiating robotic vehicle that also include an indication of a point of interest within the preview images. For example, the initiating robotic vehicle device (i.e., initiating robotic vehicle or initiating robotic vehicle controller) may transmit to the responding robotic vehicle controller a video stream of preview images captured by the initiating robotic vehicle that includes some kind of a border highlight or other indication of what the operator of the initiating robotic vehicle has designated to be the point of interest, such as in the method 5300 described with reference to FIG. 53.

In block 6204, the processor may perform operations including displaying on a user interface of the responding robotic vehicle controller preview images captured by the camera of the initiating robotic vehicle along with the indication of the point of interest within the preview images. For example, the responding robotic vehicle controller may display the received video stream on a user interface display (e.g., 5154) so that the operator can be the point of interest at least from the perspective of the initiating robotic vehicle. Providing this visual information to the responding robotic vehicle operator may enable that operator to anticipate where the responding robotic vehicle should be maneuvered to and how the robotic vehicle and camera should be positioned in order to participate in synchronous multi-viewpoint photography activities with the initiating robotic vehicle.

The processor may continue with the operations of block 6102 of the method 6100 as described. In some embodiments, the preview images of the point of interest may serve as the first maneuver instructions by showing the responding robotic vehicle operator the point of interest, thereby enabling the robotic vehicle operator to maneuver the responding robotic vehicle to an appropriate location for conducting simultaneous multi-viewpoint photography.

FIG. 63 is a process flow diagram illustrating alternative operations 6300 that may be performed by a processor (e.g., 202, 204, 5120) of a responding robotic vehicle device (i.e., a responding robotic vehicle (e.g., 152) and/or a responding robotic vehicle controller (e.g., 150)) to transmit information to the initiating robotic vehicle device relevant to the position and orientation of the responding robotic vehicle as part of the method 6100 according to some embodiments.

With reference to FIGS. 1A-63, once the responding robotic vehicle has maneuvered in block 6102 of the method 6100 to the location and orientation indicated in the first maneuver instructions, the processor may transmit preview images captured by a camera of the responding robotic vehicle to the initiating robotic vehicle device (i.e., initiating robotic vehicle or initiating robotic vehicle controller) in block 6302. By sending preview images from the camera of the responding robotic vehicle to the initiating robotic vehicle device, the initiating robotic vehicle device (i.e., initiating robotic vehicle and/or initiating robotic vehicle controller) can view the perspective of the responding robotic vehicle. This may enable the operator of the initiating robotic vehicle to determine whether the responding robotic vehicle is properly positioned for simultaneous multi-viewpoint photography, and if not to provide the second maneuver instructions as described in the method 5200 with reference to FIG. 52.

After transmitting the preview images in block 6302, the processor may perform the operations of block 6106 of the method 6100 to follow the second maneuver instructions received from the initiating robotic vehicle device as described.

FIG. 64 is a process flow diagram illustrating alternative operations 6400 that may be performed by a processor (e.g., 202, 204, 5120) of a responding robotic vehicle device (i.e., a responding robotic vehicle (e.g., 152) or a responding robotic vehicle controller (e.g., 150)) as part of the method 6100 for synchronizing the capture of images by the initiating robotic vehicle and the responding robotic vehicle according to some embodiments.

With reference to FIGS. 1A-64, in block 6402, the processor may receive a timing signal that enables synchronizing a clock in the responding robotic vehicle with a clock in the initiating robotic vehicle. In some embodiments, the operations in block 6402 involve signaling that enables an internal clock of the responding robotic vehicle to be synchronized with an internal clock of the initiating robotic vehicle. In some embodiments, the operations in block 6402 involve indicating that a GNSS time signal should be used as the clock for determining when to capture images as to robotic vehicles in relatively close proximity should receive the same GNSS time signals, thus enabling both robotic vehicles to be synchronized to an external reference clock.

In embodiments in which the robotic vehicles synchronized internal clocks, any of a variety of time synchronization signals or signaling may be used for this purpose as described for the method 5900 with reference to FIG. 59. The operations in block 6402 are illustrated in FIG. 64 as occurring before operations of the method 6100. However, such synchronization signaling may be performed at any time during the method 6100 prior to reception of the image capture instruction in block 6108. In some embodiments, the operations in block 6402 may be performed periodically so that the initiating robotic vehicle and responding robotic vehicle clocks can remain synchronized over a period of time.

The processor may continue with the operations of the method 6100, such as beginning with block 6102 as described. In block 6404, the processor may receive a time-based image capture instruction from the initiating robotic vehicle device (i.e., initiating robotic vehicle or initiating robotic vehicle controller). This may occur once the responding robotic vehicle has maneuvered in response to the second maneuver instructions received from the initiating robotic vehicle device in block 6106 when the initiating robotic vehicle device has determined that the responding robotic vehicle is properly positioned and oriented for performing synchronous multi-viewpoint photography. For example, the image capture instruction received from the initiating robotic vehicle device may include a time or time value at which the responding robotic vehicle should capture the second image using either a synchronized clock determined in block 6402 or a GNSS base reference clock. In embodiments that utilize synchronized internal clocks of the two robotic vehicles, the time-based image capture instruction may specify a time value based on the internal clock of the initiating robotic vehicle. In embodiments that utilize GNSS time signals as the reference clock, the time-based image capture instruction may specify a GNSS time value for capturing images. In some embodiments, the image capture instruction received from the initiating robotic vehicle device may specify a start time and an end time or duration for capturing a plurality of images by the responding robotic vehicle using either the internal clock synchronized in block 6402 or GNSS time values.

In block 6406, the processor may capture at least one image in response to the time-based image capture instruction using the synchronized internal clock or GNSS based reference clock.

The processor may then perform the operations of block 6110 of the method 6100 as described.

FIG. 65 is a process flow diagram illustrating alternative operations 6500 that may be performed by a processor (e.g., 202, 204, 5120) of a responding robotic vehicle device (i.e., a responding robotic vehicle (e.g., 152) and/or a responding robotic vehicle controller (e.g., 150)) as part of the method 6100 for synchronizing the capture of images by the initiating robotic vehicle and the responding robotic vehicle according to some embodiments.

With reference to FIGS. 1A-65, in block 6402, the processor may receive a timing signal that enables synchronizing a clock in the responding robotic vehicle with a clock in the initiating robotic vehicle or selecting GNSS time signals for the reference clock as described for the method 6400. As described, the operations in block 6402 may include synchronizing an internal clock of the responding robotic vehicle with an internal clock of the initiating robotic vehicle or identifying use of GNSS time signals as a reference clock.

The processor may continue with the operations of the method 6100, such as beginning with block 6102 as described. In block 6404, the processor may receive a time-based image capture instruction from the initiating robotic vehicle device (i.e., initiating robotic vehicle or initiating robotic vehicle controller) identifying a time based on the synchronized clock or GNSS reference signal to begin capturing a plurality of images in block 6502. This may occur once the responding robotic vehicle has maneuvered in response to the second maneuver instructions received from the initiating robotic vehicle device in block 6106 when the initiating robotic vehicle device has determined that the responding robotic vehicle is properly positioned and oriented for performing synchronous multi-viewpoint photography. The signal received in block 6502 may also direct the processor to record the time based upon the synchronized clock when each of the plurality of images is captured. With the internal clock of the responding robotic vehicle synchronized with the internal clock of the initiating robotic vehicle in block 6402, or the two robotic vehicles using GNSS time signals as the reference clock, the recorded time that each of the plurality of images is captured by the responding robotic vehicle will correspond to similar time values in the initiating robotic vehicle.

In block 6504, the processor may capture a plurality of images by the camera of the responding robotic vehicle and record a reference time when each of the images is captured. Using GNSS time signals or with the internal clock of the initiating robotic vehicle synchronized with the internal clock of the initiating robotic vehicle in block 6402, the time that each image is captured recorded by the processor should correspond to a very similar time (e.g., subject to any clock drift since the operations in block 6402 were performed) of the internal clock of the initiating robotic vehicle.

In block 6506, the processor may receive a reference time from the initiating robotic vehicle device (i.e., initiating robotic vehicle or initiating robotic vehicle controller). As described with reference to FIG. 60, the reference time received by the processor of the responding robotic vehicle may be a time based on the synchronized clocks when the first image was captured by the initiating robotic vehicle.

In block 6508, the processor may identify one of the captured of plurality of images that has a recorded time closely matching the reference time received from the initiating robotic vehicle device. For example, the processor may use the reference time as a look up value for identifying the corresponding image stored in memory.

In block 6510, the processor may transmit the selected image to the initiating robotic vehicle device (i.e., initiating robotic vehicle or initiating robotic vehicle controller). Thus, rather than attempting to capture a single image at the same instant as an image was captured by the initiating robotic vehicle, the responding robotic vehicle captures a plurality of images very close together and then selects the one image (or a few images) with a captured time that most closely matches the received reference time that the initiating robotic vehicle captured an image.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features

What is claimed is:

1. A method performed by a processor of an initiating robotic vehicle device for performing synchronous multi-viewpoint photography with a plurality of robotic vehicle devices, comprising:
transmitting to a responding robotic vehicle device a first maneuver instruction configured to cause a responding robotic vehicle to maneuver to a location with an orientation suitable for capturing an image suitable for use with an image of the initiating robotic vehicle device for performing synchronous multi-viewpoint photography;
determining from information received from the responding robotic vehicle device whether the responding robotic vehicle is suitably positioned and oriented for capturing an image for synchronous multi-viewpoint photography;
transmitting to the responding robotic vehicle device a second maneuver instruction configured to cause the responding robotic vehicle to maneuver so as to adjust its a location or its orientation to correct its position or orientation for capturing an image for synchronous multi-viewpoint photography in response to determining that the responding robotic vehicle is not suitably positioned and oriented for capturing an image for synchronous multi-viewpoint photography; and
transmitting, to the responding robotic vehicle device, an image capture instruction configured to enable the responding robotic vehicle to capture a second image at approximately the same time as the initiating robotic vehicle captures a first image in response to determining that the responding robotic vehicle is suitably positioned and oriented for capturing an image for synchronous multi-viewpoint photography;
capturing, via a camera of the initiating robotic vehicle, the first image;
receiving the second image from the responding robotic vehicle device; and
generating an image file based on the first image and the second image.

2. The method of claim 1, wherein:
the robotic vehicle device is an initiating robotic vehicle controller controlling the initiating robotic vehicle and the processor is within the initiating robotic vehicle controller;
the first and second maneuver instructions transmitted to the responding robotic vehicle are transmitted from the initiating robotic vehicle controller to a responding robotic vehicle controller controlling the responding robotic vehicle and configured to enable the responding robotic vehicle controller to display information to enable an operator to maneuver the responding robotic vehicle to the location and orientation suitable for capturing an image for synchronous multi-viewpoint photography; and
the image capture instruction transmitted to the responding robotic vehicle device is transmitted from the initiating robotic vehicle controller to the responding robotic vehicle controller and configured to cause the responding robotic vehicle controller to send commands to the responding robotic vehicle to capture the second image at approximately the same time as the initiating robotic vehicle captures the first image.

3. The method of claim 2, further comprising:
displaying, via a user interface on the initiating robotic vehicle controller, preview images captured by the camera of the initiating robotic vehicle; and
receiving an operator input on the user interface identifying a region or feature appearing in the preview images,
wherein transmitting to the responding robotic vehicle device the first maneuver instruction configured to cause the responding robotic vehicle to maneuver to a location with an orientation suitable for capturing an image suitable for use with an image captured by the initiating robotic vehicle for performing synchronous multi-viewpoint photography comprises transmitting preview images captured by the camera of the initiating robotic vehicle to the responding robotic vehicle controller in a format that enables the responding robotic vehicle controller to display the preview images for reference by an operator of the responding robotic vehicle.

4. The method of claim 1, wherein
the robotic vehicle device is the initiating robotic vehicle and the processor is within the initiating robotic vehicle;
the first and second maneuver instructions transmitted to the responding robotic vehicle device are transmitted from the initiating robotic vehicle to the responding robotic vehicle and configured to enable the responding robotic vehicle to maneuver to the location and orientation for capturing an image for synchronous multi-viewpoint photography; and
the image capture instruction transmitted to the responding robotic vehicle device is transmitted from the initiating robotic vehicle to the responding robotic vehicle and configured to cause the responding robotic vehicle to capture the second image at approximately the same time as the initiating robotic vehicle captures the first image.

5. The method of claim 1, wherein determining from information received from the responding robotic vehicle device whether the responding robotic vehicle is suitably positioned and oriented for capturing an image for synchronous multi-viewpoint photography comprises:
receiving from the responding robotic vehicle device location and orientation information of the responding robotic vehicle; and
determining whether the responding robotic vehicle is suitably positioned and oriented for capturing an image for synchronous multi-viewpoint photography based on the location and orientation information of the responding robotic vehicle and location and orientation information of the initiating robotic vehicle.

6. The method of claim 1, further comprising:
displaying, via a user interface on an initiating robotic vehicle controller, a first preview image captured by the camera of the initiating robotic vehicle; and
receiving an operator input on the user interface identifying a region or feature appearing in the first preview image,
wherein transmitting to the responding robotic vehicle device the first maneuver instruction configured to cause the responding robotic vehicle to maneuver to the location with an orientation suitable for capturing an image suitable for use with images captured by the initiating robotic vehicle for performing synchronous multi-viewpoint photography comprises:
determining, based on the identified region or feature of interest and a location and orientation of the initiating robotic vehicle, the location and the orientation for the responding robotic vehicle for capturing images suitable for use with images captured by the initiating robotic vehicle for synchronous multi-viewpoint photography; and
transmitting the determined location and orientation to the responding robotic vehicle device.

7. The method of claim 1, wherein determining from information received from the responding robotic vehicle whether the responding robotic vehicle is suitably positioned and oriented for capturing an image for synchronous multi-viewpoint photography comprises:
receiving preview images from the responding robotic vehicle device;
performing image processing to determine whether the preview images received from the responding robotic vehicle device and preview images captured by the initiating robotic vehicle are aligned suitably for synchronous multi-viewpoint photography;
determining an adjustment to the location or orientation of the responding robotic vehicle to position the responding robotic vehicle for capturing an image for synchronous multi-viewpoint photography in response to determining that the preview images received from the responding robotic vehicle device and preview images captured by the initiating robotic vehicle are not aligned suitably for synchronous multi-viewpoint photography; and
determining that the responding robotic vehicle is suitably positioned and oriented for capturing an image for synchronous multi-viewpoint photography in response to determining that the preview images received from the responding robotic vehicle device and preview images captured by the initiating robotic vehicle are aligned suitably for synchronous multi-viewpoint photography.

8. The method of claim 7, wherein:
performing image processing to determine whether the preview images received from the responding robotic vehicle and preview images captured by the initiating robotic vehicle are aligned suitably for synchronous multi-viewpoint photography comprises:
determining a first perceived size of the identified point of interest in the preview images captured by the initiating robotic vehicle;
determining a second perceived size of the identified point of interest in the preview images received from the responding robotic vehicle; and
determining whether a difference between the first perceived size of the identified point of interest and the second perceived size of the identified point of interest is within a size difference threshold for synchronous multi-viewpoint photography;
determining an adjustment to the location or orientation of the responding robotic vehicle to position the responding robotic vehicle for capturing an image for synchronous multi-viewpoint photography in response to determining that the preview images received from the responding robotic vehicle device and preview images captured by the initiating robotic vehicle are not aligned suitably for synchronous multi-viewpoint photography comprises determining a change in location for the responding robotic vehicle based on the difference between the first perceived size of the identified point of interest and the second perceived size of the identified point of interest in response to determining that the difference between the first perceived size of the identified point of interest and the second perceived size of the identified point of interest is not within the size difference threshold for synchronous multi-viewpoint photography; and
determining that the responding robotic vehicle is suitably positioned and oriented for capturing an image for synchronous multi-viewpoint photography in response to determining that the preview images received from the responding robotic vehicle device and preview images captured by the initiating robotic vehicle are aligned suitably for synchronous multi-viewpoint photography comprises determining that the responding robotic vehicle is suitably positioned and oriented for capturing an image for synchronous multi-viewpoint photography in response to determining that the difference between the first perceived size of the identified point of interest and the second perceived size of the identified point of interest is within the size difference threshold for synchronous multi-viewpoint photography.

9. The method of claim 7, wherein:
performing image processing to determine whether the preview images received from the responding robotic vehicle and preview images captured by the initiating robotic vehicle are aligned suitably for synchronous multi-viewpoint photography comprises:
performing image processing to determine a location where the point of interest appears within preview images captured by the initiating robotic vehicle;
performing image processing to determine a location where the point of interest appears within preview images received from the responding robotic vehicle device; and
determining whether a difference in the location of the point of interest within preview images captured by the initiating robotic vehicle and preview images received from the responding robotic vehicle device is within a location difference threshold for synchronous multi-viewpoint photography;
determining an adjustment to the location or orientation of the responding robotic vehicle to position the responding robotic vehicle for capturing an image for synchronous multi-viewpoint photography in response to determining that the preview images received from the responding robotic vehicle device and preview images captured by the initiating robotic vehicle are not aligned suitably for synchronous multi-viewpoint photography comprises determining a change in orientation of the responding robotic vehicle based on the difference in the location of the point of interest within preview images captured by the initiating robotic vehicle and preview images received from the responding robotic vehicle device in response to determining that the difference in the location of the point of interest within preview images captured by the initiating robotic vehicle and preview images received from the responding robotic vehicle device is not within the location difference threshold for synchronous multi-viewpoint photography; and
determining that the responding robotic vehicle is suitably positioned and oriented for capturing an image for synchronous multi-viewpoint photography in response to determining that the preview images received from the responding robotic vehicle device and preview images captured by the initiating robotic vehicle are aligned suitably for synchronous multi-viewpoint photography comprises determining that the responding robotic vehicle is suitably oriented for capturing an image for synchronous multi-viewpoint photography in response to determining that the difference in the location of the point of interest within preview images captured by the initiating robotic vehicle and preview images received from the responding robotic vehicle device is within the location difference threshold for synchronous multi-viewpoint photography.

10. The method of claim 1, further comprising transmitting a timing signal that enables synchronizing a clock in the responding robotic vehicle with a clock in the initiating robotic vehicle, wherein:
transmitting a time-based image capture instruction using the synchronized clocks comprises transmitting an instruction configured to cause the responding robotic vehicle to capture a plurality of images and record a time when each image is captured by the initiating robotic vehicle;
capturing the first image comprises capturing the first image and recording a reference time when the first image is captured; and
receiving the second image from the responding robotic vehicle device comprises:
transmitting, to the responding robotic vehicle device, the reference time when the first image was captured; and
receiving from the responding robotic vehicle device a second image that was captured by the responding robotic vehicle at approximately the reference time.

11. A method performed by a processor of a responding unmanned aerial vehicle (robotic vehicle) device for performing synchronous multi-viewpoint photography, comprising:
maneuvering a responding robotic vehicle to a position and orientation identified in a first maneuver instruction received from an initiating robotic vehicle device;
transmitting information to the initiating robotic vehicle device relevant to the position and orientation of the responding robotic vehicle;
maneuvering to adjust the position or orientation the responding robotic vehicle based on a second maneuver instruction received from the initiating robotic vehicle device;
capturing at least one image in response to an image capture instruction received from the initiating robotic vehicle device; and
transmitting the at least one image to the initiating robotic vehicle device.

12. The method of claim 11, wherein:
the responding robotic vehicle device is a responding robotic vehicle controller controlling the responding robotic vehicle and the processor is within the responding robotic vehicle controller;
maneuvering the responding robotic vehicle to a position and orientation identified in the first maneuver instruction received from the initiating robotic vehicle device comprises displaying the first maneuver instructions on a display of the responding robotic vehicle controller and transmitting maneuver commands to the responding robotic vehicle based on user inputs;
maneuvering to adjust the position or orientation the responding robotic vehicle based on the second maneuver instruction received from the initiating robotic vehicle device comprises displaying the second maneuver instructions on the display of the responding robotic vehicle controller and transmitting maneuver commands to the responding robotic vehicle based on user inputs;
capturing at least one image in response to an image capture instruction received from the initiating robotic vehicle device comprises the responding robotic vehicle controller causing a camera of the responding robotic vehicle to capture the at least one image; and
transmitting the at least one image to the initiating robotic vehicle device comprises the responding robotic vehicle controller receiving the at least one image from the responding robotic vehicle and transmitting the at least one image to the initiating robotic vehicle device.

13. The method of claim 12, further comprising:
receiving, from the initiating robotic vehicle device, preview images captured by the initiating robotic vehicle including an indication of a point of interest within the preview images; and
displaying the preview images and the indication of the point of interest on the display of the responding robotic vehicle controller.

14. The method of claim 11, wherein transmitting information to the initiating robotic vehicle device relevant to the position and orientation of the responding robotic vehicle comprises transmitting preview images capture by a camera of the responding robotic vehicle to the initiating robotic vehicle device.

15. The method of claim 11, wherein transmitting information to the initiating robotic vehicle device relevant to the position and orientation of the responding robotic vehicle comprises transmitting information regarding a location and orientation of the responding robotic vehicle to the initiating robotic vehicle device.

16. The method of claim 11, further comprising receiving a timing signal from the initiating robotic vehicle device that enables synchronizing a clock in the responding robotic vehicle with a clock of the initiating robotic vehicle, wherein:
capturing at least one image in response to a time-based image capture instruction using the synchronized clocks comprises:
receiving an image capture instruction identifying a time based on the synchronized clock to begin capturing a plurality of images;
capturing a plurality of images and recording a time when each image is captured beginning at the identified time;
receiving a reference time from the initiating robotic vehicle device; and
identifying one or more of the captured plurality of images with a recorded time closely matching the reference time received from the initiating robotic vehicle device; and
transmitting the at least one image to the initiating robotic vehicle device comprises transmitting the identified one of the captured plurality of images to the initiating robotic vehicle device.

17. An unmanned aerial vehicle (robotic vehicle) device, comprising:
a processor configured with processor-executable instructions to:
transmit to a responding robotic vehicle device a first maneuver instruction configured to cause a responding robotic vehicle to maneuver to a location with an orientation suitable for capturing an image suitable for use with an image of the robotic vehicle for performing synchronous multi-viewpoint photography;
determining from information received from the responding robotic vehicle device whether the responding robotic vehicle is suitably positioned and oriented for capturing an image for synchronous multi-viewpoint photography;
transmit to the responding robotic vehicle device a second maneuver instruction configured to cause the responding robotic vehicle to maneuver so as to adjust its a location or its orientation to correct its position or orientation for capturing an image for synchronous multi-viewpoint photography in response to determining that the responding robotic vehicle is not suitably positioned and oriented for capturing an image for synchronous multi-viewpoint photography; and
transmit, to the responding robotic vehicle device, an image capture instruction configured to enable the responding robotic vehicle to capture a second image at approximately the same time as the robotic vehicle captures a first image in response to determining that the responding robotic vehicle is suitably positioned and oriented for capturing an image for synchronous multi-viewpoint photography;
capture, via a camera of the robotic vehicle, the first image;
receive the second image from the responding robotic vehicle device; and
generating an image file based on the first image and the second image.

18. The robotic vehicle device of claim 17, wherein the robotic vehicle device is a robotic vehicle controller comprising a wireless transceiver, a display and the processor, and wherein the processor is further configured with processor-executable instructions to:
transmit the first and second maneuver instructions to a responding robotic vehicle controller controlling the responding robotic vehicle, wherein the first and second maneuver instructions are configured to enable the responding robotic vehicle controller to display information to enable an operator to maneuver the responding robotic vehicle to the location and orientation suitable for capturing an image for synchronous multi-viewpoint photography; and
transmit the image capture instruction to the responding robotic vehicle controller, wherein the image capture instructions are configured to cause the responding robotic vehicle controller to send commands to the responding robotic vehicle to capture the second image at approximately the same time as the robotic vehicle captures the first image.

19. The robotic vehicle device of claim 18, wherein the processor is further configured with processor-executable instructions to:
display, via a user interface on the robotic vehicle controller, preview images captured by the camera of the robotic vehicle;
receive an operator input on the user interface identifying a region or feature appearing in the preview images; and
transmit to the responding robotic vehicle device the first maneuver instruction configured to cause the responding robotic vehicle to maneuver to a location with an orientation suitable for capturing an image suitable for use with an image captured by the robotic vehicle for performing synchronous multi-viewpoint photography by transmitting preview images captured by the camera of the robotic vehicle to the responding robotic vehicle controller in a format that enables the responding robotic vehicle controller to display the preview images for reference by an operator of the responding robotic vehicle.

20. The robotic vehicle device of claim 17, wherein the robotic vehicle device is the robotic vehicle comprising a camera and the processor, and wherein the processor is further configured with processor-executable instructions to:
transmit the first and second maneuver instructions to the responding robotic vehicle, wherein the first and second maneuver instructions are configured to enable the responding robotic vehicle to maneuver to the location and orientation for capturing an image for synchronous multi-viewpoint photography; and
transmit the image capture instruction to the responding robotic vehicle, wherein the image capture instructions are configured to cause the responding robotic vehicle to capture the second image at approximately the same time as the robotic vehicle captures the first image.

21. The robotic vehicle device of claim 17, wherein the processor is further configured with processor-executable instructions to determine from information received from the responding robotic vehicle device whether the responding robotic vehicle is suitably positioned and oriented for capturing an image for synchronous multi-viewpoint photography by:
receiving from the responding robotic vehicle device location and orientation information of the responding robotic vehicle; and
determining whether the responding robotic vehicle is suitably positioned and oriented for capturing an image for synchronous multi-viewpoint photography based on the location and orientation information of the responding robotic vehicle and location and orientation information of the robotic vehicle.

22. The robotic vehicle device of claim 17, wherein the processor is further configured with processor-executable instructions to:
display, via a user interface on the robotic vehicle controller, a first preview image captured by the camera of the robotic vehicle;
receive an operator input on the user interface identifying a region or feature appearing in the first preview image; and
transmit to the responding robotic vehicle device the first maneuver instruction configured to cause the responding robotic vehicle to maneuver to the location with an orientation suitable for capturing an image suitable for use with images captured by the robotic vehicle for performing synchronous multi-viewpoint photography by:
determining, based on the identified region or feature of interest and a location and orientation of the robotic vehicle, the location and the orientation for the responding robotic vehicle for capturing images suitable for use with images captured by the robotic vehicle for synchronous multi-viewpoint photography; and
transmitting the determined location and orientation to the responding robotic vehicle device.

23. The robotic vehicle device of claim 17, wherein the processor is further configured with processor-executable instructions to determine from information received from the responding robotic vehicle whether the responding robotic vehicle is suitably positioned and oriented for capturing an image for synchronous multi-viewpoint photography by:
receiving preview images from the responding robotic vehicle device;
performing image processing to determine whether the preview images received from the responding robotic vehicle device and preview images captured by the robotic vehicle are aligned suitably for synchronous multi-viewpoint photography;
determining an adjustment to the location or orientation of the responding robotic vehicle to position the responding robotic vehicle for capturing an image for synchronous multi-viewpoint photography in response to determining that the preview images received from the responding robotic vehicle device and preview images captured by the robotic vehicle are not aligned suitably for synchronous multi-viewpoint photography; and
determining that the responding robotic vehicle is suitably positioned and oriented for capturing an image for synchronous multi-viewpoint photography in response to determining that the preview images received from the responding robotic vehicle device and preview images captured by the robotic vehicle are aligned suitably for synchronous multi-viewpoint photography.

24. The robotic vehicle device of claim 23, wherein the processor is further configured with processor-executable instructions to:
performing image processing to determine whether the preview images received from the responding robotic vehicle and preview images captured by the robotic vehicle are aligned suitably for synchronous multi-viewpoint photography by:
determining a first perceived size of an identified point of interest in the preview images captured by the robotic vehicle;
determining a second perceived size of the identified point of interest in the preview images received from the responding robotic vehicle; and
determining whether a difference between the first perceived size of the identified point of interest and the second perceived size of the identified point of interest is within a size difference threshold for synchronous multi-viewpoint photography;
determining an adjustment to the location or orientation of the responding robotic vehicle to position the responding robotic vehicle for capturing an image for synchronous multi-viewpoint photography in response to determining that the preview images received from the responding robotic vehicle device and preview images captured by the robotic vehicle are not aligned suitably for synchronous multi-viewpoint photography by determining a change in location for the responding robotic vehicle based on the difference between the first perceived size of the identified point of interest and the second perceived size of the identified point of interest in response to determining that the difference between the first perceived size of the identified point of interest and the second perceived size of the identified point of interest is not within the size difference threshold for synchronous multi-viewpoint photography; and
determining that the responding robotic vehicle is suitably positioned and oriented for capturing an image for synchronous multi-viewpoint photography in response to determining that the preview images received from the responding robotic vehicle device and preview images captured by the robotic vehicle are aligned suitably for synchronous multi-viewpoint photography by determining that the responding robotic vehicle is suitably positioned and oriented for capturing an image for synchronous multi-viewpoint photography in response to determining that the difference between the first perceived size of the identified point of interest and the second perceived size of the identified point of interest is within the size difference threshold for synchronous multi-viewpoint photography.

25. The robotic vehicle device of claim 23, wherein the processor is further configured with processor-executable instructions to:
perform image processing to determine whether the preview images received from the responding robotic vehicle and preview images captured by the robotic vehicle are aligned suitably for synchronous multi-viewpoint photography by:
performing image processing to determine a location where a point of interest appears within preview images captured by the robotic vehicle;
performing image processing to determine a location where the point of interest appears within preview images received from the responding robotic vehicle device; and
determining whether a difference in the location of the point of interest within preview images captured by the robotic vehicle and preview images received from the responding robotic vehicle device is within a location difference threshold for synchronous multi-viewpoint photography;
determine an adjustment to the location or orientation of the responding robotic vehicle to position the responding robotic vehicle for capturing an image for synchronous multi-viewpoint photography in response to determining that the preview images received from the responding robotic vehicle device and preview images captured by the robotic vehicle are not aligned suitably for synchronous multi-viewpoint photography by determining a change in orientation of the responding robotic vehicle based on the difference in the location of the point of interest within preview images captured by the robotic vehicle and preview images received from the responding robotic vehicle device in response to determining that the difference in the location of the point of interest within preview images captured by the robotic vehicle and preview images received from the responding robotic vehicle device is not within the location difference threshold for synchronous multi-viewpoint photography; and
determine that the responding robotic vehicle is suitably positioned and oriented for capturing an image for synchronous multi-viewpoint photography in response to determining that the preview images received from the responding robotic vehicle device and preview images captured by the robotic vehicle are aligned suitably for synchronous multi-viewpoint photography by determining that the responding robotic vehicle is suitably oriented for capturing an image for synchronous multi-viewpoint photography in response to determining that the difference in the location of the point of interest within preview images captured by the robotic vehicle and preview images received from the responding robotic vehicle device is within the location difference threshold for synchronous multi-viewpoint photography.

26. An unmanned aerial vehicle (robotic vehicle) device, comprising:
a processor configured with processor-executable instructions to:
maneuver a robotic vehicle to a position and orientation identified in a first maneuver instruction received from an initiating robotic vehicle device;
transmit information to the initiating robotic vehicle device relevant to the position and orientation of the robotic vehicle;
maneuver to adjust the position or orientation of the robotic vehicle based on a second maneuver instruction received from the initiating robotic vehicle device;
capturing at least one image in response to an image capture instruction received from the initiating robotic vehicle device; and
transmit the at least one image to the initiating robotic vehicle device.

27. The robotic vehicle device of claim 26, wherein the robotic vehicle device is a robotic vehicle controller comprising a wireless transceiver, a display and the processor, and wherein the processor is further configured with processor-executable instructions to:
maneuver the robotic vehicle to a position and orientation identified in the first maneuver instruction received from the initiating robotic vehicle device by displaying the first maneuver instructions on a display of the robotic vehicle controller and transmitting maneuver commands to the robotic vehicle based on user inputs;
maneuver to adjust the position or orientation of the robotic vehicle based on the second maneuver instruction received from the initiating robotic vehicle device by displaying the second maneuver instructions on the display of the robotic vehicle controller and transmitting maneuver commands to the robotic vehicle based on user inputs;
capture at least one image in response to an image capture instruction received from the initiating robotic vehicle device by causing a camera of the robotic vehicle to capture the at least one image; and
transmit the at least one image to the initiating robotic vehicle device by receiving the at least one image from the robotic vehicle and transmitting the at least one image to the initiating robotic vehicle device.

28. The robotic vehicle device of claim 27, wherein the processor is further configured with processor-executable instructions to:
receive, from the initiating robotic vehicle device, preview images captured by an initiating robotic vehicle including an indication of a point of interest within the preview images; and
displaying the preview images and the indication of the point of interest on the display of the robotic vehicle controller.

29. The robotic vehicle device of claim 26, wherein the processor is further configured with processor-executable instructions to transmit information to the initiating robotic vehicle device relevant to the position and orientation of the robotic vehicle by transmitting preview images capture by a camera of the robotic vehicle to the initiating robotic vehicle device.

30. The robotic vehicle device of claim 26, wherein the processor is further configured with processor-executable instructions to:
receive a timing signal from the initiating robotic vehicle device that enables synchronizing a clock in the robotic vehicle with a clock of the initiating robotic vehicle; and
capture at least one image in response to a time-based image capture instruction using the synchronized clocks by:
receiving an image capture instruction identifying a time based on the synchronized clock to begin capturing a plurality of images;
capturing a plurality of images and recording a time when each image is captured beginning at the identified time;
receiving a reference time from the initiating robotic vehicle device; and
identifying one or more of the captured plurality of images with a recorded time closely matching the reference time received from the initiating robotic vehicle device.
